(19) United States
(12) Patent Application Publication
(10) Pub. No.: US 2013/0273514 A1
(43) Pub. Date: Oct. 17, 2013

(54) Optimal Strategies in Security Games

(71) Applicants: Milind Tambe, Ranch Palos Verdes, CA (US); Fernando Ordóñez, Santiado (CL); Rong Yang, Los Angeles, CA (US); Zhengyu Yin, Torrance, CA (US); Matthew Brown, Los Angeles, CA (US); Bo An, Torrance, CA (US); Christopher Kiekintveld, El Paso, TX (US)

(72) Inventors: Milind Tambe, Ranch Palos Verdes, CA (US); Fernando Ordóñez, Santiado (CL); Rong Yang, Los Angeles, CA (US); Zhengyu Yin, Torrance, CA (US); Matthew Brown, Los Angeles, CA (US); Bo An, Torrance, CA (US); Christopher Kiekintveld, El Paso, TX (US)

(73) Assignee: University of Southern California, Los Angeles, CA (US)

(21) Appl. No.: 13/838,466

(22) Filed: Mar. 15, 2013

Related U.S. Application Data
(63) Continuation-in-part of application No. 13/749,026, filed on Jan. 24, 2013.
Application No. 13/749,026 is a continuation of application No. 13/479,884, filed on May 24, 2012, now Pat. No. 8,364,511.
Application No. 13/479,884 is a continuation of application No. 12/253,695, filed on Oct. 17, 2008, now Pat. No. 8,224,681.
Application No. 12/253,695 is a continuation-in-part of application No. 12/251,766, filed on Oct. 15, 2008, now Pat. No. 8,195,490.
(60) Provisional application No. 61/651,799, filed on May 25, 2012.
(60) Provisional application No. 60/980,128, filed on Oct. 15, 2007.
(60) Provisional application No. 60/980,739, filed on Oct. 17, 2007.
(60) Provisional application No. 60/980,128, filed on Oct. 15, 2007.
(60) Provisional application No. 60/980,739, filed on Oct. 17, 2007.
(60) Provisional application No. 60/980,128, filed on Oct. 15, 2007.
(60) Provisional application No. 60/980,739, filed on Oct. 17, 2007.

(51) Int. Cl. G09B 5/00

(52) U.S. Cl. CPC G09B 5/00
USPC 434/219

(57) ABSTRACT

Different solution methodologies for addressing problems or issues when directing security domain patrolling strategies according to attacker-defender Stackelberg security games. One type of solution provides for computing optimal strategy against quantal response in security games, and includes two algorithms, the GOSAQ and PASAQ algorithms. Another type of solution provides for a unified method for handling discrete and continuous uncertainty in Bayesian Stackelberg games, and introduces the HUNTER algorithm. Another solution type addresses multi-objective security games (MOSG), combining security games and multi-objective optimization. MOSGs have a set of Pareto optimal (non-dominated) solutions referred to herein as the Pareto frontier. The Pareto frontier can be generated by solving a sequence of constrained single-objective optimization problems (CSOP), where one objective is selected to be maximized while lower bounds are specified for the other objectives. Specific examples of applications to security domains are described.

### CROSS-REFERENCE TO RELATED APPLICATIONS

This application claims priority to U.S. Provisional Patent Application 61/651,799, entitled “Computing Optimal Strategy Against Quantal Response in Security Games,” filed May 25, 2012, the entire content of which, including Exhibits 1-3, is incorporated herein by reference. This application is related to U.S. patent application Ser. No. 12/251,766, entitled “Agent Security Via Approximate Solvers,” filed Oct. 15, 2008, attorney docket no. 028080-0399; and to U.S. patent application Ser. No. 12/253,695, entitled “Decomposed Optimal Bayesian Stackelberg Solver,” filed Oct. 17, 2008, attorney docket no. 028080-0367. Both applications claim priority to U.S. Provisional Patent Application 60/980,128, entitled “ASAP (Agent Security Via Approximate Policies) Algorithm in an Approximate Solver for Bayesian-Stackelberg Games,” filed Oct. 15, 2007, attorney docket no. 028080-0299, and U.S. Provisional Patent Application 60/980,739, entitled “DOBSS (Decomposed Optimal Bayesian Stackelberg Solver) is an Optimal Algorithm for Solving Stackelberg Games” filed Oct. 17, 2007, attorney docket no. 028080-0300. This application is also a Continuation In Part of U.S. Continuation patent application Ser. No. 13/479,884, entitled “Agent Security Via Approximate Solvers,” filed May 24, 2012, attorney docket no. 028080-0751. The entire contents of all of these applications are incorporated herein by reference.

### STATEMENT REGARDING FEDERALLY SPONSORED RESEARCH

This invention was made with government support under Grant Nos. W911NF-10-1-0185 and ICM/FIC P10-024-F, awarded by the Army Research Office. The invention was also made with government support from the Department of Homeland Security (DHS), under Grant No. 2010-ST-061-RE0001, awarded through the Center for Risk and Economic Analysis of Terrorism Events (CREATE) and with DHS support through the National Center for Border Security and Immigration (NCBSI). The government has certain rights in the invention.

### BACKGROUND

Game theory is an increasingly important paradigm for modeling security domains which feature complex resource allocation. Security games, a special class of attacker-defender Stackelberg games, are at the heart of several major deployed decision-support applications.

In these applications, the defender is typically trying to maximize a single objective. However, there are domains where the defender has to consider multiple objectives simultaneously. For example, the Los Angeles Sheriff's Department (LASD) has stated that it needs to protect the city's metro system from ticketless travelers, common criminals, and terrorists. From the perspective of LASD, each one of these attacker types provides a unique threat (lost revenue, property theft, and loss of life). Given this diverse set of threats, selecting a security strategy is a significant challenge as no single strategy can minimize the threat for all attacker types. Thus, tradeoffs must be made and protecting more against one threat may increase the vulnerability to another threat. However, it is not clear how LASD should weigh these threats when determining the security strategy to use. One could attempt to establish methods for converting the different threats into a single metric. However, this process can become convoluted when attempting to compare abstract notions such as safety and security with concrete concepts such as ticket revenue.

Bayesian security games have been used to model domains where the defender is facing multiple attacker types. The threats posed by the different attacker types are weighted according to the relative likelihood of encountering that attacker type. There are three potential factors limiting the use of Bayesian security games: (1) the defender may not have information on the probability distribution over attacker types, (2) it may be impossible or undesirable to directly compare and combine the defender rewards of different security games, and (3) only one solution is given, hiding the trade-offs between the objectives from the end user.

The recent real-world applications of attacker-defender Stackelberg security games, e.g., ARMOR, IRIS and GUARDS, provide software assistants that help security agencies optimize allocations of their limited security resources. These applications require efficient algorithms that derive mixed (randomized) strategies for the defender (security agencies), taking into account an attacker's surveillance and best response. The algorithms underlying these applications or most others in the literature have assumed perfect rationality of the human attacker, who strictly maximizes his expected utility. While this is a standard game-theoretic assumption and appropriate as an approximation in first generation applications, it is a well-accepted limitation of classical game theory. Indeed, algorithmic solutions based on this assumption may not be robust to the boundedly rational decision making of a human adversary (leading to reduced expected defender reward), and may also be limited in exploiting human biases.

Due to their significance in real-world security, there has been a lot of recent research activity in leader-follower Stackelberg games, oriented towards producing deployed solutions: ARMOR at LAX, IRIS for Federal Air Marshals Service, and GUARDS for the TSA. Bayesian extension to Stackelberg game has been used to model the uncertainty over players' preferences by allowing multiple discrete follower types, as well as, by use of sampling-based algorithms, continuous payoff uncertainty.

Scalability of discrete follower types is essential in domains such as road network security, where each follower type could represent a criminal attempting to follow a certain path. Scaling up the number of types is also necessary for the sampling-based algorithms to obtain high quality solutions under continuous uncertainty. Unfortunately, such scale-up remains difficult, as finding the equilibrium of a Bayesian Stackelberg game is NP-hard. Indeed, despite the recent algorithmic advancement including Multiple-LPs, DOBSS, HBGS, none of these techniques can handle games with more than ≈50 types, even when the number of actions per player is as few as 5: inadequate both for scale-up in discrete follower types and for sampling-based approaches. This scale-up difficulty has led to an entirely new set of algorithms developed for handling continuous payoff uncertainty, and continuous observation and execution error; these algorithms do not handle discrete follower types, however.

### SUMMARY

Illustrative embodiments are now discussed and illustrated. Other embodiments may be used in addition or instead. Details which may be apparent or unnecessary may be omitted to save space or for a more effective presentation. Conversely, some embodiments may be practiced without all of the details which are disclosed.

The present disclosure provides different solution methodologies for addressing the issues of protecting and/or patrolling security domains, e.g., identified infrastructures or resources, with limited resources. The solution methodologies can provide optimal solutions to attacker-defender Stackelberg security games that are modeled on a real-world application of interest. These optimal solutions can be used for directing patrolling strategies and/or resource allocation for particular security domains.

One aspect of the present disclosure provides for computing optimal strategy against quantal response in security games. Two algorithms are presented, which address the difficulties in computing optimal defender strategies in real-world security games: GOSAQ can compute the globally optimal defender strategy against a QR model of attackers when there are no resource constraints and gives an efficient heuristic otherwise; PASAQ in turn provides an efficient approximation of the optimal defender strategy with or without resource constraints. These two algorithms, presented in Exhibit 1, are based upon three key ideas: i) use of a binary search method to solve the fractional optimization problem efficiently, ii) construction of a convex optimization problem through a non-linear transformation, iii) building a piecewise linear approximation of the non-linear terms in the problem. Additional contributions of Exhibit 1 include proofs of approximation bounds, detailed experimental results showing the advantages of GOSAQ and PASAQ in solution quality over the benchmark algorithm (BRQR) and the efficiency of PASAQ. Given these results, PASAQ is at the heart of the PROTECT system, which is deployed for the US Coast Guard in the Port of Boston, and is now headed to other ports.

A further aspect is directed to a unified method for handling discrete and continuous uncertainty in Bayesian Stackelberg games, which scales up Bayesian Stackelberg games, providing a novel unified approach to handling uncertainty not only over discrete follower types but also other key continuously distributed real world uncertainty, due to the leader's execution error, the follower's observation error, and continuous payoff uncertainty. To that end, the aspect provide new algorithms. An algorithm for Bayesian Stackelberg games, called HUNTER, is presented to scale up the number of types. HUNTER combines the following five key features: i) efficient pruning via a best-first search of the leader's strategy space; ii) a novel linear program for computing tight upper bounds for this search; iii) using Bender's decomposition for solving the upper bound linear program efficiently; iv) efficient inheritance of Bender's cuts from parent to child; and v) an efficient heuristic branching rule. Experiments show that HUNTER provides order of magnitude speedups over the best existing methods to handle discrete follower types. In the second part of Exhibit 2, it is shown how HUNTER's efficiency for Bayesian Stackelberg games can be exploited to also handle the continuous uncertainty using sample average approximation. The HUNTER-based approach also outperforms latest robust solution methods under continuously distributed uncertainty.

A further aspect provides a multi-objective optimization for security games, which provides a solution to the challenges of different security domains. The aspect includes treatment of multi-objective security games (MOSG), which combines security games and multi-objective optimization. Instead of a single optimal solution, MOSGs have a set of Pareto optimal (non-dominated) solutions referred to as the Pareto frontier. The Pareto frontier can be generated by solving a sequence of constrained single-objective optimization problems (CSOP), where one objective is selected to be maximized while lower bounds are specified for the other objectives. Features include: i) an algorithm, Iterative ∈-Constraints, for generating the sequence of CSOPs; ii) an exact approach for solving an MILP formulation of a CSOP (which also applies to multi-objective optimization in more general Stackelberg games); iii) heuristics that achieve speedup by exploiting the structure of security games to further constrain a CSOP; iv) an approximate approach for solving an algorithmic formulation of a CSOP, increasing the scalability of the approach described in Exhibit 3 with quality guarantees. Additional contributions of Exhibit 3 include proofs on the level of approximation and detailed experimental evaluation of the proposed approaches.

These, as well as other components, steps, features, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 depicts a table with notations used for an exemplary quantal response embodiment according to the present disclosure.

FIG. 2 depicts an algorithm used for an exemplary quantal response embodiment of the present disclosure.

FIG. 3, includes FIGS. 3(a) and 3(b), which display two examples of approximations of nonlinear objective functions over partitioned domains and after variable substitution.

FIG. 4 includes FIGS. 4(a)-4(f), which depict a solution quality and runtime comparison, without assignment constraints for examples of the three algorithms, GOSAQ, PASAQ, and BRQR.

FIG. 5 includes FIGS. 5(a)-5(f), which depict a solution quality and runtime comparison, with assignment constraints for examples of the three algorithms, GOSAQ, PASAQ, and BRQR.

FIG. 6 depicts an example search tree of solving Bayesian games.

FIG. 7 is a diagram showing step of creating internal search nodes according to an example of the HUNTER algorithm.

FIG. 8 is a diagram depicting an example of internal nodes according to an example of the HUNTER algorithm.

FIG. 9 depicts an example of the HUNTER algorithm.

FIG. 10 depicts an example of the convex hull of H, clconvH.

FIG. 11 depicts an experimental analysis of HUNTER in runtime comparison with the HBGS and DOBSS algorithms.

FIG. 12 is an example of a Pareto frontier plotted for a Bi-Objective MOSG.

FIG. 13 depicts an example of the Iterative-∈-Constraints algorithm.

FIG. 14 depicts an example of an algorithm for recreating a sequence of CSOP problems generated by the Iterative-∈-Constraints algorithm that ensures b≦v throughout.

FIG. 15 depicts a table with notations used for an exemplary MOSG algorithm according to the present disclosure.

FIG. 16 depicts an example of the ORIGAMI-M algorithm.

FIG. 17 depicts an example of the MINI-COV algorithm.

FIG. 18 depicts an example of the ORIGAMI-A algorithm.

FIG. 19 depicts an example of scaling up targets, according to the present disclosure.

FIG. 20 depicts a further example of scaling up targets, according to the present disclosure.

FIG. 21 depicts an example of scaling up objectives, according to the present disclosure.

FIG. 22 depicts an example of scaling down epsilon, according to the present disclosure.

FIG. 23 shows results using ORIGAMI-A under specified conditions.

FIG. 24 is shows epsilon solution quality for MILP-PM and ORIGAMI-A.

FIG. 25 depicts a comparison of maximum objective loss for different epsilon values against uniformly weighted Bayesian security games.

### DETAILED DESCRIPTION

Illustrative embodiments are now discussed and illustrated. Other embodiments may be used in addition or instead. Details which may be apparent or unnecessary may be omitted to save space or for a more effective presentation. Conversely, some embodiments may be practiced without all of the details which are disclosed.

The present disclosure provides different solution methodologies for addressing the issues of protecting and/or patrolling security domains, e.g., identified infrastructures or resources, with limited resources. The solution methodologies can provide optimal solutions to attacker-defender Stackelberg security games that are modeled on a real-world application of interest. These optimal solutions can be used for directing patrolling strategies and/or resource allocation for particular security domains. Three aspects of the present disclosure are described in the following Sections 1-3. Formula presented in the sections are numbered separately for each section while tables and figures are numbered together.

Section 1—Computing Optimal Strategy Against Quantal Response in Security Games: GOSAQ and PASAQ Algorithms

As was noted above, an aspect of the present disclosure in directed to computing an optimal strategy of one or more defenders against one or more attackers having a quantal response in security games.

To step beyond the first-generation deployments of attacker-defender security games, it may be desirable to relax the assumption of perfect rationality of the human adversary. Indeed, this assumption is a well-accepted limitation of classical game theory and modeling human adversaries' bounded rationality is desirable. To this end, quantal response (QR) has provided very promising results to model human bounded rationality. However, in computing optimal defender strategies in real-world security games against a QR model of attackers, difficulties have been recognized: (1) solving a nonlinear non-convex optimization problem efficiently for massive real-world security games; and (2) addressing constraints on assigning security resources, which adds to the complexity of computing the optimal defender strategy.

An aspect of the present disclosure provides two new algorithms to

address these difficulties: The global optimal strategy against quantal response (GOSAQ) algorithm can compute the globally optimal defender strategy against a QR model of attackers when there are no resource constraints and gives an efficient heuristic otherwise; the piecewise linear approximation of optimal strategy against quantal response (PASAQ) algorithm, in turn provides an efficient approximation of the optimal defender strategy with or without resource constraints. These two novel algorithms are based on three key ideas: (i) use of a binary search method to solve the fractional optimization problem efficiently, (ii) construction of a convex optimization problem through a non-linear transformation, (iii) building a piecewise linear approximation of the non-linear terms in the problem. Additional contributions of the disclosure include proofs of approximation bounds, detailed experimental results showing the advantages of GOSAQ and PASAQ in solution quality over the benchmark algorithm (BRQR) and the efficiency of PASAQ.

QR assumes errors in human decision making and suggests that instead of strictly maximizing utility, individuals respond stochastically in games: the chance of selecting a non-optimal strategy increases as the associated cost decreases. The QR model has received widespread support in the literature in terms of its superior ability to model human behavior in games, including in recent multi-agent systems literature. An even more relevant study in the context of security games showed that defender security allocations assuming a quantal response model of adversary behavior outperformed several competing models in experiments with human subjects. QR is among the best-performing current models and one that allows tuning of the ‘adversary rationality level’ as explained later. Hence this model is one that can be practically used by security agencies desiring to not be locked into adversary models of perfect rationality.

Unfortunately, in computing optimal defender strategies in security games assuming an adversary with quantal response (QR-adversary), facing two major difficulties: (1) solving a nonlinear non-convex optimization problem efficiently for massive real-world security games; and (2) addressing resource assignment constraints in security games, which adds to the complexity of computing the optimal defender strategy. Yet, scaling-up to massive security problems and handling constraints on resource assignments are essential to address real-world problems such as computing strategies for Federal Air Marshals Service (FAMS) and the US Coast Guard (USCG).

The algorithm BRQR has been used to solve a Stackelberg security game with a QR-adversary. BRQR however is not guaranteed to converge to the optimal solution, as it used a nonlinear solver with multi-starts to obtain an efficient solution to a non-convex optimization problem. Furthermore, such use of BRQR did not consider resource assignment constraints that are included in this paper. Nevertheless, GOSAQ and PASAQ are compared herein to the performance of BRQR, since it is the benchmark algorithm. Another existing algorithm that efficiently computes the Quantal Response Equilibrium only applies to cases where all the players have the same level of errors in their quantal response, a condition not satisfied in security games. In particular, in security games, the defender's strategy is based on a computer-aided decision-making tool, and therefore it is a best response. Adversaries, on the other hand, are human beings who may have biases and preferences in their decision making, so they are modeled with a quantal response. Therefore, new algorithms have been developed, as presented herein, to compute the optimal defender strategy when facing a QR-adversary in real-world security problems.

In the present disclosure, the following five contributions are provided. First, an algorithm called GOSAQ is provided to compute the defender optimal strategy against a QR-adversary. GOSAQ uses a binary search method to iteratively estimate the global optimal solution rather than searching for it directly, which would require solving a nonlinear and non-convex fractional problem. It also uses a nonlinear variable transformation to convert the problem into a convex problem. GOSAQ leads to a ∈-optimal solution, where ∈ can be arbitrarily small. Second, another algorithm called PASAQ is provided to approximate the optimal defender strategy. PASAQ is also based on binary search. It then converts the problem into a Mixed-Integer Linear Programming problem by using a piecewise linear approximation. PASAQ leads to an efficient approximation of the global optimal defender strategy and provides an arbitrarily near-optimal solution with a sufficiently accurate linear approximation. Third, GOSAQ and PASAQ both show that they cannot only solve problems without resource assignment constraints, such as for the LAX police, but also problems with resource assignment constraints, such as problems for FAMS and USCG. Fourth, the correctness/approximation-bound proof of GOSAQ and PASAQ is provided. Fifth, detailed experimental analysis is provided on the solution quality and computational efficiency of GOSAQ and PASAQ, illustrating that both GOSAQ and PASAQ achieve better solution quality and runtime scalability than the previous benchmark algorithm BRQR. Indeed, PASAQ can potentially be applied to most of the real-world deployments of the Stackelberg Security Game, including ARMOR and IRIS, that are based on a perfect rationality model of the adversary. This may improve the performances of such systems when dealing with human adversaries.

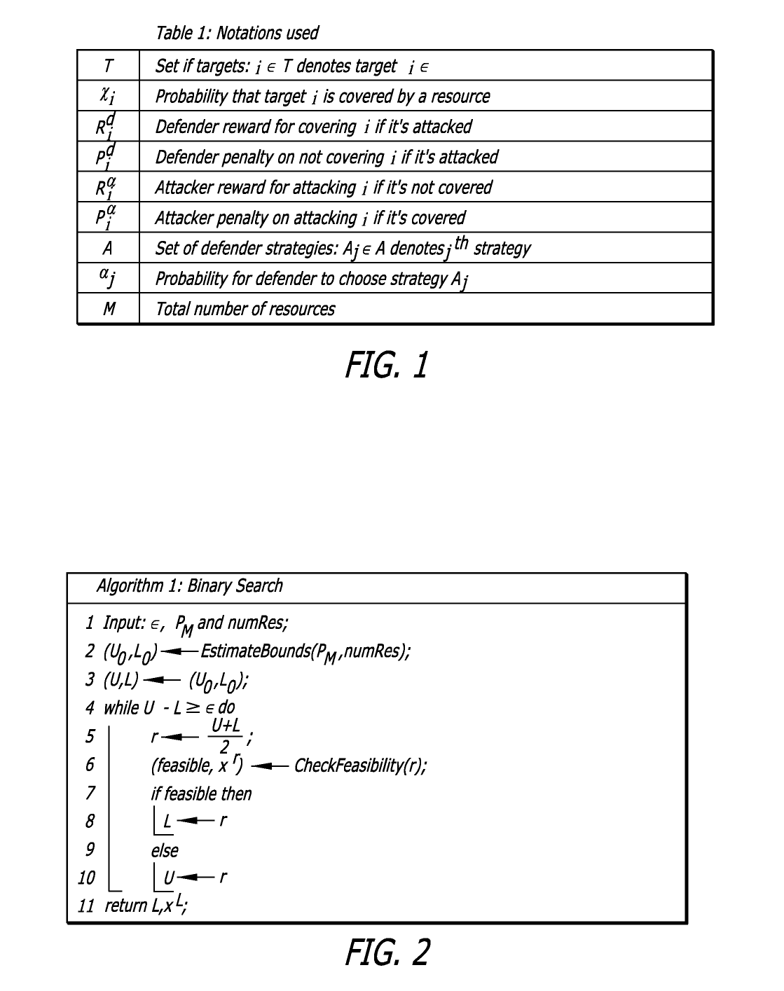

For a statement of the problem, consider a Stackelberg Security Game (SSG) with a single leader and at least one follower, where the defender plays the role of the leader and the adversary plays the role of the follower. The defender and attacker may represent organizations and need not be single individuals. The following notation to describe a SSG is used, also listed in Table 1 shown in FIG. 1. For this, the defender has a total of M resources to protect a set of targets [symbol] ={1, . . . , [symbol] }. The outcomes of the SSG depend only on whether or not the attack is successful. So given a target i, the defender receives reward Rᵢ^{d} if the adversary attacks a target that is covered by the defender; otherwise, the defender receives penalty Pᵢ^{d}. Correspondingly, the attacker receives penalty Pᵢ^{a} in the former case; and reward Rᵢ^{a} in the latter case. Note that a key property of SSG is that while the games may be non-zero-sum, Rᵢ^{d}>Pᵢ^{d} and Rᵢ^{a}, ∀i [9]. In other words, adding resources to cover a target helps the defender and hurts the attacker.

The j^{th} individual defender strategy can be denoted as Aⱼ, which is an assignment of all the security resources. Generally, Aⱼ could be represented as a column vector Aⱼ= [symbol] Aᵢⱼ [symbol] ^{T}, where Aᵢⱼ indicates whether or not target i is covered by assignment j. Let [symbol] ={Aⱼ} be the set of feasible assignments of resources and let aⱼ be the probability of selecting strategy j. Given this probability of selecting defender strategies, the likelihood protecting any specific target i can be computed as the marginal xᵢ= [symbol] . The marginals xᵢ clearly sum to M, the total number of resources. Previous work has shown that defender strategies in SSGs can be represented in terms of these marginals, leading to more concise equivalent representations. In particular, the defender's expected utility if the adversary attacks target i can be written as:

Uᵢ^{d}(xᵢ)=xᵢRᵢ^{d}+(1−xᵢ)Pᵢ^{d}

and the adversary's expected utility on attacking target i is

Uᵢ^{a}(xᵢ)=xᵢPᵢ^{a}+(1−xᵢ)Rᵢ^{a}

These marginal coverage vectors can be converted to a mixed strategy over actual defender strategies when there are no resource constraints, such as in ARMOR.

In the presence of constraints on assignments of resources, marginals may result which cannot be converted to probabilities over individual strategies. However, as is show below, this difficulty can be addressed if a complete description of defender strategies is set A. In this case enforcing that the marginals are obtained from a convex combination of these feasible defender strategies can be added.

In SSGs, the goal is to compute a mixed strategy for the leader to commit to based on her knowledge of the adversary's response. More specifically, given that the defender has limited resources (e.g., she may need to protect 8 targets with 3 guards), she must design her strategy to optimize against the adversary's response to maximize effectiveness.

Optimal Strategy Against Quantal Response

In this section of the present disclosure, assuming a QR-adversary, i.e. with a quantal response [symbol] qᵢ, i∈T [symbol] to the defender's mixed strategy x= [symbol] xᵢ, i∈T [symbol] . The value qᵢ is the probability that adversary attacks target i, computed as

$${q}_{i} ( x ) = \frac{{e}^{λ {U}_{i}^{a} ( xi )}}{{\sum }_{k ∈ 𝒯} {e}^{λ {U}_{k}^{a} ( {x}_{k} )}} \qquad ( 1 )$$

where λ≧0 is the parameter of the quantal response mode, which represents the error level in adversary's quantal response. Simultaneously, the defender maximizes her utility (given her computer-aided decision making tool):

$${U}^{d} ( x ) = {\sum }_{i ∈ T} {q}_{i} ( x ) {U}_{i}^{d} ( {x}_{i} )$$

Therefore, in domains without constraints on assigning the resources, the problem of computing the optimal defender strategy against a QR-adversary can be written in terms of marginals as:

$$P 1 \text{:} \{ \begin{matrix}{max}_{x} \frac{{\sum }_{i ∈ T} {e}^{λ {R}_{i}^{a}} {e}^{- λ ( {R}_{i}^{a} - {P}_{i}^{a} ) {x}_{i}} ( ( {R}_{i}^{d} - {P}_{i}^{d} ) {x}_{i} + {P}_{i}^{d} )}{{\sum }_{i ∈ T} {e}^{λ {R}_{i}^{a}} {e}^{- λ ( {R}_{i}^{a} - {P}_{i}^{a} ) {x}_{i}}} \\ s . t . {\sum }_{i ∈ T} {x}_{i} \leq M \\ 0 \leq {x}_{i} \leq 1 , ∀ i ∈ T \end{matrix}$$

Problem P1 has a polyhedral feasible region and is a non-convex fractional objective function.

Resource Assignment Constraint

In many real world security problems, there are constraints on assigning the resources. For example, in the FAMS problem [7], an air marshal is scheduled to protect 2 flights (targets) out of M total flights. The total number of possible schedule is

$$( \begin{matrix}M \\ 2\end{matrix} ) .$$

However, not all of the schedules are feasible, since the flights scheduled for an air marshal have to be connected, e.g. an air marshal cannot be on a flight from A to B and then on a flight C to D. A resource assignment constraint implies that the feasible assignment set A is restricted; not all combinatorial assignment of resources to targets are allowed. Hence, the marginals on targets, x, are also restricted.

Definition 1. Consider a marginal coverage x to be feasible if and only if there exists aⱼ≧0, Aⱼ∈A such that [symbol] aⱼ=1 and for all i∈T, xᵢ= [symbol] aⱼAᵢⱼ.

In fact, [symbol] aⱼ [symbol] is the mixed strategy over all the feasible assignments of the resources. In order to compute the defender's optimal strategies against a QR-adversary in the presence of resource-assignment constraints, solving P2 is needed. The constraints in P1 are modified to enforce feasibility of the marginal coverage.

$$P 2 \text{:} \{ \begin{matrix}{max}_{x} \frac{{\sum }_{i ∈ T} {e}^{λ {R}_{i}^{a}} {e}^{- λ ( {R}_{i}^{a} - {P}_{i}^{a} ) {x}_{i}} ( ( {R}_{i}^{d} - {P}_{i}^{d} ) {x}_{i} + {P}_{i}^{d} )}{{\sum }_{i ∈ T} {e}^{λ {R}_{i}^{a}} {e}^{- λ ( {R}_{i}^{a} - {P}_{i}^{a} ) {x}_{i}}} \\ s . t . {\sum }_{i ∈ T} {x}_{i} \leq M \\ 0 \leq {x}_{i} \leq 1 , ∀ i ∈ T \\ {\sum }_{{A}_{j} ∈ A} {a}_{j} = 1 \\ 0 \leq {a}_{j} \leq 1 , ∀ {A}_{j} ∈ A \end{matrix}$$

Binary Search Method

Solve P1 and P2 is needed to compute the optimal defender strategy, which requires optimally solving a non-convex problem which is in general an NP-hard problem [16]. In this section, the basic structure of using a binary search method to solve the two problems is described. However, further efforts are required to convert this skeleton into actual efficiently runnable algorithms. The additional details in the next two sections will be filled in.

For notational simplicity, the symbols ∀i∈ [symbol] are defined in Table 2. The numerator and denominator of the objective function in P1 and P2 by N(x) and D(x) are denoted:

TABLE 2
Symbols for Targets in SSG

| | | |
|---|---|---|
| θᵢ := e^{λR}^{ᵢ}^{^{a}} > 0 | βᵢ := λ(Rᵢ^{a} − Pᵢ^{a}) > 0 | αᵢ := (Rᵢ^{d} − Pᵢ^{d}) > 0 |

N(x)= [symbol] θᵢαᵢxᵢe^{-βix}^{ᵢ}+ [symbol] θᵢPᵢ^{d}e^{-β}^{ᵢ}^{x}^{ᵢ}
D(x)= [symbol] θᵢe^{-β}^{ᵢ}^{x}^{ᵢ}>0

A key idea of the binary search method is to iteratively estimate the global optimal value (p*) of the fractional objective function of P1, instead of searching for it directly. Let X_{f} be the feasible region of P1 (or P2). Given a real value r, it can be known whether r≦p* by checking,

∃x∈X_{f},s.t.rD(x)−N(x)≦0 (2)

Justification is now given for correctness of the binary search method to solve any generic fractional programming problem max_{x∈X}_{_{f}}N(x)/D(x) for any functions N(x) and D(x)>0.

Lemma 1. For any real value r∈R, one of the following two conditions holds.

(a) r≦p* [symbol] ∃x∈X_{f}, s.t., rD(x)−N(x)≦0

(b) r≦p* [symbol] ∀x∈X_{f}, rD(x)−N(x)>0

PROOF. (a) as (b) is proven similarly. ‘ [symbol] ’: since ∃x such that rD(x)≦N(x) this means that

$$r \leq \frac{N ( x )}{D ( x )} \leq {p}^{*} ; {}^{′} {⇒}^{′} \text{:}$$

Since P1 optimizes a continuous objective over a closed convex set, then there exists any optimal solution x* such that

$${p}^{*} = \frac{N ( {x}^{*} )}{D ( {x}^{*} )} \leq r$$

which rearranging gives the result.

As shown in FIG. 2, Algorithm 1, describes the basic structure of the binary search method. Given the payoff matrix (P_{M}) and the total number of security resources (numRes), Algorithm 1 first initializes the upper bound (U₀) and lower bound (L₀) of the defender expected utility on Line 2. Then in each iteration, r is set to be the mean of U and L. Line 6 checks whether the current r satisfies Equation (2). If so, p*≧r, the lower-bound of the binary search needs to be increased; in this case, it also returns a valid strategy x^{r}. Otherwise, p*<r, the upper-bound of the binary search should be decreased. The search continues until the upper-bound and lower-bound are sufficiently close, i.e., U−L<∈. The number of iterations in Algorithm 1 is bounded by

$$O ( log ( \frac{{U}_{0} - {L}_{0}}{ɛ} ) ) .$$

Specifically for SSGs the upper and lower bounds can be estimated as follows:

Lower bound: Let sᵤ be any feasible defender strategy. The defender utility based on using sᵤ against a adversary's quantal response is a lower bound of the optimal solution of P1. A simple example of sᵤ is the uniform strategy.

Upper bound: Since Pᵢ^{d}≦Uᵢ^{d}≦Rᵢ^{d} then the following can be stated: Uᵢ^{d}≦ [symbol] Rᵢ^{d}. The defender's utility is computed as [symbol] qᵢY=Uᵢ^{d}, where Uᵢ^{d} is the defender utility on target i and qᵢ, is the probability that the adversary attacks target i. Thus, the maximum Rᵢ^{d} serves as an upper bound of Uᵢ^{d}.

Turning now to feasibility checking, which is performed in Step 6 in Algorithm 1. Given a real number r∈R, in order to check whether Equation (2) is satisfied, introduction is made to CF-OPT.

$$CF - OPT \text{:} {min}_{x ∈ {X}_{f}} rD ( x ) - N ( x )$$

Let δ* be the optimal objective function of the above optimization problem. If δ*≦0, Equation (2) must be true. Therefore, by solving the new optimization problem and checking if δ*≦0, an answer can be made if a given r is larger or smaller than the global maximum. However, the objective function in CF-OPT is still non-convex, therefore, solving it directly is still a hard problem. Two methods to address this in the next two sections will be introduced.

GOSAQ: Algorithm 1+Variable Substitution

Global Optimal Strategy Against Quantal response (GOSAQ) is now presented, which adapts Algorithm 1 to efficiently solve problems P1 and P2. It does so through the following nonlinear invertible change of variables:

yᵢ=e^{-β}^{ᵢ}^{x}^{ᵢ},∀i∈ [symbol] (3)

GOSAQ with No Assignment Constraint

Focusing first on applying GOSAQ to solve P1 for problems with no resource assignment constraints. Here, GOSAQ uses Algorithm 1, but with a rewritten CF-OPT as follows given the above variable substitution:

$$\begin{matrix}{min}_{y} r {\sum }_{i ∈ T} {θ}_{i} {y}_{i} - {\sum }_{i ∈ T} {θ}_{i} {P}_{i}^{d} {y}_{i} - {\sum }_{i ∈ T} \frac{{α}_{i} {θ}_{i}}{{β}_{i}} {y}_{i} ln ( {y}_{i} ) \\ s . t . r {\sum }_{i ∈ T} \frac{- 1}{{β}_{i}} ln ( {y}_{i} ) \leq M & ( 4 ) \\ {e}^{- {β}_{i}} \leq {y}_{i} \leq 1 , ∀ i & ( 5 )\end{matrix}$$

Let's refer to the above optimization problem as GOSAQ-CP.

Lemma 2. Let Obj_{CF}(x) and Obj_{CF}(y) be the objective function of CF-OPT and GOSAQ-CP respectively; X_{f} and Y_{f} denote the feasible domain of CF-OPT and GOSAQ-CP respectively:

$${min}_{x ∈ {X}_{f}} {Obj}_{CF} ( x ) = {min}_{y ∈ {Y}_{f}} {bj}_{CF} ( y )$$

The proof, omitted for brevity, follows from the variable substitution in equation 6. Lemma 2 indicates that solving GOSAQ-CP is equivalent to solving CF-OPT. The following shows that GOSAQ-CP is actually a convex optimization problem.

Lemma 3. GOSAQ-CP is a convex optimization problem with a unique optimal solution.

PROOF. Showing that both the objective function and the nonlinear constraint function (4) in GOSAQ-CP are strictly convex by taking second derivatives and showing that the Hessian matrices are positive definite. The fact that the objective is strictly convex implies that it can have only one optimal solution.

In theory, convex optimization problems like the one above, can be solved in polynomial time through the ellipsoid method or interior point method with the volumetric barrier function (in practice there are a number of nonlinear solvers capable of finding the only Karush-Kuhn-Tucker (KKT) point efficiently). Hence, GOSAQ entails running Algorithm 1, performing Step 6 with

$$O ( log ( \frac{{U}_{0} - {L}_{0}}{∈} ) )$$

times, and each time solving GOS-CP which is polynomial solvable. Therefore, GOSAQ is a polynomial time algorithm.

The bound of GOSAQ 's solution quality is now shown.

Lemma 4. Let L* and U* be the lower and upper bounds of GOSAQ when the algorithm stops, and x* is the defender strategy returned by GOSAQ. Then,

L*≦Obj_{P1}(x*)≦U* where Obj_{P1}(x) denotes the objective function of P1.

PROOF. Given r, Let δ*(r) be the minimum value of the objective function in GOSAQ-CP. When GOSAQ stops, δ*(L*)≦0, because from Lines 6-8 of Algorithm 1, updating the lower bound requires it. Hence, from Lemma 2,

$${L}^{*} D ( {x}^{*} ) - N ( {x}^{*} ) \leq 0 ⇒ {L}^{*} \leq \frac{N ( {x}^{*} )}{D ( {x}^{*} )} . \\ Similarly , {δ}^{*} ( {U}^{*} ) \leq 0 ⇒ {U}^{*} > \frac{N ( {x}^{*} )}{D ( {x}^{*} )} .$$

Theorem 1. Let x* be the defender strategy computed by GOSAQ,

0≦p*−Obj_{P1}(x*)≦∈ (7)

PROOF. p* is the global maximum of P1, so p*−Obj_{P1}(x*). Let L* and U* be the lower and upper bound when GOSAQ stops. Based on Lemma 4, L*≦Obj_{P1}(x*)≦U*. Simultaneously, Algorithm 1 indicates that L*≦p*(x*)≦U*.

Therefore, 0≦p*−Obj_{P1}(x*)≦U*−L*≦∈.

Theorem 1 indicates that the solution obtained by GOSAQ is an ∈-optimal solution.

GOSAQ with Assignment Constraints

In order to address the assignment constraints, P2 needs to be solved. Note that the objective function of P2 is the same as that of P1. The difference lies in the extra constraints which enforce the marginal coverage to be feasible. Therefore Algorithm 1 is used once again with variable substitution given in Equation 3, but modify GOSAQ-CP as follows (which is referred as GOSAQ-CP-C) to incorporate the extra constraints:

$$\begin{matrix}{min}_{y , a} r {\sum }_{i ∈ T} {θ}_{i} {y}_{i} - {\sum }_{i ∈ T} {θ}_{i} {P}_{i}^{d} {y}_{i} + {\sum }_{i ∈ T} \frac{{α}_{i} {θ}_{i}}{{β}_{i}} {y}_{i} ln ( {y}_{i} ) \\ s . t . Constraint ( 4 ) , ( 5 ) \\ \frac{- 1}{{β}_{i}} ln ( {y}_{i} ) = {\sum }_{{A}_{j} ∈ A} {a}_{j} {A}_{ij} , ∀ i ∈ T & ( 8 ) \\ {\sum }_{{A}_{j} ∈ A} {a}_{j} = 1 & ( 9 ) \\ 0 \leq {a}_{j} \leq 1 , {A}_{j} ∈ A & ( 10 )\end{matrix}$$

Equation (8) is a nonlinear equality constraint that makes this optimization problem non-convex. There are no known polynomial time algorithms for generic non-convex optimization problems, which can have multiple local minima. Attempts can be made to solve such non-convex problems by using one of the efficient nonlinear solvers, but a Karush-Kuhn-Tucker (KKT) point would be obtained which can be only locally optimal. There are a few research grade global solvers for non-convex programs, however they are limited to solving specific problems or small instances. Therefore, in the presence of assignment constraints, GOSAQ is no longer guaranteed to return the optimal solution as might be left with locally optimal solutions when solving the subproblems GOSAQ-CP-C.

PASAQ: Algorithm 1+Linear Approximation

Since GOSAQ may be unable to provide a quality bound in the presence of assignment constraints (and as shown later, may turn out to be inefficient in such cases), the Piecewise linear Approximation of optimal Strategy Against Quantal response (PASAQ) is proposed. PASAQ is an algorithm to compute the approximate optimal defender strategy. PASAQ has the same structure as Algorithm 1. The key idea in PASAQ is to use a piecewise linear function to approximate the nonlinear objective function in CF-OPT, and thus convert it into a Mixed-Integer Linear Programming (MILP) problem. Such a problem can easily include assignment constraints giving an approximate solution for a SSG against a QR-adversary with assignment constraints.

In order to demonstrate the piecewise approximation in PASAQ, the nonlinear objective function of CF-OPT is rewritten as:

$${\sum }_{i ∈ T} {θ}_{i} ( r - {P}_{i}^{d} ) {e}^{- {β}_{i} {x}_{i}} + {\sum }_{i ∈ T} {θ}_{i} {α}_{i} {x}_{i} {e}^{- {β}_{i} {x}_{i}}$$

The goal is to approximate the two nonlinear function ƒᵢ⁽¹⁾(xᵢ)=e^{-β}^{ᵢ}^{x}^{ᵢ} and ƒᵢ⁽²⁾(xᵢ)=xᵢe^{-β}^{ᵢ}^{x}^{ᵢ} as two piecewise linear functions in the range xᵢ∈[0,1], for each i=1 . . . [symbol] . Uniformly divide the range [0 . . . 1] first into K pieces (segments). Simultaneously, introduce a set of new variables {xᵢₖ,k=11 . . . K} to represent the portion of xᵢ in each of the K pieces,

$$\{ [ \frac{k - 1}{K} , \frac{k}{K} ] , k = 1 … K \} .$$

### Therefore,

$${x}_{ik} ∈ [ 0 , \frac{1}{K} ] , \\ ∀ k = 1 … K and$$

$${x}_{i} {\sum }_{k = 1}^{K} {x}_{ik} .$$

In order to ensure that {xᵢₖ} is a valid partition of xᵢ, all xᵢₖ must satisfy: xᵢₖ>0 only if

$${x}_{{ik}^{′}} = \frac{1}{K} , \\ ∀ {k}^{′} < k .$$

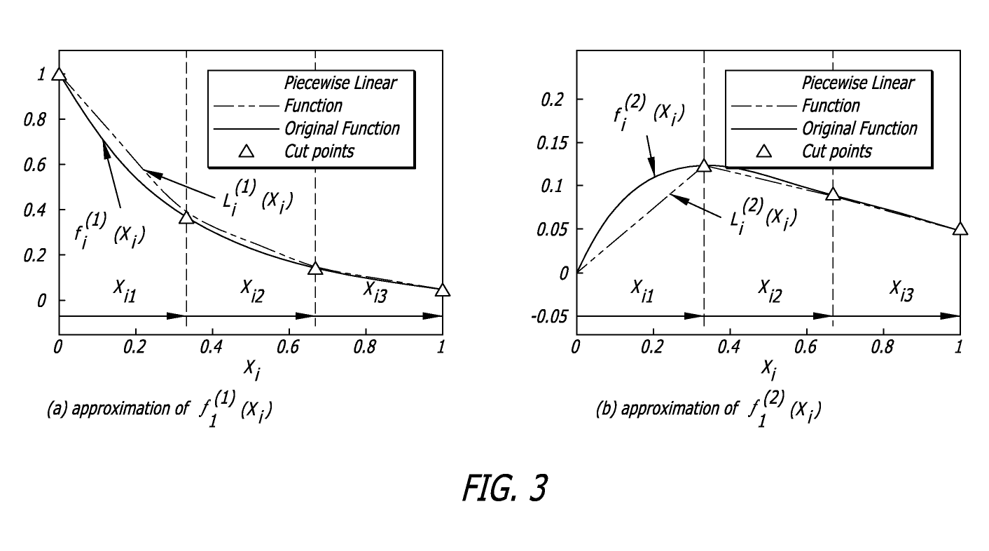

In other words, xᵢₖ can be non-zero only when all the previous pieces are completely filled. FIG. 3, which includes FIGS. 3(a) and 3(b), displays two examples of such a partition.

Thus, the two nonlinear functions can be represented as piecewise linear functions using {xᵢₖ}.

$$Let \{ ( \frac{k - 1}{K} , {f}_{i}^{( 1 )} ( \frac{k}{K} ) ) , k = 0 … K \}$$

be the K+1 cut-points of the linear segments of function ƒᵢ⁽¹⁾(xᵢ), and {γᵢₖ,k=1 . . . K} be the slopes of each of the linear segments. Starting from ƒᵢ⁽¹⁾(0), the piecewise linear approximation of ƒᵢ⁽¹⁾(xᵢ), denoted as Lᵢ⁽¹⁾(xᵢ):

$${L}_{i}^{( 1 )} ( {x}_{i} ) = {f}_{i}^{( 1 )} ( 0 ) + {\sum }_{k = 1}^{K} {γ}_{ik} {x}_{ik} = 1 + {\sum }_{k = 1}^{K} {γ}_{ik} {x}_{ik}$$

Similarly, the piecewise linear approximation of ƒᵢ⁽²⁾(xᵢ), can be obtained denoted as Lᵢ⁽²⁾(xᵢ):

$${L}_{i}^{( 2 )} ( {x}_{i} ) = {f}_{i}^{( 2 )} ( 0 ) + {\sum }_{k = 1}^{K} {μ}_{ik} {x}_{ik} = 1 + {\sum }_{k = 1}^{K} {μ}_{ik} {x}_{ik}$$

where, {μᵢₖ,k=1 . . . K} is the slope of each linear segment.

TABLE 3
Notations for Error Bound Proof.

| | | |
|---|---|---|
| $\underline{θ} : {min {θ}_{i}}_{i ∈ 𝒯}$ | $\overline{{R}^{d}} := {max}_{i ∈ 𝒯} \vert {R}_{i}^{d} \vert$ | $\overline{β} := {max}_{i ∈ 𝒯} {β}_{i}$ |
| $\underline{θ} : {max {θ}_{i}}_{i ∈ 𝒯}$ | $\overline{{P}^{d}} := {max}_{i ∈ 𝒯} \vert {P}_{i}^{d} \vert$ | $\overline{β} := {max}_{i ∈ 𝒯} {α}_{i}$ |

PASAQ with No Assignment Constraint

In domains without assignment constraints, PASAQ consists of Algorithm 1, but with CF-OPT rewritten as follows:

$$\begin{matrix}{min}_{x , z} {\sum }_{i ∈ 𝒯}^{ } {θ}_{i} ( r - {P}_{i}^{d} ) ( 1 + {\sum }_{k = 1}^{K} {γ}_{ik} {x}_{ik} ) + {\sum }_{i ∈ 𝒯}^{ } {θ}_{i} {α}_{i} {\sum }_{k - 1}^{K} {μ}_{ik} {x}_{ik} & \\ s . t . {\sum }_{i ∈ 𝒯}^{ } {\sum }_{k = 1}^{K} {x}_{ik} \leq M & ( 11 ) \\ 0 \leq {x}_{ik} \leq \frac{1}{K} , \\ ∀ i , \\ k = 1 … K & ( 12 ) \\ {z}_{ik} \frac{1}{K} \leq {x}_{ik} , \\ ∀ i , \\ k = 1 … K - 1 & ( 13 ) \\ {x}_{ik ( k + 1 )} \leq {z}_{ik} , \\ ∀ i , \\ k = 1 … K - 1 & ( 14 ) \\ {z}_{ik} ∈ \{ 0 , 1 \} , \\ ∀ i , \\ k = 1 … K - 1 & ( 15 )\end{matrix}$$

Let's refer to the above MILP formulation as PASAQ-MILP.

Lemma 5. The feasible region for x= [symbol] xᵢ=Σₖ₌₁^{K}xᵢₖ,i∈ [symbol] [symbol] of PASAQ-MILP is equivalent to that of P1.

JUSTIFICATION. The auxiliary integer variable zᵢₖ indicates whether or not

$${x}_{ik} < \frac{1}{K} .$$

Equation (13) enforces that zᵢₖ=0 only when

$${x}_{ik} < \frac{1}{K} .$$

Simultaneously, Equation (14) enforces that xᵢ₍ₖ₊₁₎ is positive only if zᵢₖ=1. Hence, {xᵢₖ,K=1 . . . K} is a valid partition of xᵢ and xᵢ=Σₖ₌₁^{K}xᵢₖ and that xᵢ∈[0,1]. Thus, the feasible region of PASAQ-MILP is equivalent to P1.

Lemma 5 shows that the solution provided by PASAQ is in the feasible region of P1. However, PASAQ approximates the minimum value of CF-OPT by using PASAQ-MILP, and furthermore solves P1 approximately using binary search. Hence, an error bound needs to be shown on the solution quality of PASAQ.

Lemma 6, 7 and 8 is first shown on the way to build the proof for the error bound. Due to space constraints, many proofs are abbreviated; full proofs have been derived and made available in an on-line appendix. Further, two constants are defined which are decided by the game payoffs: C₁=( θ̅/θ)e ^{β̅}{( R̅^̅{̅d̅}̅+ P̅^̅{̅d̅}̅) β̅+ α̅} and C₂=( θ̅/θ)e ^{β̅}. The notation used is defined in Table 3. The following, illustrates obtaining a bound on the difference between p* (the global optimal obtained from P1) and Obj_{P1}(\tilde{x}*), where (\tilde{x}*) is the strategy obtained from PASAQ. However, along the way, a bound has to be obtained for the difference between Obj_{P1}(\tilde{x}*) and its corresponding piecewise linear approximation O\tilde{b}j_{P1}(\tilde{x}*).

Lemma 6. Let Ñ(x)= [symbol] θᵢαᵢLᵢ⁽²⁾(xᵢ)+ [symbol] θᵢPᵢ^{d}Lᵢ⁽¹⁾(xᵢ) and \tilde{D}(x)= [symbol] θᵢLᵢ⁽¹⁾(xᵢ)>0 be the piecewise linear approximation of N(x) and D(x) respectively. Then, ∀x∈X_{f}

$$\vert N ( x ) - \tilde{N} ( x ) \vert \leq ( \overline{θ} \overline{α} + \overline{{P}^{d}} \overline{θ β} ) \frac{\vert 𝒯 \vert}{K}$$

Lemma 7. The difference between the objective function of P1, Obj_{P1}(x), and its corresponding piecewise linear approximation Obj_{P1}(x), is less than

$${C}_{1} \frac{1}{K}$$

PROOF.

$$\begin{matrix}\vert {Obj}_{P 1} ( x ) - O \tilde{b} {j}_{P 1} ( x ) \vert = \vert \frac{N ( x )}{D ( x )} - \frac{\tilde{N} ( x )}{\tilde{D} ( x )} \vert \\ = \vert \frac{N ( x )}{D ( x )} - \frac{N ( x )}{\tilde{D} ( x )} + \frac{N ( x )}{\tilde{D} ( x )} - \frac{\tilde{N} ( x )}{\tilde{D} ( x )} \vert \leq \\ \frac{1}{\tilde{D} ( x )} ( \vert {Obj}_{P 1} ( x ) \vert \vert D ( x ) - \tilde{D} ( x ) \vert + \vert N ( x ) - \tilde{N} ( x ) \vert )\end{matrix}$$

Based on Lemma 6, |Obj_{P1}(x)|≦ R̅^̅{̅d̅}̅, and \tilde{D}(x)≧ [symbol] θe^{- β̅}.

$$\vert {Obj}_{P 1} ( x ) - O \tilde{b} {j}_{P 1} ( x ) \vert \leq {C}_{1} \frac{1}{K}$$

Lemma 8. Let \tilde{L}* and L* be final lower bound of PASAQ and GOSAQ,

$$L * \tilde{L} * \leq {C}_{1} \frac{1}{K} + {C}_{2} ∈$$

Lemma 9. Let \tilde{L}* and Ũ* be the final lower and upper bounds of PASAQ, and \tilde{x}* is the defender strategy returned by PASAQ. Then,

\tilde{L}*≦O\tilde{b}j_{P1}(\tilde{x}*)≦Ũ*

Theorem 2. Let \tilde{x}* be the defender strategy computed by PASAQ, p* is the global optimal defender expected utility,

$$0 \leq p * {Obj}_{P 1} ( \tilde{x} *) \leq 2 {C}_{1} \frac{1}{K} + ( {C}_{2} + 1 ) ɛ$$

PROOF. The first inequality is implied since \tilde{x}* is a feasible solution. Furthermore,

p*−Obj_{P1}(\tilde{x}*)=(p*−L*)+(L*−\tilde{L}*)+(\tilde{L}*−Obj_{P1}(\tilde{x}*))

+(O\tilde{b}j_{P1}(\tilde{x}*)−Obj_{P1}(\tilde{x}*))

Algorithm 1 indicates that L*≦p*≦U*, hence p*−L*≦∈. Additionally, Lemma 7, 8 and 9 provide an upper bound on O\tilde{b}j_{P1}(\tilde{x}*)−Obj_{P1}(\tilde{x}*), L*−\tilde{L}* and \tilde{L}*−Obj_{P1}(\tilde{x}*), therefore

$$p * - {Obj}_{P 1} ( \tilde{x} *) \leq ɛ + {C}_{1} \frac{1}{K} + {C}_{2} ɛ + {C}_{1} \frac{1}{K} \leq 2 {C}_{1} \frac{1}{K} + ( {C}_{2} + 1 ) ɛ$$

Theorem 2 suggests that, given a game instance, the solution quality of PASAQ is bounded linearly by the binary search threshold e and the piecewise linear accuracy

$$\frac{1}{K} .$$

Therefore the PASAQ solution can be made arbitrarily close to the optimal solution with sufficiently small ∈ and sufficiently large K.

PASAQ with Assignment Constraints

In order to extend PASAQ to handle the assignment constraints, PASAQ-MILP can be modified as the following, referred to as PASAQ-MILP-C,

$$\begin{matrix}{min}_{x , z , a} {\sum }_{i ∈ 𝒯}^{ } {θ}_{i} ( r - {P}_{i}^{d} ) ( 1 + {\sum }_{k = 1}^{K} {γ}_{ik} {x}_{ik} ) + {\sum }_{i ∈ 𝒯}^{ } {θ}_{i} {α}_{i} {\sum }_{k = 1}^{K} {μ}_{ik} {x}_{ik} \\ s . t . Constraint ( 11 ) \text{-} ( 15 ) & \\ {\sum }_{k = 1}^{K} {x}_{ik} = {\sum }_{{A}_{j} ∈ 𝒜}^{ } {α}_{j} {A}_{ij} , \\ ∀ i ∈ 𝒯 & ( 16 ) \\ {\sum }_{{A}_{j} ∈ 𝒜}^{ } {α}_{j} = 1 & ( 17 ) \\ 0 \leq {a}_{j} \leq 1 , \\ {A}_{j} ∈ 𝒜 . & ( 18 )\end{matrix}$$

PASAQ-MILP-C is a MILP so it can be solved optimally with any MILP solver (e.g., CPLEX). Proving similarly, as for Lemma 5, that the above MILP formulation has the same feasible region as P2. Hence, it leads to a feasible solution of P2. Furthermore, the error bound of PASAQ relies on the approximation accuracy of the objective function by the piecewise linear function and the fact that the subproblem PASAQ-MILP-C can be solved optimally. Both conditions have not changed from the cases without assignment constraints to the cases with assignment constraints. Hence, the error bound is the same as that shown in Theorem 2.

Experimental Results

Verification experiments were performed, and are described herein separated into two sets: the first set focuses on the cases where there is no constraint on assigning the resources; the second set focuses on cases with assignment constraints. In both sets, the solution quality and runtime of the two new algorithms, GOSAQ and PASAQ, is compared with the previous benchmark algorithm BRQR. The results were obtained using CPLEX to solve the MILP for PASAQ. For both BRQR and GOSAQ, the MATLAB toolbox function fmincon was used to solve nonlinear optimization problems. All experiments were conducted on a standard 2.00 GHz machine with 4 GB main memory. For each setting of the experiment parameters (i.e. number of targets, amount of resources and number of assignment constraints), 50 different game instances were used. In each game instance, payoffs Rᵢ^{d} and Rᵢ^{a} are chosen uniformly randomly from 1 to 10, while Pᵢ^{d} and pᵢ^{a} are chosen uniformly randomly from −10 to −1; feasible assignments Aⱼ are generated by randomly setting each element Aᵢⱼ to 0 or 1. For the parameter λ of the quantal response in Equation (1), the same value was used (λ=0.76).

No Assignment Constraints

Experimental results comparing the solution quality and runtime of the three algorithms (GOSAQ, PASAQ and BRQR) was used in cases without assignment constraints.

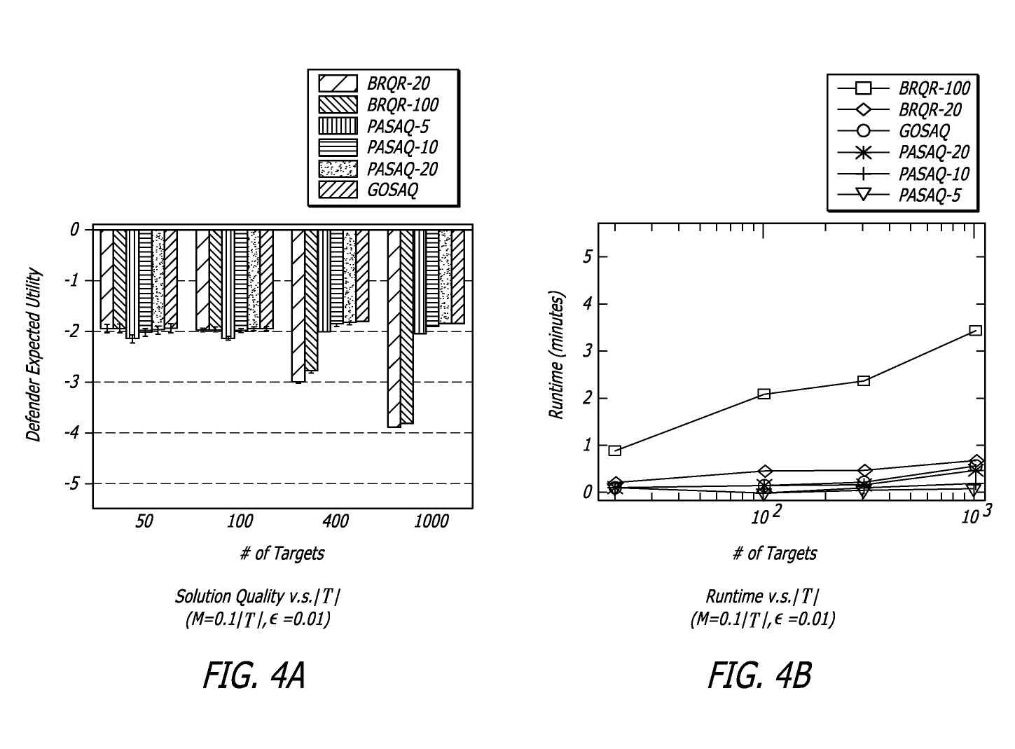

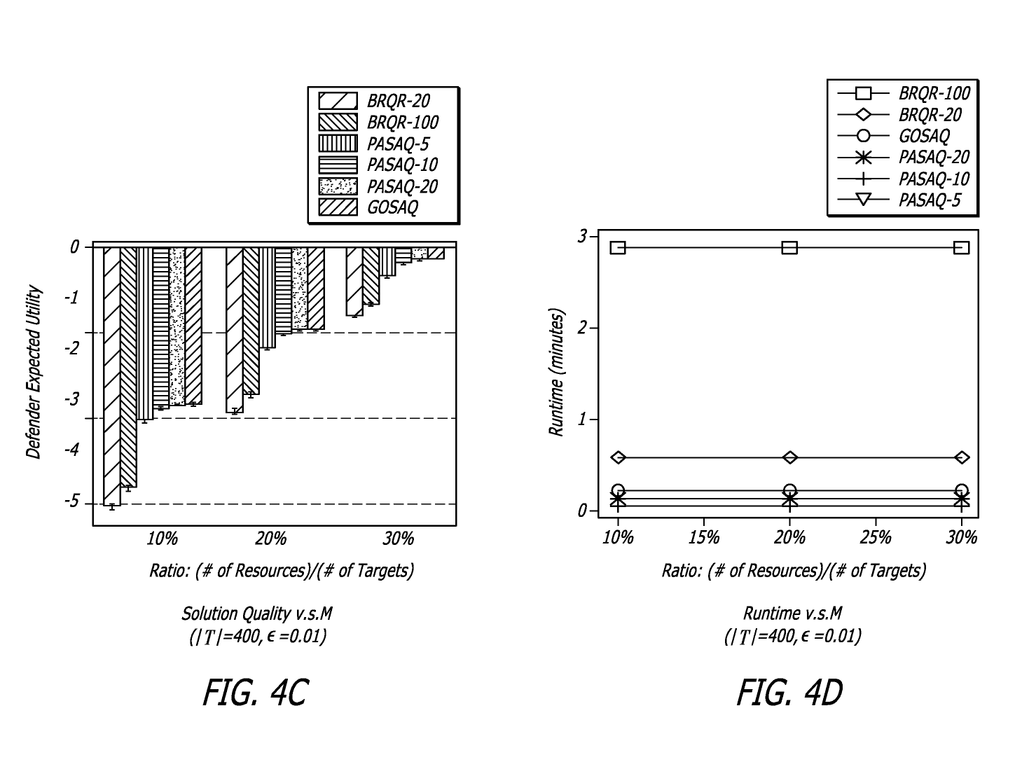

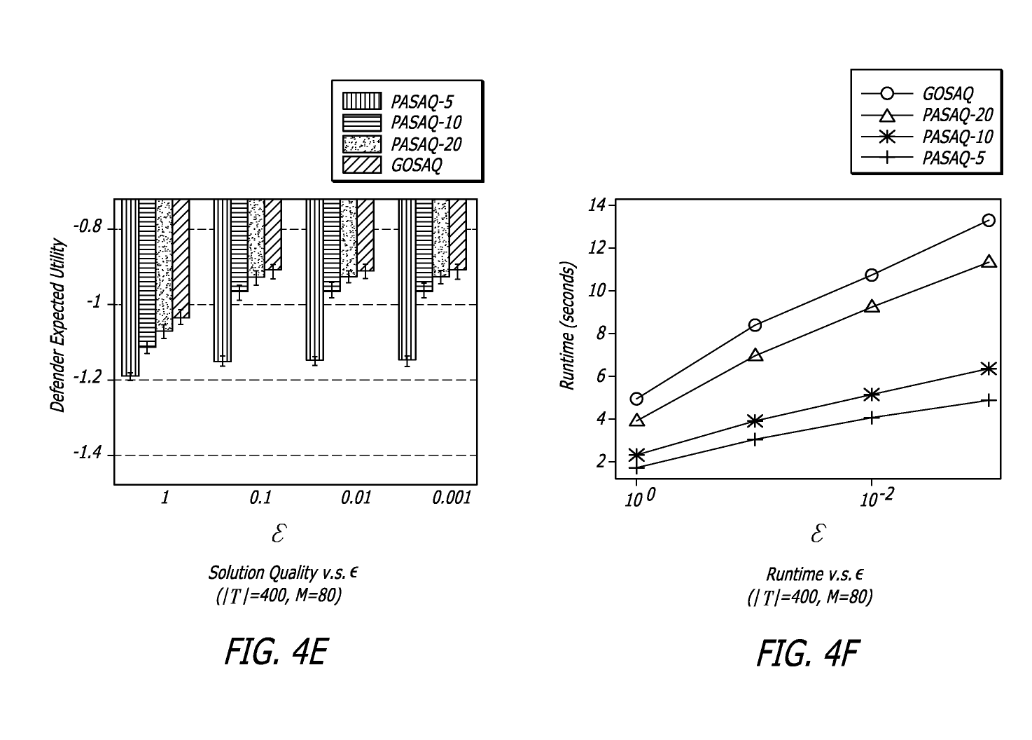

Solution Quality: For each game instance, GOSAQ provides the E-optimal defender expected utility, BRQR presents the best local optimal solution among all the local optimum it finds, and PASAQ leads to an approximated global optimal solution. The solution quality of different algorithms using average defender's expected utility over all the 50 game instances was measured. FIG. 4, includes FIGS. 4(a)-4(f), which show solution quality and runtime comparisons, without assignment constraints, for GOSAQ and PASAQ compared with the previous benchmark algorithm BRQR.

FIGS. 4(a), 4(c) and 4(e) show the solution quality results of different algorithms under different conditions. In all three figures, the average defender expected utility is displayed on the y-axis. On the x-axis, FIG. 4(a) changes the numbers of targets ( [symbol] ) keeping the ratio of resources (M) to targets and ∈ fixed as shown in the caption; FIG. 4(c) changes the ratio of resources to targets fixing targets and ∈ as shown; and FIG. 4(e) changes the value of the binary search threshold ∈. Given a setting of the parameters ( [symbol] , M and ∈), the solution qualities of different algorithms are displayed in a group of bars. For example, in FIG. 4(a), ( [symbol] ) is set to 50 for the leftmost group of bars, M is 5 and ∈=0.01. From left to right, the bars show the solution quality of BRQR (with 20 and 100 iterations), PASAQ (with 5, 10 and 20 pieces) and GOSAQ.

Key observations from FIGS. 4(a), 4(c) and 4(e) include: (i) The solution quality of BRQR drops quickly as the number of targets increases; increasing the number of iterations in BRQR improves the solution quality, but the improvement is very small. (ii) The solution quality of PASAQ improves as the number of pieces increases; and it converges to the Gosaq solution as the number of pieces becomes larger than 10. (iii) As the number of resources increases, the defender expected utility also increase; and the resource count does not impact the relationship of solution quality between the different algorithms. (iv) As ∈ becomes smaller, the solution quality of both GOSAQ and PASAQ improves. However, after epsilon becomes sufficiently small (≦0.1), no substantial improvement is achieved by further decreasing the value of ∈. In other words, the solution quality of both GOSAQ and PASAQ converges.

In general BRQR has the worst solution quality; GOSAQ has the best solution quality. PASAQ achieves almost the same solution quality as GOSAQ when it uses more than 10 pieces.

Runtime: The runtime results are presented in FIGS. 4(b), 4(d) and 4(f). In all three figures, the 7-axis display the runtime, the x-axis displays the variables which were varied in order to measure their impact on the runtime of the algorithms. For BRQR run time is the sum of the run-time across all its iterations.

FIG. 4(b) shows the change in runtime as the number of targets increases. The number of resources and the value of ∈ are shown in the caption. BRQR with 100 iterations is seen to run significantly slower than GOSAQ and PASAQ. FIG. 4(d) shows the impact of the ratio of resource to targets on the runtime. The figure indicates that the runtime of the three algorithms is independent of the change in the number of resources. FIG. 4(f) shows how runtime of GOSAQ and PASAQ is affected by the value of ∈. On the x-axis, the value for ∈ decreases from left to right. The runtime increases linearly as ∈ decreases exponentially. In both FIGS. 4(d) and 4(f), the number of targets and resources are displayed in the caption.

Overall, the results suggest that GOSAQ is the algorithm of choice when the domain has no assignment constraints. Clearly, BRQR has the worst solution quality, and it is the slowest of the set of algorithms. PASAQ has a solution quality that approaches that of GOSAQ when the number of pieces is sufficiently large (≧10), and GOSAQ and PASAQ also achieve comparable runtime efficiency. Thus, in cases with no assignment constraints, PASAQ offers no advantages over GOSAQ.

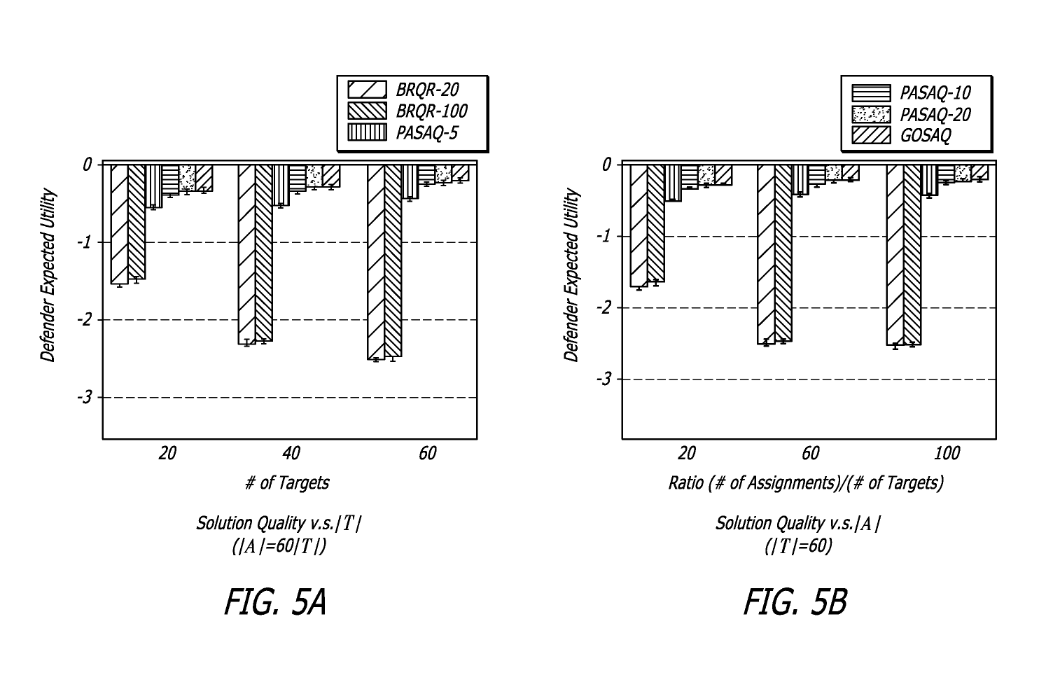

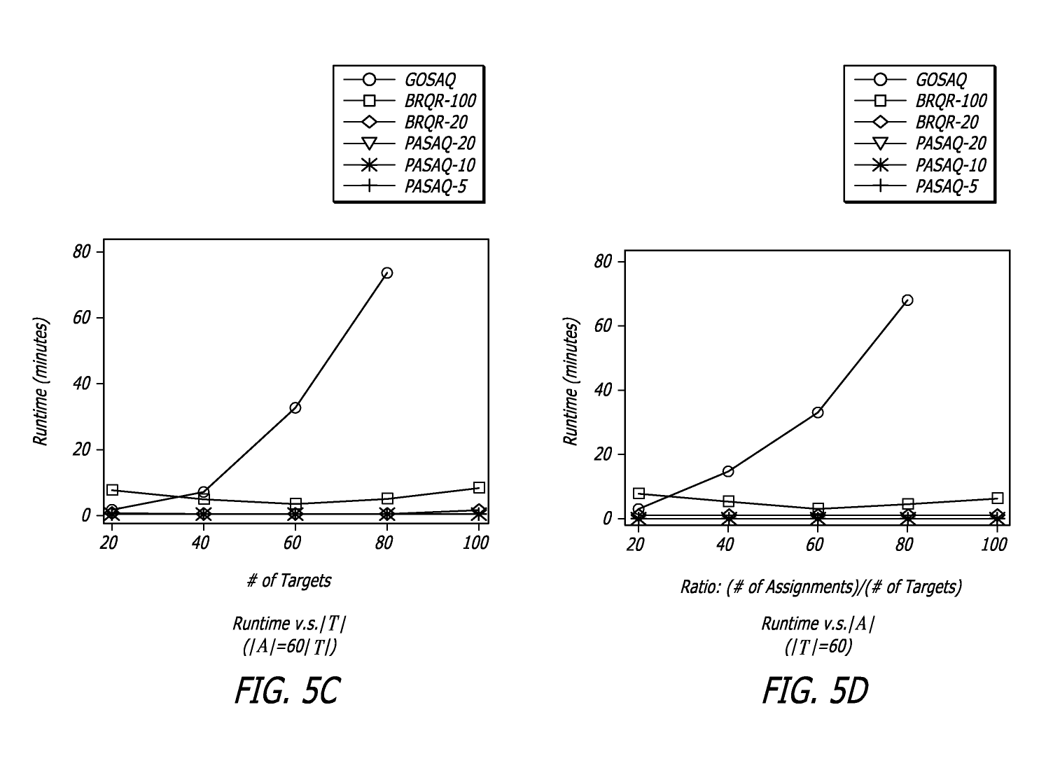

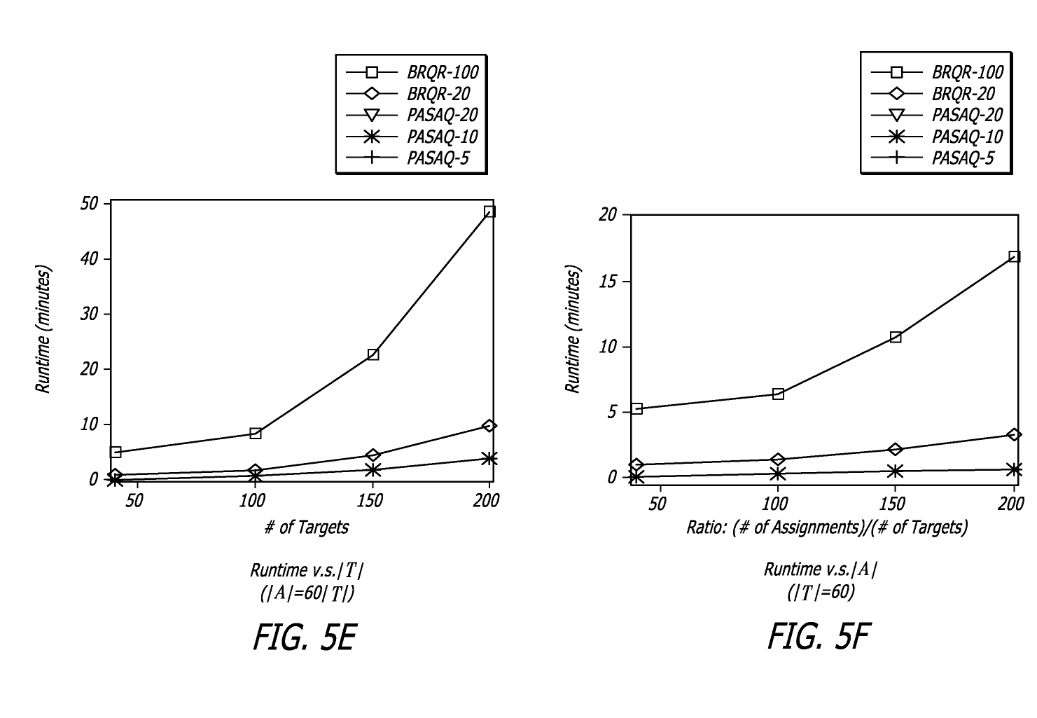

FIG. 5, includes FIGS. 5(a)-5(f), and shows solution quality and runtime comparison, with assignment constraint(s), for GOSAQ and PASAQ compared with the previous benchmark algorithm BRQR.

With Assignment Constraint

In the second set, assignment constraints are introduced into the problem. The feasible assignments are randomly generated. Experimental results are presented on both solution quality and runtime.

Solution Quality: FIGS. 5(a) and 5(b) display the solution quality of the three algorithms with varying number of targets ( [symbol] ) and varying number of feasible assignments ( [symbol] ). In both figures, the average defender utility is displayed on the y-axis. In FIG. 5(a) the number of targets is displayed on the x-axis, and the ration of | [symbol] | to | [symbol] | is set to 60. BRQR is seen to have very poor performance. Furthermore, there is very little gain in solution quality from increasing its number of iterations. While GOSAQ provided the best solution, PASAQ achieves almost identical solution quality when the number of pieces is sufficiently large (>10). FIG. 5(b) shows how solution quality is impacted by the number of feasible assignments, which is displayed on the x-axis. Specifically, the x-axis shows numbers of assignment constraints, A to be 20 times, 60 times and 100 times the number of targets. The number of targets is set to 60. Once again, BRQR has significantly lower solution quality, and it drops as the number of assignments increases; and PASAQ again achieves almost the same solution quality as GOSAQ, as the number the number of pieces is larger than 10.

Runtime: The runtime results in FIGS. 5(c), 5(e), 5(d) and 5(f) are presented. In all experiments, 80 minutes was set as the cutoff. FIG. 5(c) displays the runtime on the y-axis and the number of targets on the x-axis. It is clear that GOSAQ runs significantly slower than both PASAQ and BRQR, and slows down exponentially as the number of targets increases. FIG. 5(e) shows extended runtime result of BRQR and PASAQ as the number of targets increases. PASAQ runs in less than 4 minutes with 200 targets and 12000 feasible assignments. BRQR runs significantly slower with higher number of iterations.

Overall, the results suggest that PASAQ is the algorithm of choice when the domain has assignment constraints. Clearly, BRQR has significantly lower solution quality than PASAQ. PASAQ not only has a solution quality that approaches that of GOSAQ when the number of pieces is sufficiently large (≧10), PASAQ is significantly faster than GOSAQ (which suffers exponential slowdown with scale-up in the domain).

Accordingly, the algorithms described above, including the GOSAQ and PASAQ algorithms, can provide a number of advantages in security games. The GOSAQ can be used to find or guarantee the global optimal solution in computing the defender strategy against an adversary's quantal response. The efficient approximation algorithm, PASAQ, can provide a more efficient computation of the defender strategy with nearly-optimal solution quality (compared to GOSAQ). These algorithms model the human adversaries' bounded rationality using the quantal response (QR) model. Further algorithms are also described for solving problems with resource assignment constraint. This work overcomes the difficulties in developing efficient methods to solve the massive security games in real applications, including solving a nonlinear and non-convex optimization problem and handling constraints on assigning security resources in designing defender strategies.

Section 2—A Unified Method for Handling Discrete and Continuous Uncertainty in Bayesian Stackelberg Games (HUNTER Algorithm)

Another aspect of the present disclosure is directed to a unified method of handling discrete and continuous uncertainty in Bayesian Stackelberg games, i.e., the HUNTER algorithm. Given their existing and potential real-world security applications, Bayesian Stackelberg games have received significant research interest. In these games, the defender acts as a leader, and the many different follower types model the uncertainty over discrete attacker types. Unfortunately since solving such games is an NP-hard problem, scale-up has remained a difficult challenge.

This section of the present disclosure describes methods (or algorithms) for addressing Bayesian Stackelberg games of large scale, where Bayesian Stackelberg refers to a Stackelberg game in which the defender acts as a leader, and there are many different follower types which model the uncertainty over discrete attacker types. The algorithms described herein provide for a unified approach to handling uncertainty not only over discrete follower types but also other key continuously distributed real world uncertainty, due to the leader's execution error, the follower's observation error, and continuous payoff uncertainty. To that end, an aspect of the present disclosure provides a new algorithm is presented for Bayesian Stackelberg games, called HUNTER, which can provide for or accommodate a scale up the number of types used. HUNTER combines one or more of the following five key features: i) efficient pruning via a best-first search of the leader's strategy space; ii) a novel linear program for computing tight upper bounds for this search; iii) using Bender's decomposition for solving the upper bound linear program efficiently; iv) efficient inheritance of Bender's cuts from parent to child; v) an efficient heuristic branching rule. Experimental results have shown that HUNTER provides orders of magnitude speedups over the best existing methods to handle discrete follower types. HUNTER's efficiency for Bayesian Stackelberg games can be exploited to also handle the continuous uncertainty using sample average approximation, as is described below in further detail. HUNTER-based approaches are experimentally shown to also outperform latest robust solution methods under continuously distributed uncertainty.

Introduction

To address the challenge of discrete uncertainty, a novel algorithm for solving Bayesian Stackelberg games, called HUNTER, is described, preferably combining the following five key features. First, the HUNTER algorithm conducts a best-first search in the follower's best-response assignment space, which only expands a small number of nodes (within an exponentially large assignment space). Second, HUNTER computes tight upper bounds to speed up this search using a novel linear program. Third, HUNTER solves this linear program efficiently using Bender's decomposition. Fourth, the Bender's cuts generated in a parent node are shown to be valid cuts for its children, providing further speedups. Finally, HUNTER deploys a heuristic branching rule to further improve efficiency. Thus, this paper's contribution is in combining an AI search technique (best-first search) with multiple techniques from Operations Research (disjunctive program and Bender's decomposition) to provide a novel efficient algorithm; the application of these techniques for solving Stackelberg games had not been explored earlier, and thus their application towards solving these games, as well as their particular synergistic combination in HUNTER are both novel. Experiments have shown that HUNTER can dramatically improve the scalability of the number of types over other existing approaches.

The present disclosure also shows, via sample average approximation, that HUNTER for Bayesian Stackelberg games can be used in handling continuously distributed uncertainty such as the leader's execution error, the follower's observation noise, and both players' preference uncertainty. For comparison, a class of Stackelberg games motivated by security applications are considered, and enhance two existing robust solution methods, BRASS and RECON to handle such uncertainty. HUNTER is again shown to provide significantly better performance than BRASS and RECON. A final set of experiments, described herein, also illustrates HUNTER's ability to handle both discrete and continuous uncertainty within a single problem.

Background and Notation

This part of Section 2 of the present disclosure is focused on solving Bayesian Stackelberg games with discrete follower types, where as noted previously, a Stackelberg game is a multi-party (e.g., two-person) game played by a leader and a follower. In Stackelberg games where the leader commits to a mixed strategy first, the follower observes the leader's strategy and responds with a pure strategy, maximizing his utility correspondingly. This set-up can be generalized by extending the definition of the leader's strategy space and the leader and follower utilities in two ways beyond what has previously been considered and by allowing for compact representation of constraints.

Assuming the leader's mixed strategy is an N-dimensional real column vector x∈R^{N}, bounded by a polytope Ax [symbol] b,x [symbol] 0, generalizes the constraint of Σᵢ xᵢ=1 and allows for compact strategy representation with constraints. Given a leader's strategy x, the follower maximizes his utility by choosing from J pure strategies. For each pure strategy j=1, . . . , J played by the follower, the leader gets a utility of μ_{J}^{T}x+μ,_{j,0} and the follower gets a utility of ν_{J}^{T}x+ν,_{j,0}, where μᵢ,νⱼ are real vectors in R^{N} and μ_{j,0}, v_{j,0}∈R. This use of μ_{j,0},ν_{j,0} terms generalizes the utility functions.

The leader's utility matrix U and the follower's utility matrix V is defined as the following,

$$U = ( \begin{matrix}{μ}_{1 , 0} & … & {μ}_{J , 0} \\ {μ}_{1} & … & {μ}_{J}\end{matrix} ) , \\ V = ( \begin{matrix}{v}_{1 , 0} & … & {v}_{J , 0} \\ {v}_{1} & … & {v}_{J}\end{matrix} )$$

Then for a leader's strategy x, the leader and follower's J utilities for the follower's J pure strategies are U^{T}(ₓ¹) and V^{T}(ₓ¹).

A Bayesian extension to the Stackelberg game allows multiple types of players, each with its own payoff matrix. A Bayesian Stackelberg game can be represented with S follower types by a set of utility matrix pairs (U¹, V¹), . . . , (U^{S}, V^{S}), each corresponding to a type. A type s has a prior probability p^{s} representing the likelihood of its occurrence. The leader commits to a mixed strategy without knowing the type of the follower she faces. The follower, however, knows his own type s, and plays the best response j^{s}∈{1, . . . , J} according to his utility matrix V^{S}. A strategy profile in a Bayesian Stackelberg game is [symbol] x, j [symbol] , a pair of leader's mixed strategy x and follower's response j, where j= [symbol] j¹, . . . , j^{S} [symbol] denotes a vector of the follower's responses for all types.

The solution concept of interest is a Strong Stackelberg Equilibrium (SSE), where the leader maximizes her expected utility assuming the follower chooses the best response and breaks ties in favor of the leader for each type. Formally, let u(x, j)=Σₛ₌₁^{S}p^{s}((μⱼₛ^{s})^{T}x+μ_{js,0}^{s}) denote the leader's expected utility, and v^{s}(x, j^{s})=(νⱼₛ^{s})^{T}x+ν_{js,0}^{s} denote the follower's expected utility for a type s. Then, [symbol] x*, j* [symbol] is an SSE if and only if,

$$〈 {x}^{*} , {j}^{*} 〉 = arg {max}_{x , j} \{ u ( x , j ) \vert {v}^{s} ( x , {j}^{s} ) \geq {v}^{s} ( x , {j}^{′} ) , ∀ {j}^{′} \neq {j}^{s} \} .$$

TABLE 4
Payoff matrices of a Bayesian Stackelberg game.

| Type 1 | Target1 | Target2 | Type 2 | Target1 | Target2 |
|---|---|---|---|---|---|
| Target1 | 1, −1 | −1, 0 | Target1 | 1, −1 | −1, 1 |
| Target2 | 0, 1 | 1, −1 | Target2 | 0, 1 | 1, −1 |

As an example, which will be returned to herein, a Bayesian Stackelberg game is considered with two follower types, where type 1 appears with probability 0.84 and type 2 appears with probability 0.16. The leader (defender) chooses a probability distribution of allocating one resource to protect the two targets whereas the follower (attacker) chooses the best target to attack. The payoff matrices in Table 4 are shown, where the leader is the row player and the follower is the column player. The utilities of the two types are identical except that a follower of type 2 gets a utility of 1 for attacking Target2 successfully, whereas one of type 1 gets 0. The leader's strategy is a column vector (x₁+x₂)^{T} representing the probabilities of protecting the two targets. Given one resource, the strategy space of the leader is x₁+x₂≦1, x₁≧0, x₂≧0, i.e., A=(1, 1), b=1. The payoffs in FIG. 1 can be represented by the following utility matrices,

$${U}^{1} = ( \begin{matrix}0 & 0 \\ 1 & - 1 \\ 0 & 1\end{matrix} ) , \\ {V}^{1} = ( \begin{matrix}0 & 0 \\ 1 & - 1 \\ 0 & 1\end{matrix} )$$

$${U}^{2} = ( \begin{matrix}0 & 0 \\ 1 & - 1 \\ 0 & 1\end{matrix} ) , \\ {V}^{2} = ( \begin{matrix}0 & 0 \\ 1 & - 1 \\ 0 & 1\end{matrix} )$$

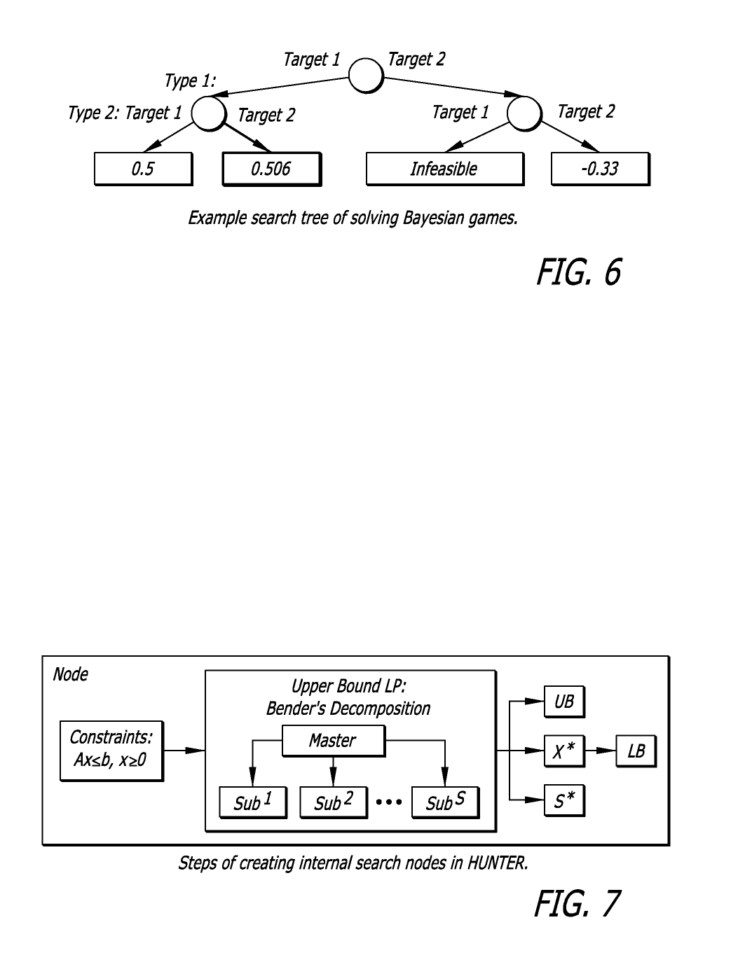

Bayesian Stackelberg games have been typically solved via tree search, where one follower type to a pure strategy at each tree level is assigned. For example, FIG. 6 shows a search tree of the example game in Table 4. Four linear programs are solved, one for each leaf node. At each leaf node, the linear program provides an optimal leader strategy such that the follower's best response for every follower type is the chosen target at that leaf node, e.g., at the leftmost leaf node, the linear program finds the optimal leader strategy such that both type 1 and type 2 have a best response of attacking Target1. Comparing across leaf nodes, the overall optimal leader strategy can be obtained. In this case, the leaf node where type 1 is assigned to Target1 and type 2 to Target2 provides the overall optimal strategy.

Instead of solving an LP for all J^{S} leaf nodes, recent work uses a branch-and-bound technique to speed up the tree search. The key to efficiency in branch-and-bound is obtaining tight upper and lower bounds for internal nodes, i.e., for nodes shown by circles in FIG. 6, where subsets of follower types are assigned to particular targets. For example, in FIG. 6, suppose the left subtree has been explored; now if at the rightmost internal node (where type 1 is assigned to Target2) that the upper bound on solution quality is 0.5 is realized, the right subtree could be pruned without even considering type 2. One possible way of obtaining upper bounds is by relaxing the integrality constraints in DOBSS MILP. Unfortunately, when the integer variables in DOBSS are relaxed, the objective can be arbitrarily large, leading to meaningless upper bounds. HBGS computes upper bounds by heuristically utilizing the solutions of smaller restricted games. However, the preprocessing involved in solving many small games can be expensive and the bounds computed using heuristics can again be loose.

The HUNTER (handling uncertainty efficiently using relaxation) algorithm, based on the five key ideas described previously in this section, can provide a unified method for handling uncertainty in Bayesian Stackelberg games, and can facilitate real-world solutions to security domain problems.

Algorithm Overview

To find the optimal leader's mixed strategy, HUNTER would conduct a best-first search in the search tree that results from assigning follower types to pure strategies, such as the search tree in FIG. 6. Simply stated, HUNTER aims to search this space much more efficiently than HBGS. As discussed earlier, efficiency gains are sought by obtaining tight upper bounds and lower bounds at internal nodes in the search tree (which corresponds to a partial assignment in which a subset of follower types are fixed). To that end, as illustrated in FIG. 7, an upper bound LP is used within an internal search node. The LP returns an upper bound UB and a feasible solution x*, which is then evaluated by computing/determining the follower best response, providing a lower bound LB. The solution returned by the upper bound LP is also utilized in choosing a new type s* to create branches. To avoid having this upper bound LP itself become a bottleneck, it can be solved efficiently using, e.g., Bender's decomposition, which will be explained below.

FIG. 7 depicts steps of creating internal search nodes for an embodiment of HUNTER.

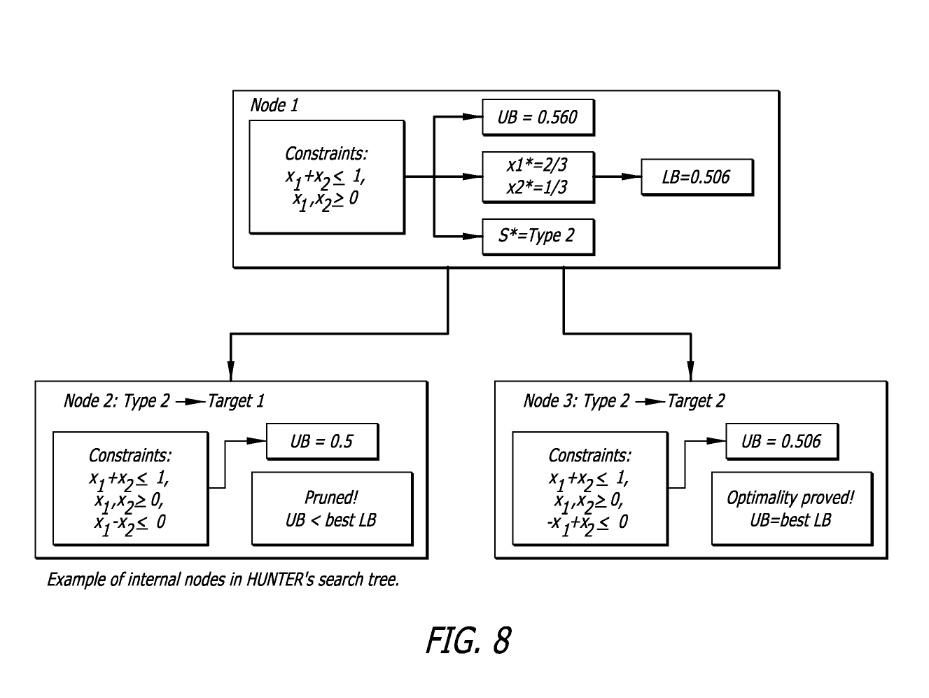

To facilitate understanding of HUNTER's behavior on a toy game instance, see FIG. 8, which illustrates HUNTER's search tree in solving the example game from Table 4 above. To start the best-first search, at the root node, no types are assigned any targets yet; the upper bound LP is solved with the initial strategy space x₁+x₂≦1, x₁, x₂≧0 (Node 1). As a result, an upper bound of 0.560 and the optimal solution x*₁=⅔, x*₂=⅓ is obtained. The solution returned is evaluated and a lower bound of 0.506 is obtained. Using HUNTER's heuristics, type 2 is then chosen to create branches by assigning it to Target1 and Target2 respectively. Next, a child node (Node 2) is considered in which type 2 is assigned to Target1, i.e., type 2's best response is to attack Target1. As a result, the follower's expected utility of choosing Target1 must be higher than that of choosing Target2, i.e., −x₁+x₂≧x₁−x₂, simplified as x₁−x₂≦0. Thus, in Node 2, an additional constraint is imposed x₁−x₂≦0 on the strategy space and obtain an upper bound of 0.5. Since its upper bound is lower than the current lower bound 0.506, this branch can be pruned out. Next, the other child node (Node 3) is considered in which type 2 is assigned to Target2. This time constraint −x₁+x₂≦0 instead is added, and an upper bound of 0.506 is obtained. Since the upper bound coincides with the lower bound, the expansion of the node further is not needed. Moreover, since both Target1 and Target2 for type 2 have been considered, the algorithm and return 0.506 can be terminated as the optimal solution value.

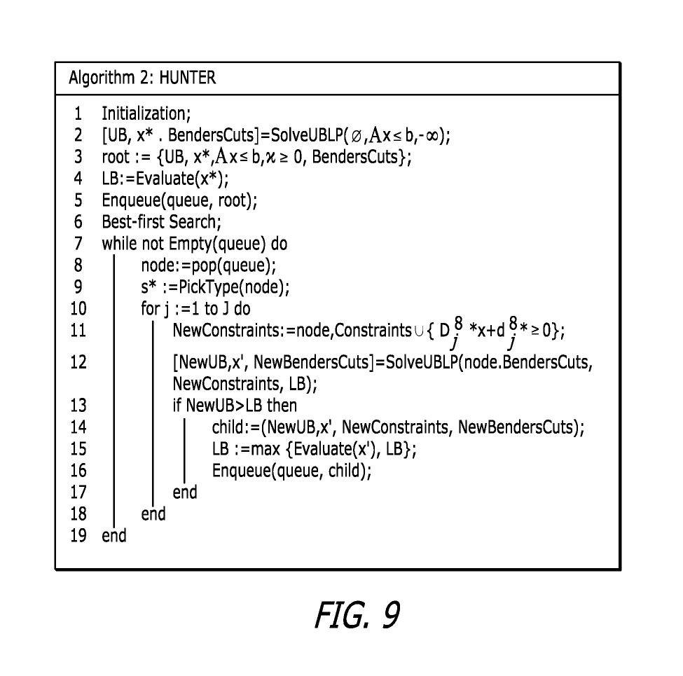

HUNTER's behavior line-by-line (see Algorithm 2 in FIG. 9) is now discussed. The best-first search is initialized by creating the root node of the search tree with no assignment of types to targets and with the computation of the node's upper bound (Line 2 and 3). The initial lower bound is obtained by evaluating the solution returned by the upper bound LP (Line 4). The root node is added to a priority queue of open nodes which is internally sorted in a decreasing order of their upper bounds (Line 5). Each node contains information of the partial assignment, the feasible region of x, the upper bound, and the Bender's cuts generated by the upper bound LP. At each iteration, the node is retrieved with the highest upper bound (Line 8), select a type s* to assign pure strategies (Line 9), compute the upper bounds of the node's child nodes (Line 12 and 14), update the lower bound using the new solutions (Line 15), and enqueue child nodes with upper bound higher than the current lower bound (Line 16). As shown later, Bender's cuts at a parent node can be inherited by its children, speeding up the computation (Line 12).

In the rest of the section, the following are provided: 1) a presentation of the upper bound LP, 2) an example of how to solve it using Bender's decomposition, and 3) verification of the correctness of passing down Bender's cuts from parent to child nodes, and 4) introduction of a heuristic branching rule.

Upper Bound Linear Program

A tractable linear relaxation of Bayesian Stackelberg games can be derived to provide an upper bound efficiently at each of HUNTER's internal nodes. Applying the results in disjunctive program, can provide derivation of the convex hull for a single type. As is shown below, intersecting the convex hulls of all its types provides a tractable, polynomial-size relaxation of a Bayesian Stackelberg game.

Convex Hull of a Single Type

Considering a Stackelberg game with a single follower type (U, V), the leader's optimal strategy x* is the best among the optimal solutions of J LPs where each restricts the follower's best response to one pure strategy. Hence the optimization problem can be represented as the following disjunctive program (i.e., a disjunction of “Multiple LPs”),

$${max}_{x , u} u \\ s . t . Ax b , \\ x ≽ {}_{j = 1}^{J} ( \begin{matrix}u \leq {μ}_{j}^{T} x + {μ}_{j , 0} \\ {D}_{j} x + {d}_{j} 0\end{matrix} ) \qquad ( 1 )$$

where Dⱼ and dⱼ are given by,

$$Dj = ( \begin{matrix}{v}_{1}^{T} - {v}_{j}^{T} \\ ⋮ \\ {v}_{j}^{T} - {v}_{j}^{T}\end{matrix} ) , \\ {d}_{j} = ( \begin{matrix}{v}_{1 , 0} - {v}_{j , 0} \\ ⋮ \\ {v}_{J , 0} - {v}_{j , 0}\end{matrix} ) .$$

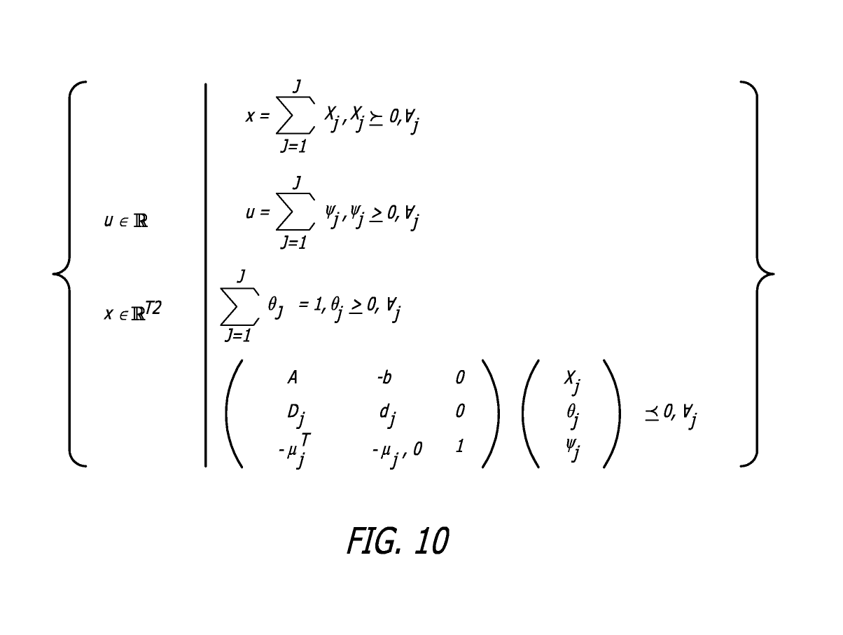

The feasible set of (1), denoted by H, is a union of J convex sets, each corresponding to a disjunctive term. The closure of the convex hull of H, clconvH, can be represented as shown in FIG. 10.

The intuition for this being that the continuous variables θ, Σⱼ₌₁^{J}θⱼ=1 are used to create all possible convex combination of points in H. Furthermore, when

$${θ}_{j} \neq 0 , \\ 〈 \frac{{χ}_{j}}{{θ}_{j}} , \frac{{ψ}_{j}}{{θ}_{j}} 〉$$

represents a point in the convex set defined by the j-th disjunctive term in the original problem (1). Finally, since all the extreme points of clconvH belong to H, the disjunctive program (1) is equivalent to the linear program:

$${max}_{x , u} \{ u \vert ( x , u ) ∈ clconvH \}$$

Tractable Relaxation

Building on the convex hulls of individual types, the relaxation of a Bayesian Stackelberg game with S types is now derived. This game is written with S types as the following disjunctive program,

$${max}_{x , {u}^{i} , … , {u}^{s}} {\sum }_{s = 1}^{S} {p}^{s} {u}^{s} \\ s . t . Ax b , \\ x ≽ 0 \\ {}_{s = 1}^{S} [ {}_{j = 1}^{J} ( \begin{matrix}{u}^{2} \leq {( {μ}_{j}^{s} )}^{T} x + {μ}_{j , 0}^{s} \\ {D}_{j}^{s} x + {d}_{j}^{s} 0\end{matrix} ) ] \qquad ( 2 )$$

Returning to the toy example, the corresponding disjunctive program of the game in Table 4 can be written as,

$${max}_{{x}_{1} , {x}_{2} , {u}^{1} , {u}^{2}} 0.84 {u}^{1} + 0.16 {u}^{2} \\ s . t . {x}_{1} + {x}_{2} \leq 1 , {x}_{1} , {x}_{2} \geq 0 \\ x ≽ 0 \\ ( \begin{matrix}{u}^{1} \leq {x}_{{1}^{′}} \\ {x}_{1} - 2 {x}_{2} \leq 0\end{matrix} ) ( \begin{matrix}{u}^{1} \leq {x}_{{1}^{′}} + {x}_{2} \\ - {x}_{1} - 2 {x}_{2} \leq 0\end{matrix} ) \\ ( \begin{matrix}{u}^{2} \leq {x}_{{1}^{′}} \\ {x}_{1} - {x}_{2} \leq 0\end{matrix} ) ( \begin{matrix}{u}^{2} \leq {x}_{{1}^{′}} + {x}_{2} \\ - {x}_{1} - {x}_{2} \leq 0\end{matrix} ) \qquad ( 3 )$$

Denote the set of feasible points (x, u¹, . . . , u^{S}) of (2) by H*. To avoid an expansion of (2) to a disjunctive normal form, which would result in a linear program with an exponential number (O(N J^{S})) of variables, a much more tractable, polynomial-size relaxation of (2) is given in order to create clconvH*, as is explained below. Denote the feasible set of each type s, (x, u^{s}) by H^{s}, and define Ĥ*:={(x,u¹, . . . , u^{S})|(x,u^{s})∈clconvH^{s},∀s}. Then the following program is a relaxation of (2):

$${max}_{x , {u}^{1} , … {u}^{s}} \{ {\sum }_{s = 1}^{S} {p}^{s} {u}^{s} \vert ( x , {u}^{s} ) ∈ {clconvH}^{s} , ∀ s \} \qquad ( 4 )$$

Indeed, for any feasible point (x, u¹, . . . , u^{S}) in H*, (x, u^{s}) must belong to H^{s}, implying that (x, u^{s})∈clconvH^{s}. Hence H* [symbol] Ĥ* implying that optimizing over H̅* provides an upper bound on H*. On the other hand, H̅* will in general have points not belonging to H* and thus the relaxation can lead to an overestimation.

For example, consider the disjunctive program in (3).

$$( {x}_{1} = \frac{2}{3} , {x}_{2} = \frac{1}{3} , {u}^{1} = \frac{2}{3} , {u}^{2} = 0 )$$

does not belong to H* since −x₁+x₂≦0 but

$${u}^{2} \leq - {x}_{1} + {x}_{2} = - \frac{1}{3} .$$

However the point belongs to Ĥ* because: i)

$$( {x}_{1} = \frac{2}{3} , {x}_{2} = \frac{1}{3} , {u}^{1} = \frac{2}{3} )$$

belongs to H¹ [symbol] clconvH¹; ii)

$$( {x}_{1} = \frac{2}{3} , {x}_{2} = \frac{1}{3} , {u}^{2} = 0 )$$

belongs to clconvH², as it is the convex combination of two points in H²:

$$( {x}_{1} = \frac{1}{2} , {x}_{2} = \frac{1}{2} , {u}^{2} = \frac{1}{2} ) and ( {x}_{1} = 1 , {x}_{2} = 0 , {u}^{2} = - 1 ) , \\ ( \frac{2}{3} , \frac{1}{3} , 0 ) = \frac{2}{3} \times ( \frac{1}{2} , \frac{1}{2} , \frac{1}{2} ) + \frac{1}{3} \times ( 1 , 0 , - 1 ) .$$

The upper bound LP (4) has O(N J S) number of variables and constraints, and can be written as the following two-stage problem by explicitly representing clconvH^{s}:

$${max}_{x} {\sum }_{s = 1}^{S} {p}^{s} {u}^{s} ( x ) \\ s . t . Ax b , x ≽ 0 \qquad ( 5 )$$

where u^{s}(x) is defined to be the optimal value of,

$${max}_{{x}_{j}^{s} , {ψ}_{j}^{s} , {θ}_{j}^{s}} {\sum }_{j = 1}^{J} {ψ}_{j}^{s} , {ψ}_{j}^{s} \geq 0 , ∀ j \\ s . t . {\sum }_{j = 1}^{S} {x}_{j}^{s} = x , {x}_{j}^{s} ≽ 0 , ∀ j \\ {\sum }_{j = 1}^{S} {θ}_{j}^{s} = 1 , {θ}_{j}^{s} \geq 0 , ∀ j \\ ( \begin{matrix}A & - b & 0 \\ {D}_{j}^{s} & {d}_{j}^{s} & 0 \\ - {( {μ}_{s}^{j} )}^{T} & - {μ}_{j , 0}^{s} & 1\end{matrix} ) ( \begin{matrix}{x}_{j}^{s} \\ {θ}_{j}^{s} \\ {ψ}_{j}^{s}\end{matrix} ) 0 , ∀ j \qquad ( 6 )$$

Although written in two stages, the above formulation is in fact a single linear program, as both stages are maximization problems and combining the two stages will not produce any non-linear terms. Formulations (5) and (6) are displayed in order to reveal the block structure for further speedup as explained below.

Note that so far, the relaxation for the root node of HUNTER's search tree have only been derived without assigning any type to a pure strategy. This relaxation is also applied to other internal nodes in HUNTER's search tree. For example, if type s is assigned to pure strategy j, the leader's strategy space is further restricted by the addition of constraints of Dⱼ^{s}x+dⱼ^{s} [symbol] 0 to the original constraints Ax [symbol] b,x [symbol] 0. That is, A′ [symbol] b′,x [symbol] 0, where

$${A}^{′} = ( \begin{matrix}{D}_{j}^{s} \\ A\end{matrix} ) and {b}^{′} = ( \begin{matrix}- {d}_{j}^{s} \\ b\end{matrix} ) .$$

Bender's Decomposition

Although much easier than solving a full Bayesian Stackelberg game, solving the upper bound LP can still be computationally challenging. Here, the block structure of (4) as observed above is invoked, which partitioned it into (5) and (6), where, (5) is a master problem and (6) for s=1, . . . , S are S subproblems. This block structure allows solution of the upper bound LP efficiently using multi-cut Bender's Decomposition. Generally speaking, the computational difficulty of optimization problems increases significantly with the number of variables and constraints. Instead of considering all variables and constraints of a large problem simultaneously, Bender's decomposition can be used to partition the problem into multiple smaller problems, which can then be solved in sequence. For completeness, the technique is now briefly described.

In Bender's decomposition, the second-stage maximization problem (6) is replaced by its dual minimization counterpart, with dual variables λⱼ^{s},π^{s},η^{s} for s=1, . . . , S:

$${u}^{s} ( x ) = {min}_{{λ}_{j}^{s} ≽ 0 , {π}^{s} , {η}^{s}} {( {π}^{s} )}^{T} x + {η}^{s} \\ s . t . ( \begin{matrix}{A}^{T} & {( {D}_{j}^{s} )}^{T} & - {μ}_{j}^{s} \\ - {b}^{T} & {( {d}_{j}^{s} )}^{T} & - {μ}_{i , 0}^{s} \\ {0}^{T} & {0}^{T} & 1\end{matrix} ) {λ}_{j}^{s} + ( \begin{matrix}{π}^{s} \\ {η}^{s} \\ - 1\end{matrix} ) ≽ 0 , ∀ i \qquad ( 7 )$$

Since the feasible region of (7) is independent of x, its optimal solution is reached at one of a finite number of extreme points (of the dual variables). Since u^{s}(x) is the minimum of (π^{s})^{T}x+η^{s} over all possible dual points, the following inequality must be true in the master problem,

u^{s}≦(πₖ^{s})^{T}x+ηₖ^{s}, k=1, . . . , K (8)

where, (πₖ^{s},ηₖ^{s}), k=1, . . . , K are all the dual extreme points. Constraints of type (8) for the master problem are called optimality cuts (infeasibility cuts, another type of constraint, are not believed to be relevant for this problem).

Since there are typically exponentially many extreme points for the dual formulation (7), generating all constraints of type (8) may not be practical. Instead, Bender's decomposition can be used, and which starts by solving the master problem (5) with a subset of these constraints to find a candidate optimal solution (x^{*}, u^{1,*}, . . . , u^{S,*}). It then solves S dual subproblems (7) to calculate u^{s}(x^{*}). If all the subproblems have u^{s}(x^{*})=u^{s,*}, the algorithm stops. Otherwise for those u^{s}(x^{*})<u^{s,*}, the corresponding constraints of type (8) are added to the master program for the next iteration.

Reusing Bender's Cuts

The upper bound LP computation can be further sped up at internal nodes of HUNTER's search tree by not creating all of the Bender's cuts from scratch; instead, Bender's cuts from the parent node can be reused in its children. Suppose u^{s}≦(π^{s})^{T}x+η^{s} is a Bender's cut in the parent node. This means u^{s} cannot be greater than (π^{s})^{T}x+η^{s} for any x in the feasible region of the parent node. Because a child node's feasible region is always more restricted than its parent's, a conclusion is that u^{s} cannot be greater than (π^{s})^{T}x+η^{s} for any x in the child node's feasible region, i.e., u^{s}≦(π^{s})^{T}x+η^{s} must also be a valid cut for the child node.

Heuristic Branching Rules

Given an internal node in the search tree of HUNTER, the type to branch on next must be decided upon, i.e., the type for which J child nodes will be created at the next lower level of the tree. As described below, the type selected to branch on has a significant effect on efficiency. For some embodiments, a type can be selected whereby the upper bound at these children nodes will decrease most significantly. To that end, HUNTER chooses the type whose θ^{s} returned by (6) violates the integrality constraint the most. Recall that θ^{s} is used to generate convex combinations. The motivation here is that if all θ^{s} returned by (6) are integer vectors, the solution of the upper bound LP (5) and (6) is a feasible point of the original problem (2), implying the relaxation already returns the optimal solution. More specifically, HUNTER chooses type s^{*} whose corresponding θ^{s*} has the maximum entropy, i.e., s*=arg maxₛ−Σⱼ₌₁^{J}θⱼ^{s} log θⱼ^{s}.

Continuous Uncertainty in Stackelberg Games

HUNTER can be used or modified to handle continuous uncertainty via the sample average approximation technique. Below, an uncertain Stackelberg game model is introduced with continuously distributed uncertainty in leader's execution, follower's observation, and both players' utilities. Then it is shown that the uncertain Stackelberg game model can be written as a two-stage mixed-integer stochastic program, to which existing convergence results of the sample average approximation technique apply. Finally, it is shown that the sampled problems are equivalent to Bayesian Stackelberg games, and consequently can also be solved by HUNTER.

Uncertain Stackelberg Game Model

The following types of uncertainty in Stackelberg games with known distributions are shown. First, an assumption can be made that there is uncertainty in both the leader and the follower's utilities U and V. Second, the leader's execution and the follower's observation can be assumed to be noisy. In particular, the executed strategy and observed strategy are linear perturbations of the intended strategy are assumed, i.e., when the leader commits to x, the actual executed strategy is y=F^{T}x+f and the observed strategy by the follower is z=G^{T}x+g, where (F, f) and (G, g) are uncertain. Here f and g are used to represent the execution and observation noise that is independent on x. In addition, F and G are matrices allowing execution and observation noise to be modeled as linearly dependent on x. Note that G and g can be dependent on F and f. For example, an execution noise can be represented that is independent of x and follows a Gaussian distribution with 0 mean using F=I_{N} and f˜N(0,Σ), where I_{N} is the N×N identity matrix. Assume U, V, F, f, G, and g are random variables, following some known continuous distributions. A vector ξ=(U, V, F, f, G, g) can be used to represent a realization of the above inputs, and the notation ξ(ω) can be used to represent the corresponding random variable.

The uncertain Stackelberg game, as described in further detail below, can be written as a two-stage mixed-integer stochastic program. Let Q(x, ξ) be the leader's utility for a strategy x and a realization ξ, assuming the follower chooses the best response. The first stage maximizes the expectation of leader's utility with respect to the joint probability distribution of ξ(ω), i.e.,

$${min}_{x} \{ E [ Q ( x , ξ ( w ) ) ] \vert Ax b , x ≽ 0 \} .$$

The second stage computes [symbol] (x,ξ)²:

where

Q(xξ)=μ_{i*}^{T}(F^{T}x+f)+μ_{i*,0}

i*=argmaxᵢ₌₁^{m}νᵢ^{T}(G^{T}x+g)+ν_{i,0}. (9)

Sample Average Approximation

Sample average approximation is a popular solution technique for stochastic programs with continuously distributed uncertainty. It can be applied to solving uncertain Stackelberg games as follows. First, a sample ξ¹, . . . , ξ^{S} of S realizations of the random vector ξ(ω) is generated. The expected value function E[Q(x,ξ(ω))] can then be approximated by the sample average function

$$\frac{1}{S} {\sum }_{s = 1}^{s} Q ( x , {ξ}^{s} ) .$$

The sampled problem is given by,

$${min}_{x} \{ {\sum }_{s = 1}^{S} \frac{1}{S} Q ( x , {ξ}^{s} ) \vert Ax b , x ≽ 0 \} . \qquad ( 10 )$$

The sampled problem provides tighter and tighter statistical upper bound of the true problem with increasing number of samples; the number of samples required to solve the true problem to a certain accuracy grows linearly in the dimension of x.

In the sampled problem, each sample ξ corresponds to a tuple (U, V, F, f, G, g). The following proposition shows ξ is equivalent to some ξ where \hat{F}=Ĝ=I_{N} and \hat{ƒ}=ĝ=0, implying the sampled execution and observation noise can be handled by simply perturbing the utility matrices.

PROPOSITION 1. For any leader's strategy x and follower's strategy j, both players get the same expected utilities in two noise realizations (U, V, F, f, G, g) and (Û, \hat{V}, I_{N}, 0, I_{N}, 0), where,

$$\hat{U} = ( \begin{matrix}1 & {f}^{T} \\ 0 & F\end{matrix} ) U , \\ \hat{V} = ( \begin{matrix}1 & {g}^{T} \\ 0 & G\end{matrix} ) V .$$

PROOF. Both players' expected utility vectors for both noise realizations to establish the equivalence are calculated:

$${\hat{U}}^{T} ( \begin{matrix}1 \\ x\end{matrix} ) = {U}^{T} ( \begin{matrix}1 & {0}^{T} \\ f & {F}^{T}\end{matrix} ) ( \begin{matrix}1 \\ x\end{matrix} ) = {U}^{T} ( \begin{matrix}1 \\ {F}^{T} x + f\end{matrix} ) . \\ {\hat{V}}^{T} ( \begin{matrix}1 \\ x\end{matrix} ) = {V}^{T} ( \begin{matrix}1 & {0}^{T} \\ g & {G}^{T}\end{matrix} ) ( \begin{matrix}1 \\ x\end{matrix} ) = {V}^{T} ( \begin{matrix}1 \\ {G}^{T} x + g\end{matrix} ) .$$

A direct implication of Proposition 1 is that the sampled problem (10) and (9) is equivalent to a Bayesian Stackelberg game of S equally weighted types, with utility matrices (Û^{s},\hat{V}^{s}), s=1, . . . , S. Hence, via sample average approximation, HUNTER can be used to solve Stackelberg games with continuous payoff, execution, and observation uncertainty.

A Unified Approach

Applying sample average approximation in Bayesian Stackelberg games with discrete follower types, both discrete and continuous uncertainty can be handled simultaneously using HUNTER. For this, each discrete follower type can be replaced by a set of samples of the continuous distribution, converting the original Bayesian Stackelberg game to a larger one. The resulting problem can again be solved by HUNTER, providing a solution robust to both types of uncertainty.

Experimental Results

To verify that HUNTER can handle both discrete and continuous uncertainty in Stackelberg games, three sets of experiments were conducted considering i) only discrete uncertainty, ii) only continuous uncertainty, and iii) both types of uncertainty. The utility matrices were randomly generated from a uniform distribution between −100 and 100. Results were obtained on a standard 2.8 GHz machine with 2 GB main memory, and were averaged over 30 trials.

Handling Discrete Follower Types

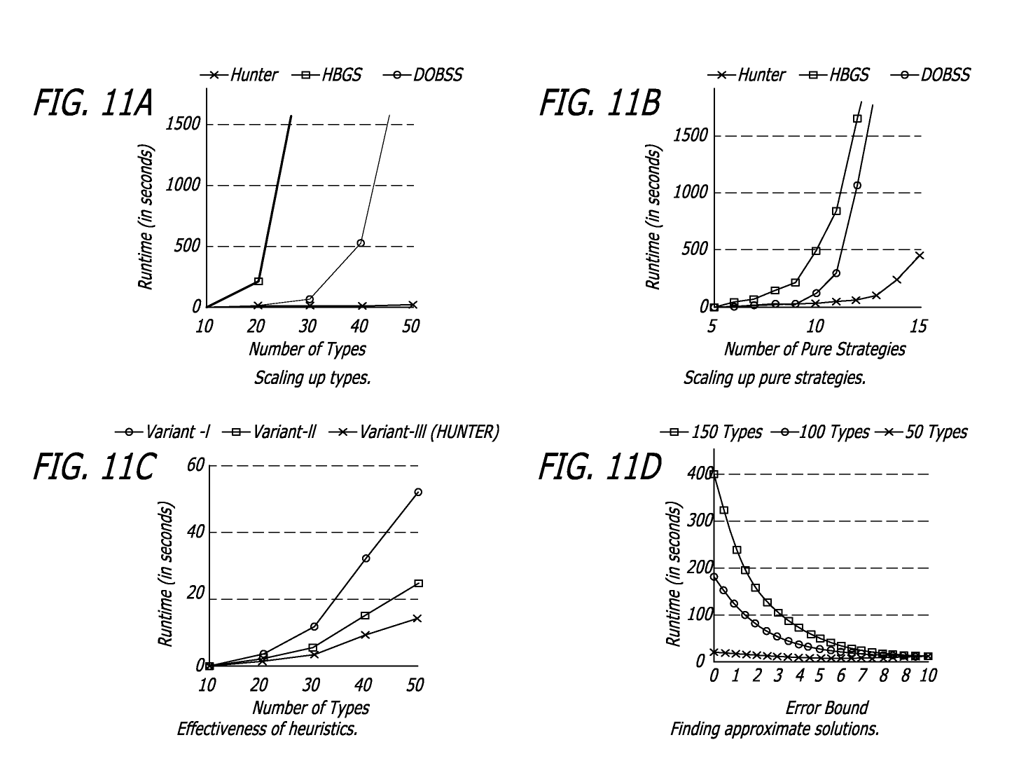

FIGS. 11(a)-11(d) show experimental analysis of HUNTER and runtime comparisons with HBGS and DOBSS. For discrete uncertainty, the runtime of HUNTER was compared with DOBSS and HBGS (specifically, HBGS-F, the most efficient variant), the two best known algorithms for general Bayesian Stackelberg games. These algorithms were compared, varying the number of types and the number of pure strategies per player. The tests used a cutoff time of one hour for all three algorithms.

FIG. 11(a) shows the performance of the three algorithms when the number of types increases. The games tested in this set have 5 pure strategies for each player. The x-axis shows the number of types, while the y-axis shows the runtime in seconds. As can be seen in FIG. 11(a), HUNTER provides significant speed-up, of orders of magnitude over both HBGS and DOBSS3 (the line depicting HUNTER is almost touching the x-axis in FIG. 11(a). For example, it was found that HUNTER can solve a Bayesian Stackelberg game with 50 types in 17.7 seconds on average, whereas neither HBGS nor DOBSS could solve an instance in an hour. FIG. 11(b) shows the performance of the three algorithms when the number of pure strategies for each player increases. The games tested in this set have 10 types. The x-axis shows the number of pure strategies for each player, while the y-axis shows the runtime in seconds. HUNTER again was shown to provide significant speed-up over both HBGS and DOBSS. For example, HUNTER on average was able to solve a game with 13 pure strategies in 108.3 seconds, but HBGS and DOBSS took more than 30 minutes.

The following analyzes the contributions of HUNTER's key components to its performance. First, the runtime of HUNTER with two search heuristics, best-first (BFS) and depth-first (DFS) is considered, when the number of types is further increased. Setting the pure strategies for each player to 5, the number of types can be increased from 10 to 200. In Table 5, the average runtime and average number of nodes explored in the search process is summarized. DFS, as seen, is faster than BFS when the number of types is small, e.g., 10 types. However, BFS was seen to always explore significantly fewer number of nodes than DFS and be more efficient when the number types is large. For games with 200 types, the average runtime of BFS based HUNTER was 20 minutes, highlighting its scalability to a large number of types. Such scalability is achieved by efficient pruning—for a game with 200 types, HUNTER explores on average 5.3×10³ nodes with BFS and 1.1×10⁴ nodes with DFS, compared to a total of 5²⁰⁰=6.2×10¹³⁹ possible leaf nodes.

TABLE 5
Scalability of HUNTER to a large number of types

| #Types | 10 | 50 | 100 | 150 | 200 |
|---|---|---|---|---|---|
| BFS Runtime(s) | 5.7 | 17.7 | 178.4 | 405.1 | 1143.5 |
| BFS #Nodes | 21 | 316 | 1596 | 2628 | 5328 |
| Explored | | | | | |
| DFS Runtime(s) | 4.5 | 29.7 | 32.1 | 766.0 | 2323.5 |
| DFS #Nodes | 33 | 617 | 3094 | 5468 | 11049 |
| Explored | | | | | |

Second, the effectiveness of the two heuristics is tested: inheritance of Bender's cuts from parent node to child nodes and the branching rule utilizing the solution returned by the upper bound LP. The number of pure strategies for each agent was fixed to 5 and the number of types was increased from 10 to 50. In FIG. 11(c), the runtime of three variants of HUNTER are shown: i) Variant-I does not inherit Bender's cuts and chooses a random type to create branches; ii) Variant-II does not inherit Bender's cuts and uses the heuristic branching rule; iii) Variant-III (HUNTER) inherits Bender's cuts and uses the heuristic branching rule. The x-axis represents the number of types while the y-axis represents the runtime in seconds. As can be seen, each individual heuristic helps speed up the algorithm significantly, showing their usefulness. For example, it was shown to take 14.0 seconds to solve an instance of 50 types when both heuristics were enabled (Variant-Ill) compared to 51.5 seconds when neither of them was enabled (Variant-I).

Finally, a consideration is made of the performance of HUNTER in finding quality bounded approximate solutions. To this end, HUNTER is allowed to terminate once the difference between the upper bound and the lower bound decreases to η, a given error bound. The solution returned is therefore an approximate solution provably within η of the optimal solution. In this set of experiment, 30 games were tested with 5 pure strategies for each player and 50, 100, and 150 types with varying error bound η from 0 to 10. As shown in FIG. 11(d), HUNTER can effectively trade off solution quality for further speedup, indicating the effectiveness of its upper bound and lower bound heuristics. For example, for games with 100 types, HUNTER returned within 30 seconds a suboptimal solution at most 5 away from the optimal solution (the average optimal solution quality is 60.2). Compared to finding the global optimal solution in 178 seconds, HUNTER is able to achieve six-fold speedup by allowing at most 5 quality loss.

Handling Continuous Uncertainty

For continuous uncertainty, ideally HUNTER would be compared with other algorithms that handle continuous execution and observation uncertainty in general Stackelberg games; however, no such algorithm are known to exist. Hence this investigation is restricted to the more restricted security games, so that two previous robust algorithms BRASS and RECON can be used in such a comparison. To introduce the uncertainty in these security games, it can be assumed that the defender's execution and the attacker's observation uncertainty each follows independent uniform distributions. That is, an assumption is made that for an intended defender strategy x= [symbol] x₁, . . . , x_{N} [symbol] where xᵢ represents the probability of protecting target i, the maximum execution error associated with target i is αᵢ, and the actual executed strategy is y= [symbol] y₁, . . . , y_{N} [symbol] . where yᵢ follows a uniform distribution between xᵢ−αᵢ and xᵢ+αᵢ for each i. Similarly, the maximum observation error for target i is βᵢ, is assumed and the actual observed strategy is z= [symbol] z₁, . . . , z_{N} [symbol] where zᵢ follows a uniform distribution between yᵢ−βᵢ and yᵢ+βᵢ for each i.

HUNTER was used with 20 samples and 100 samples to solve the problem above via sample average approximation as described previously. For each setting, HUNTER was repeated 20 times with different sets of samples and reported the best solution found (as shown below, HUNTER's competitors were used for 20 settings for selecting the best solutions). Having generated a solution with 20 or 100 samples, evaluating its actual quality is difficult in the continuous uncertainty model—certainly any analytical evaluation is extremely difficult. Therefore, to provide an accurate estimation of the actual quality, 10,000 samples were drawn from the uncertainty distribution and the solution was evaluated using these samples.

For comparison, two existing robust solution methods BRASS and RECON were considered. As experimentally tested, when its parameter ∈ is chosen carefully, BRASS strategy is one of the top performing strategies under continuous payoff uncertainty. RECON assumes a maximum execution error α and a maximum observation error β, computing the risk-averse strategy for the defender that maximizes the worst-case performance over all possible noise realization. To provide a more meaningful comparison, solutions of BRASS/RECON were found repeatedly with multiple settings of parameters, and reports are provided herein for the best one. For BRASS, 20 ∈ settings were tested, and for RECON, the setting was made α=β and 20 settings were tested.

For the experiments, 30 randomly generated security games were tested with five targets and one resource. The maximum execution and observation error was set to α=β=0.1. The utilities in the game were drawn from a uniform distribution between −100 and +100. Nonetheless, the possible optimal solution quality existed in a much narrower range. Over the 30 instances tested, the optimal solution quality by any algorithm were found to vary between −26 and +17. In Table 6, the solution quality of HUNTER compared to BRASS and RECON is shown, respectively. In Table 6, the #Wins shows the number of instances out of 30 where HUNTER returned a better solution than BRASS/RECON. Avg. Diff. shows the average gain of HUNTER over BRASS (or RECON), and the average solution quality of the corresponding algorithm (shown in the parentheses). Max. Diff. shows the maximum gain of HUNTER over BRASS (or RECON), and the solution quality of the corresponding instance and algorithm (shown in the parentheses). HUNTER, as shown with 20 and 100 samples, outperformed both BRASS and RECON on average. For example, RECON on average returned a solution with quality of −5.1, while even with 20 samples, the average gain HUNTER achieved over RECON is 0.6. The result is statistically significant with a paired t-test value of 8.9×10⁻⁶ and 1.0×10⁻³ for BRASS and RECON respectively. Indeed, when the number of samples used in HUNTER increased to 100, HUNTER was able to outperform both BRASS and RECON in every instance tested. Not only is the average difference in this case statistically significant, but the actual solution quality found by HUNTER—as shown by max difference—can be significantly better in practice than solutions found by BRASS and RECON.

TABLE 6
Quality gain of HUNTER against BRASS and RECON under
continuous execution and observation uncertainty.

| | HUNTER-20 vs. | | HUNTER-100 vx. | |
|---|---|---|---|---|
| | BRASS | RECON | BRASS | RECON |
| #WINS | 27 | 24 | 30 | 30 |
| Avg. Diff. | 0.7(−5.2) | 0.6(−5.1) | 0.9(−5.2) | 0.8(−5.1) |
| Max. Diff. | 2.4(7.6) | 4.0(−16.1) | 3.31(7.6) | 4.4(−16.1) |

Handling Both Types of Uncertainty

In another experiment, Stackelberg games with both discrete and continuous uncertainty were considered. Since no previous algorithm in known to handle both types of uncertainty, the runtime results only of HUNTER are shown. Tests were run on security games with five targets and one resource, and with multiple discrete follower types whose utilities were randomly generated. For each type, the same utility distribution and the same execution and observation uncertainty were used as previously described. Table 7 summarizes the runtime results of HUNTER for 3, 4, 5, 6 follower types, and 10, samples per type. As shown, HUNTER can efficiently handle both uncertainty simultaneously. For example, HUNTER spends less than 4 minutes on average to solve a problem with 5 follower types and 20 samples per type.

TABLE 7
Runtime results (in seconds) of HUNTER for handling
both discrete and continuous uncertainty.

| #Discrete Types | 3 | 4 | 5 | 6 |
|---|---|---|---|---|
| 10 Samples | 4.9 | 12.8 | 29.3 | 54.8 |
| 20 Samples | 32.4 | 74.6 | 232.8 | 556.5 |

Conclusions

With increasing numbers of real-world security applications of leader-follower Stackelberg games, it is critical that to address uncertainty in such games, including discrete attacker types and continuous uncertainty such as the follower's observation noise, the leader's execution error, and both players' payoffs uncertainty. Previously, researchers have designed specialized sets of algorithms to handle these different types of uncertainty, e.g. algorithms for discrete follower types have been distinct from algorithms that handle continuous uncertainty. However, in the real-world, a leader may face all of this uncertainty simultaneously, and thus a single unified algorithm that handles all this uncertainty is desired.

To that end, a novel unified algorithm, called HUNTER, has been presented herein, which handles discrete and continuous uncertainty by scaling up Bayesian Stackelberg games. The HUNTER algorithm is able to provide speedups of orders of magnitude over existing algorithms. Additionally, using sample average approximation, HUNTER can handle continuously distributed uncertainty.

Section 3—Multi-Objective Optimization for Security Games

As was noted above, an aspect of the present disclosure in directed to a multi-objective optimization for security games. The aspect includes a treatment or description of multi-objective security games (MOSG), combining security games and multi-objective optimization. MOSGs have a set of Pareto optimal (non-dominated) solutions referred to herein as the Pareto frontier. The Pareto frontier can be generated by solving a sequence of constrained single-objective optimization problems (CSOP), where one objective is selected to be maximized while lower bounds are specified for the other objectives.

The burgeoning area of security games has focused on real-world domains where security agencies protect critical infrastructure from a diverse set of adaptive adversaries. There are security domains where the payoffs for preventing the different types of adversaries may take different forms (seized money, reduced crime, saved lives, etc) which are not readily comparable. Thus, it can be difficult to know how to weigh the different payoffs when deciding on a security strategy. To address the challenges of these domains, a fundamentally different solution concept is described herein, multi-objective security games (MOSG), which combines security games and multi-objective optimization. Instead of a single optimal solution, MOSGs have a set of Pareto optimal (non-dominated) solutions referred to as the Pareto frontier. The Pareto frontier can be generated by solving a sequence of constrained single-objective optimization problems (CSOP), where one objective is selected to be maximized while lower bounds are specified for the other objectives. Techniques or algorithms as described herein for providing multi-objective optimization for security games can include the following features: (i) an algorithm, Iterative ∈-Constraints, for generating the sequence of CSOPs; (ii) an exact approach for solving an MILP formulation of a CSOP (which also applies to multi-objective optimization in more general Stackelberg games); (iii) heuristics that achieve speedup by exploiting the structure of security games to further constrain a CSOP; (iv) an approximate approach for solving an algorithmic formulation of a CSOP, increasing the scalability of the approach with quality guarantees. Proofs on the level of approximation and detailed experimental evaluation of the certain embodiments are provided below.

As was noted above, game theory is an increasingly important paradigm for modeling security domains which feature complex resource allocation. Security games, a special class of attacker-defender Stackelberg games, are at the heart of several major deployed decision-support applications. Such systems include ARMOR at LAX airport, IRIS deployed by the US Federal Air Marshals Service, GUARDS developed for the US Transportation Security Administration, and PROTECT used in the Port of Boston by the US Coast Guard.

In these applications, the defender is trying to maximize a single objective. However, there are domains where the defender has to consider multiple objectives simultaneously. For example, the Los Angeles Sheriff's Department (LASD) has stated that it needs to protect the city's metro system from ticketless travelers, common criminals, and terrorists. From the perspective of LASD, each one of these attacker types provides a unique threat (lost revenue, property theft, and loss of life). Given this diverse set of threats, selecting a security strategy is a significant challenge as no single strategy can minimize the threat for all attacker types. Thus, tradeoffs must be made and protecting more against one threat may increase the vulnerability to another threat. However, it is not clear how LASD should weigh these threats when determining the security strategy to use. One could attempt to establish methods for converting the different threats into a single metric. However, this process can become convoluted when attempting to compare abstract notions such as safety and security with concrete concepts such as ticket revenue.

Bayesian security games have been used to model domains where the defender is facing multiple attacker types. The threats posed by the different attacker types are weighted according to the relative likelihood of encountering that attacker type. There are three potential factors limiting the use of Bayesian security games: (1) the defender may not have information on the probability distribution over attacker types, (2) it may be impossible or undesirable to directly compare and combine the defender rewards of different security games, and (3) only one solution is given, hiding the trade-offs between the objectives from the end user.

As described below, for many domains a new game model, multi-objective security games (MOSG) can be utilized advantageously, which combines game theory and multi-objective optimization. For these models, the threats posed by the attacker types are treated as different objective functions which are not aggregated, thus eliminating the need for a probability distribution over attacker types. Unlike Bayesian security games which have a single optimal solution, MOSGs have a set of Pareto optimal (non-dominated) solutions which is referred to herein as the Pareto frontier. By presenting the Pareto frontier to the end user, they are able to better understand the structure of their problem as well as the tradeoffs between different security strategies. As a result, end users are able to make a more informed decision on which strategy to enact.

As described herein, MOSG solutions provide a set of algorithms for computing Pareto optimal solutions for MOSGs. Key features of such solutions include one of more of the following: (i) Iterative ∈-Constraints, an algorithm for generating the Pareto frontier for MOSGs by producing and solving a sequence of constrained single-objective optimization problems (CSOP); (ii) an exact approach for solving a mixed-integer linear program (MILP) formulation of a CSOP (which also can apply to multi-objective optimization in more general Stackelberg games); (iii) heuristics that exploit the structure of security games to speedup solving CSOPs; and (iv) an approximate approach for solving CSOPs, which greatly increases the scalability of the MOSG approach while maintaining quality guarantees. Additionally, analysis of the complexity and completeness for the algorithms is provided, as well as experimental results.

Exemplary Domains

As described above, an example of a security domain to which a MOSG model can be applied is the stated scenario that the LASD must protect the Los Angeles metro system from ticketless travelers, criminals, and terrorists. Each type of perpetrator is distinct and presents a unique set of challenges. Thus, LASD may have different payoffs for preventing the various perpetrators. Targeting ticketless travelers will increase the revenue generated by the metro system as it will encourage passengers to purchase tickets. Pursuing criminals will reduce the amount of vandalism and property thefts, increasing the overall sense of passenger safety. Focusing on terrorists could help to prevent or mitigate the effect of a future terrorist attack, potentially saving lives. LASD has finite resources with which to protect all of the stations in the city. Thus, it is not possible to protect all stations against all perpetrators at all times. Therefore, strategic decisions must be made such as where to allocate security resources and for how long. These allocations should be determined by the amount of benefit they provide to LASD. However, if preventing different perpetrators provides different, incomparable benefits to LASD, it may be unclear how to decide on a strategy. In such situations, a multi-objective security game model could be of use, since the set of Pareto optimal solutions can explore the trade-offs between the different objectives. LASD can then select the solution they feel most comfortable with based on the information they have.

Multi-Objective Security Games

A multi-objective security game is a multi-player game between a defender and n attackers, in which the defender tries to prevent attacks by covering targets T={t₁, t₂, . . . , tₗη} using m identical resources which can be distributed in a continuous fashion amongst the targets and according to multiple different objectives. The defender's strategy can be represented as a coverage vector c∈C where cₜ is the amount of coverage placed on target t and represents the probability of the defender successfully preventing any attack on t. C={ [symbol] cₜ [symbol] |0≦cₜ≦1, Σ_{t∈T} cₜ≦m} is the defender's strategy space. The attacker i's mixed strategy aᵢ= [symbol] aᵢ^{t} [symbol] is a vector where [symbol] aᵢ^{t} [symbol] is the probability of attacking t.

U defines the payoff structure for an MOSG, with Uᵢ defining the payoffs for the security game played between the defender and attacker i. Uᵢ^{c,d}(t) is the defender's utility if t is chosen by attacker i and is fully covered by a defender resource. If t is not covered, the defender's penalty is Uᵢ^{u,d}(t). The attacker's utility is denoted similarly by Uᵢ^{c,a}(t) and Uᵢ^{u,a}(t). A property of security games is that Uᵢ^{c,d}(t)>Uᵢ^{u,d}(t) and Uᵢ^{u,a}(t)>Uᵢ^{c,a}(t) which means that placing more coverage on a target is always beneficial for the defender and disadvantageous for the attacker. For a strategy profile <c,aᵢ> for the game between the defender and attacker i, the expected utilities for both agents are given by:

$${U}_{i}^{d} ( c , {a}_{i} ) = {\sum }_{t ∈ T}^{ } {a}_{i}^{t} {U}_{i}^{d} ( {c}_{t} , t ) , \\ {U}_{i}^{a} ( c , {a}_{i} ) = {\sum }_{t ∈ T}^{ } {a}_{t} {U}_{i}^{a} ( {c}_{t} , t )$$

where

Uᵢ^{d}(cₜ,t)=cₜUᵢ^{c,d}(t)+(1−cₜ)Uᵢ^{u,d}(t) and Uᵢ^{a}(cₜ,t)=cₜUᵢ^{c,a}(t)+(1−cₜ)Uᵢ^{u,d}(t) are the payoff received by the defender and attacker i, respectively, if target t is attacked and is covered with cₜ resources.

The standard solution concept for a two-player Stackelberg game is Strong Stackelberg Equilibrium (SSE), in which the defender selects an optimal strategy based on the assumption that the attacker will choose an optimal response, breaking ties in favor of the defender. Uᵢ^{d}(c) and Uᵢ^{a}(c) can be denoted as the payoff received by the defender and attacker i, respectively, when the defender uses the coverage vector c and attacker i attacks the best target while breaking ties in favor of the defender.

With multiple attackers, the defender's utility (objective) space can be represented as a vector U^{d}(c)= [symbol] Uᵢ^{d}(c) [symbol] . An MOSG defines a multi-objective optimization problem:

$${max}_{c ∈ C} ( {U}_{1}^{d} ( c ) ) , … , {U}_{n}^{d} ( c ) ) .$$

Solving such multi-objective optimization problems is a fundamentally different task than solving a single-objective optimization problem. With multiple objectives functions tradeoffs, exist between the different objectives such that increasing the value of one objective decreases the value of at least one other objective. Thus for multi-objective optimization, the traditional concept of optimality is replaced by Pareto optimality; definitions are provided below.

DEFINITION 1. (Dominance). A coverage vector c∈C is said to dominate c′∈C if Uᵢ^{d}(c)≧Uᵢ^{d}(c′) for all i=1, . . . , n and Uᵢ^{d}(c)>Uᵢ^{d}(c′) for at least one index i.

DEFINITION 2. (Pareto Optimality) A coverage vector c∈C is Pareto optimal if there is no other c′∈C that dominates c. The set of non-dominated coverage vectors is called Pareto optimal solutions C^{*} and the corresponding set of objective vectors Ω={U^{d}(c)/c∈C^{*}} is called the Pareto frontier.

The present disclosure provides algorithms to find Pareto optimal solutions in MOSGs. If there are a finite number of Pareto optimal solutions, it is preferable to generate all of them for the end-user. If there are an infinite number of Pareto optimal solutions, it is impossible to generate all the Pareto optimal solutions. In this case, a subset of Pareto optimal solutions can be generated, which can approximate the true Pareto frontier with quality guarantees.

MOSGs build on security games and multi-objective optimization. The relationship of MOSGs to previous work in security games and in particular Bayesian security games has already been reviewed above. In this section, the research on multi-objective optimization will be primarily reviewed. There are three representative approaches for generating the Pareto frontier in multi-objective optimization problems. These include weighted summation, where the objective functions are assigned weights and aggregated, producing a single Pareto optimal solution. The Pareto frontier can then be explored by sampling different weights. Another approach is multi-objective evolutionary algorithms (MOEA). Evolutionary approaches such as NSGA-II are capable of generating multiple approximate solutions in each iteration. However, due to their stochastic nature, both weighted summation and MOEA cannot bound the level of approximation for the generated Pareto frontier. This lack of solution quality guarantees may be unacceptable for security domains.

The third approach is the ∈-constraint method in which the Pareto frontier is generated by solving a sequence of CSOPs. One objective is selected as the primary objective to be maximized while lower bound constraints are added for the secondary objectives. The original ∈-constraint method discretizes the objective space and solves a CSOP for each grid point. This approach is computationally expensive since it exhaustively searches the objective space of secondary objectives. There has been work to improve upon the original ∈-constraint method, such as proposing an adaptive technique for constraint variation that leverages information from solutions of previous CSOPs. However, such a method requires solving O(kⁿ⁻¹) CSOPs, where k is the number of solutions in the Pareto frontier. Another approach, the augmented ∈-constraint method, reduces computation by using infeasibility information from previous CSOPs. However, this approach only returns a predefined number of points and thus cannot bound the level of approximation for the Pareto frontier.

Approaches for solving MOSGs according to the present disclosure significantly modify the idea of the ∈-constraint method for application to security domains that demand both efficiency as well as quality guarantees when providing decision support. Exemplary embodiments only need to solve O(nk) CSOPs and can provide approximation bounds.

Iterative ∈-Constraints

The ∈-constraint method formulates a CSOP for a given set of constraints b, producing a single Pareto optimal solution. The Pareto frontier is then generated by solving multiple CSOPs produced by modifying the constraints in b. Below, a presentation of the Iterative ∈-Constraints algorithm is given, which is an algorithm for systematically generating a sequence of CSOPs for an MOSG. These CSOPs can then be passed to a solver φ to return solutions to the MOSG. Following portions of the disclosure present 1) an exact MILP approach, which can guarantee that each solution is Pareto optima, and 2) a faster approximate approach for solving CSOPs.

Algorithm for Generating CSOPs

Iterative ∈-Constraints uses one or more (preferably all) of the following four key features: 1) The Pareto frontier for an MOSG can be found by solving a sequence of CSOPs. For each CSOP, Uᵢ^{d}(c) is selected as the primary objective, which will be maximized. Lower bound constraints b are then added for the secondary objectives U₂^{d}(c), . . . , Uₙ^{d}(c). 2) The sequence of CSOPs are iteratively generated by exploiting previous Pareto optimal solutions and applying Pareto dominance. 3) It is possible for a CSOP to have multiple coverage vectors c that maximize Uᵢ^{d}(c) and satisfy b. Thus, lexicographic maximization is used to ensure that CSOP solver φ only returns Pareto optimal solutions. 4) It may be impractical (even impossible) to generate all Pareto optimal points if the frontier contains a large number of points, e.g., the frontier is continuous. Therefore, a parameter ∈ is used to discretize the objective space, trading off solution efficiency versus the degree of approximation in the generated Pareto frontier.

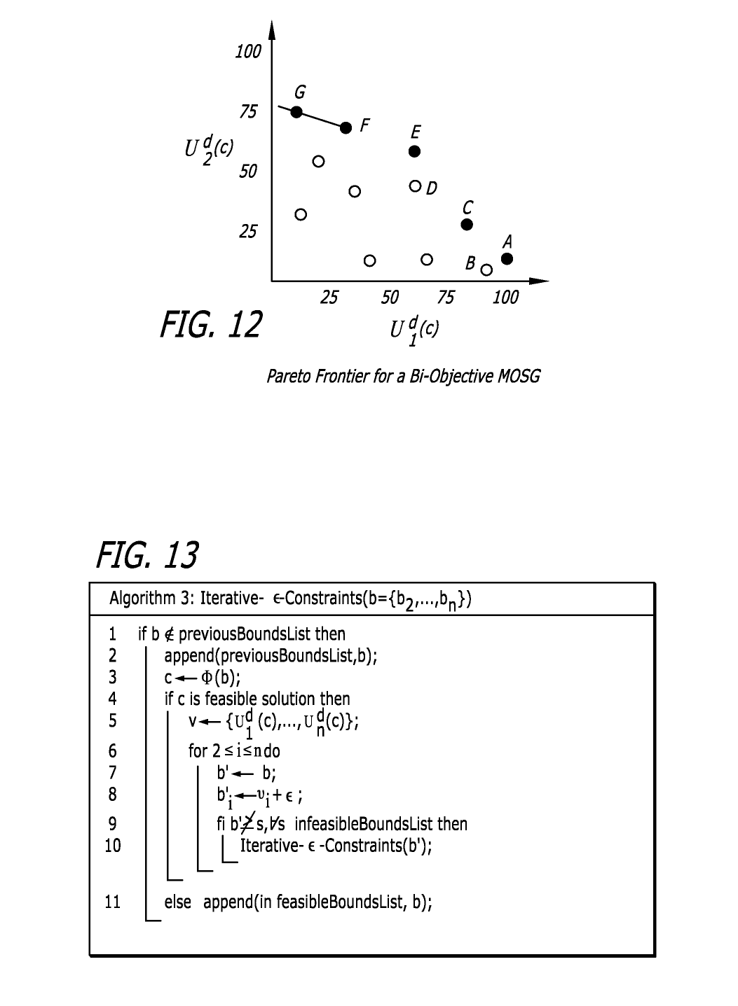

FIG. 12 depicts and example of a Pareto Frontier for a Bi-Objective MOSG. A simple MOSG example is now presented with two objectives and ∈=5. FIG. 12 shows the objective space for the problem as well as several points representing the objective vectors for different defender coverage vectors. In this problem, U₁^{d} will be maximized while b₂ constrains U₂^{d}. The initial CSOP is unconstrained (i.e., b₂=−∞), thus the solver φ will maximize U₁^{d} and return solution A=(100,10). Based on this result, that any point v={v₁,v₂} (e.g., B) is not Pareto optimal if v₂<10, as it would be dominated by A is known. A new CSOP is then generated, updating the bound to b₂=10+∈. Solving this CSOP with φ produces solution C=(80, 25) which can be used to generate another CSOP with b₂=25+∈. Both D=(60,40) and E=(60,60) satisfy b₂ but only E is Pareto optimal. Lexicographic maximization ensures that only E is returned and dominated solutions are avoided (details in Section 6). The method then updates b₂=60+∈ and φ returns F=(30,70), which is part of a continuous region of the Pareto frontier from U₂^{d}=70 to U₂^{d}=78. The parameter ∈ causes the method to select a subset of the Pareto optimal points in this continuous region. In particular this example returns G=(10,75) and in the next iteration (b₂=80) finds that the CSOP is infeasible and terminates. The algorithm returns a Pareto frontier of A, C, E, F, and G.

Algorithm 3, shown in FIG. 13, systematically updates a set of lower bound constraints b to generate the sequence of CSOPs. Each time a CSOP is solved, a portion of the n−1 dimensional space formed by the secondary objectives is marked as searched with the rest divided into n−1 subregions (by updating b for each secondary objective). These n−1 subregions are then recursively searched by solving CSOPs with updated bounds. This systematic search forms a branch and bound search tree with a branching factor of n−1. As the depth of the tree increases, the CSOPs are more constrained, eventually becoming infeasible. If a CSOP is found to be infeasible, no child CSOPs are generated because they are guaranteed to be infeasible as well. The algorithm terminates when the entire secondary objective space has been searched.

Two modifications can be made to improve the efficiency of the algorithm (Algorithm 3). 1) Preventing redundant computation resulting from multiple nodes having an identical set of lower bound constraints by recording the lower bound constraints for all previous CSOPs in a list called previousBoundsList. 2) Preventing the solving of CSOPs which are known to be infeasible based on previous CSOPs by recording the lower bound constraints for all infeasible CSOPs in a list called infeasibleBoundsList.

Approximation Analysis

Assume the full Pareto frontier is Ω and the objective space of the solutions found by the Iterative ∈-Constraints method is Ω_{∈}.

THEOREM 3. Solutions in Ω_{∈} are non-dominated, i.e., Ω_{∈} [symbol] Ω.

PROOF. Let c^{*} be the coverage vector such that U_{d}(c^{*})∈Ω_{∈} and assume that it is dominated by a solution from a coverage vector c̅. That means Uᵢ^{d}( c̅)≧Uᵢ^{d} (c^{*}) for all i=1, . . . , n and for some j, Uⱼ^{d}( c̅)>Uⱼ^{d}(c^{*}). This means that ( c̅) was a feasible solution for the CSOP for which c^{*} was found to be optimal. Furthermore, the first time the objectives differ, the solution ( c̅) is better and should have been selected in the lexicographic maximization process. Therefore c^{*}∉Ω_{∈} which is a contradiction. □

Given the approximation introduced by ∈, one immediate question is to characterize the efficiency loss. Here, a bound to measure the largest efficiency loss is defined:

$$p ( ∈ ) = {max}_{v ∈ Ω \backslash {Ω}_{∈}} {min}_{{v}^{′} ∈ {Ω}_{∈}} {max}_{1 \leq i \leq n} ( {v}_{i} - {v}_{i}^{′} )$$

This approximation measure can be used to compute the maximum distance between any point v∈Ω\Ω_{∈} on the frontier to its “closest” point v′∈Ω_{∈} computed by the algorithm. The distance between two points is the maximum difference of different objectives.

THEOREM 4. p(∈)≦∈.

PROOF. It suffices to prove Th. 4 by showing that for any v∈Ω\Ω_{∈}, there is at least one point v′∈Ω_{∈} such that v′₁≧v₁ and v′ᵢ≧vᵢ−∈ for i>1.

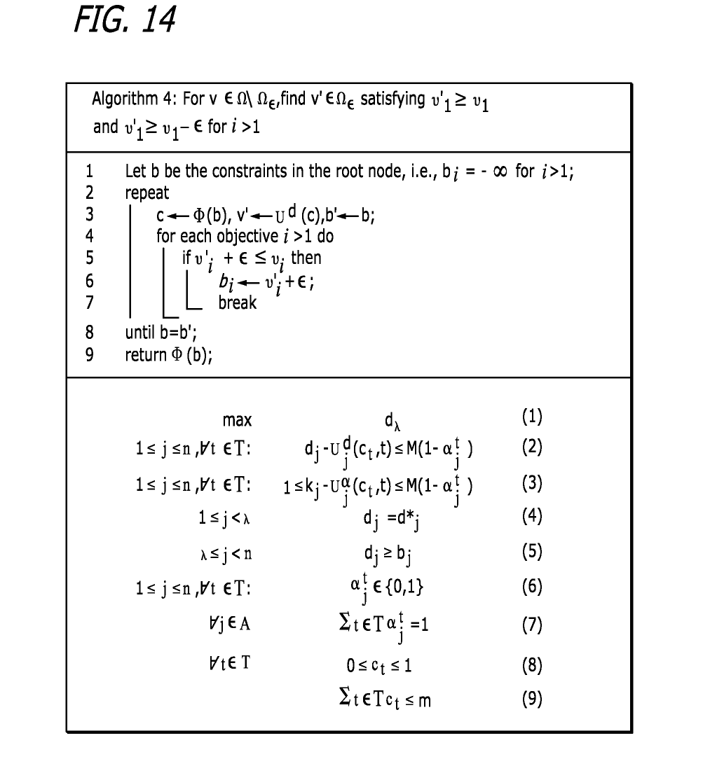

Algorithm 4, shown in FIG. 14, recreates the sequence of CSOP problems generated by Iterative ∈-Constraints while ensuring that the bound b≦v throughout. Since Algorithm 4 terminates when update b is not updated, this means that v′ᵢ+∈>vᵢ for all i>1. Summarizing, the final solution b and v′=U^{d}((φ(b)) satisfy b≦v and v′ᵢ>vᵢ−∈ for all i>1. Since v is feasible for the CSOP with bound b, but (φ(b))=v′≠v then ν′₁≧v₁. □

Given Theorem 4, the maximum distance for every objective between any missed Pareto optimal point and the closest computed Pareto optimal point is bounded by ∈. Therefore, as ∈ approaches 0, the generated Pareto frontier approaches the complete Pareto frontier in the measure p(∈). For example if there are k discrete solutions in the Pareto frontier and the smallest distance between any two is δ then setting ∈=δ/2 makes Ω_{∈}=Ω. In this case, since each solution corresponds to a non-leaf node in the search tree, the number of leaf nodes is no more than (n−1)k. Thus the algorithm solves at most O(nk) CSOPs.

MILP Approach

Previously, a high level search algorithm for generating the Pareto frontier by producing a sequence of CSOPs was introduced. An exact approach is presented below for defining and solving a mixed-integer linear program (MILP) formulation of a CSOP for MOSGs. It is then shown how heuristics that exploit the structure and properties of security games can be used to improve the efficiency of the MILP formulation.

Exact MILP Method

As stated above, to ensure Pareto optimality of solutions lexicographic maximization is required to sequentially maximizing all the objective functions. Thus, for each CSOP, n MILPs must be solved in the worst case where each MILP is used to maximize one objective. For the λ^{th} MILP in the sequence, the objective is to maximize the variable d_{λ}, which represents the defender's payoff for security game λ. This MILP is constrained by having to maintain the previously maximized values d*ⱼ for 1≦j<λ as well as satisfy lower bound constraints bₖ for λ<k≦n.

A lexicographic MILP formulation is presented for a CSOP for MOSGs in FIG. 14. Equation (1) is the objective function, which maximizes the defender's payoff for objective λ, d_{λ}. Equation (2) defines the defender's payoff. Equation (3) defines the optimal response for attacker j. Equation (4) constrains the feasible region to solutions that maintain the values of objectives maximized in previous iterations of lexicographic maximization. Equation (5) guarantees that the lower bound constraints in b will be satisfied for all objectives which have yet to be optimized.

If a mixed strategy is optimal for the attacker, then so are all the pure strategies in the support of that mixed strategy. Thus, the pure strategies of the attacker were only considered. Equations (6) and (7) constrain attackers to pure strategies that attack a single target. Equations (8) and (9) specify the feasible defender strategy space.

Once the MILP has been formulated, it can be solved using an optimization software package such as CPLEX. It is possible to increase the efficiency of the MILP formulation by using heuristics to constrain the decision variables. A simple example of a general heuristic which can be used to achieve speedup is placing an upper bound on the defender's payoff for the primary objective. Assume d₁ is the defender's payoff for the primary objective in the parent CSOP and d′₁ is the defender's payoff for the primary objective in the child CSOP. As each CSOP is a maximization problem, it must hold that d₁≧d′₁ because the child CSOP is more constrained than the parent CSOP. Thus, the value of d₁ can be passed to the child CSOP to be used as an upper bound on the objective function.

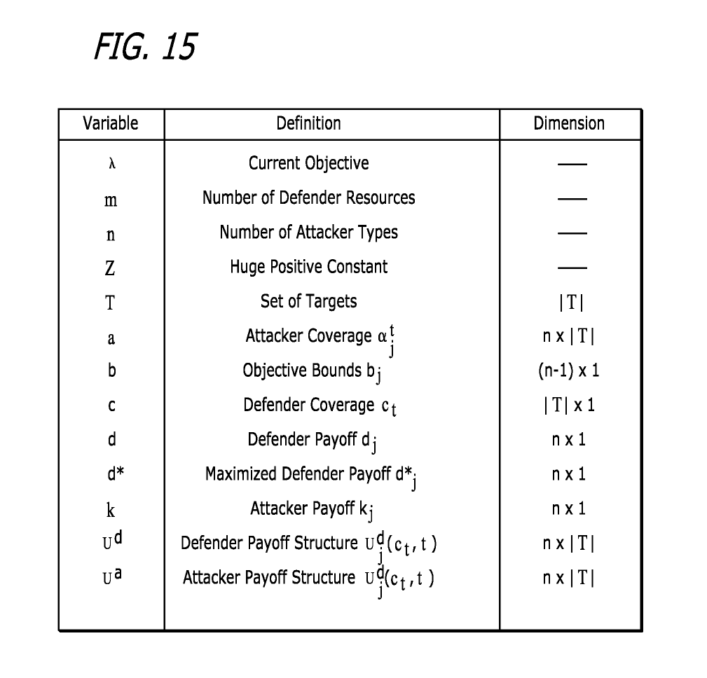

FIG. 15 shows MILP formulation definitions for an embodiment. The MILP is a variation of the optimization problem formulated previously for security games. The same variations can be made to more generic Stackelberg games, such as those used for DOBSS, giving a formulation for multi-objective Stackelberg games in general.

Exploiting Game Structures

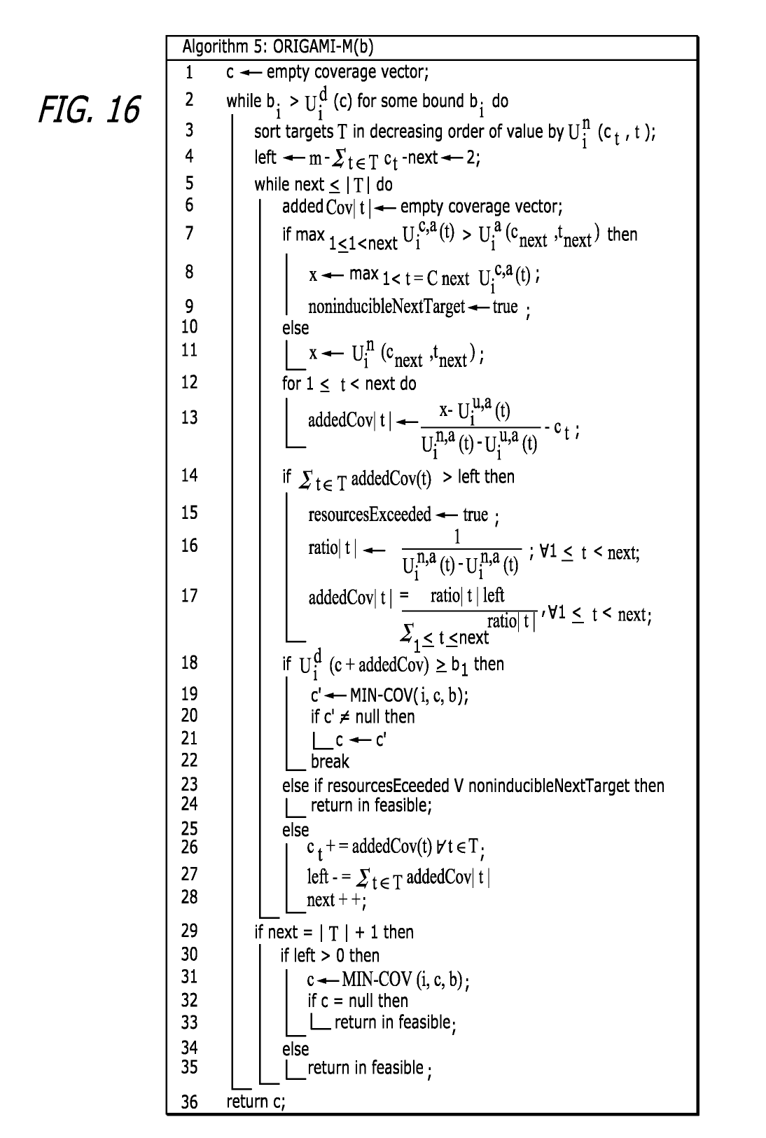

In addition to placing bounds on the defender payoff, it is possible to constrain the defender coverage in order to improve the efficiency of the MILP formulation. Thus, an approach for translating constraints on defender payoff into constraints on defender coverage is realized. This approach, shown in FIG. 16 as Algorithm 5, and referred to herein as ORIGAMI-M, achieves this translation by computing the minimum coverage needed to satisfy a set of lower bound constraints b such that Uᵢ^{d}(c)≧bᵢ for 1≦i<n. This minimum coverage is then added to the MILP in FIG. 14 as constraints on the variable c, reducing the feasible region and leading to significant speedup as verified in experiments.

ORIGAMI-M is a modified version of the ORIGAMI algorithm and borrows many of its key concepts. At a high level, ORIGAMI-M starts off with an empty defender coverage vector c, a set of lower bound constraints b, and m defender resources. An attempt is made to compute a coverage c which uses the minimum defender resources to satisfy constraints b. If a constraint bᵢ is violated, i.e., Uᵢ^{d}(c)<bᵢ, ORIGAMI-M updates c by computing the minimum additional coverage necessary to satisfy bᵢ. Since a focus is on satisfying the constraint on one objective at a time, the constraints for objectives that were satisfied in previous iterations may become unsatisfied again. The reason is that additional coverage may be added to the target that was attacked by this attacker type, causing it to become less attractive relative to other alternatives for the attacker, and possibly reducing the defender's payoff by changing the target that is attacked. Therefore, the constraints in b should be checked repeatedly until quiescence (no chances are made to c for any bᵢ). If all m resources are exhausted before b is satisfied, then the CSOP is infeasible.

The process for calculating minimum coverage for a single constraint bᵢ is built on two properties of security games: (1) the attacker chooses the optimal target; (2) the attacker breaks ties in favor of the defender. The set of optimal targets for attacker i for coverage c is referred to as the attack set, Γᵢ(c). Accordingly, adding coverage on target t∉Γᵢ does not affect the attacker i's strategy or payoff. Thus, if c does not satisfy bᵢ, only consider adding coverage to targets in Γᵢ, Γᵢ can be expanded by increasing coverage such that the payoff for each target in Γᵢ is equivalent to the payoff for the next most optimal target. Adding an additional target to the attack set cannot hurt the defender since the defender receives the optimal payoff among targets in the attack set.

Referring to Algorithm 5 in FIG. 16, the idea for ORIGAMI-M is to expand the attack set Γᵢ until bᵢ is satisfied. The order in which the targets are added to Γᵢ is by decreasing value of Uᵢ^{a}(cₜ,t). Sorting these values, so that Uᵢ^{a}(c₁,t₁)≧Uᵢ^{a}(c₂,t₂)≧ . . . ≧Uᵢ^{a}(cᵢη,tᵢη), leads to Γᵢ(c) starts only with target t₁. Assume that the attack set includes the first q targets. To add the next target, the attacker's payoff for all targets in Γᵢ must be reduced to Uᵢ^{a}(c_{q+1},t_{q+1}) (Line 11). However, it might not be possible to do this. Once a target t is fully covered by the defender, there is no way to decrease the attacker's payoff below Uᵢ^{c,a}(t). Thus, if max_{1≦t≦q}Uᵢ^{c,a}(t)>Uᵢ^{a}(c_{q+1},t_{q+1}) (Line 7), then it is impossible to induce the adversary i to attack target t_{q+1}. In that case, the attacker's payoff for targets in the attack set to max_{1≦t≦q}Uᵢ^{c,a}(t) (Line 8) must be reduced. Then for each target t∈Γᵢ, the amount of additional coverage, addCov[t] is computed, necessary to reach the required attacker payoff (Line 13). If the total amount of additional coverage exceeds the amount of remaining coverage, then addedCov is recomputed and each target in the attack set is assigned ratio of the remaining coverage so to maintain the attack set (Line 17). There is then a check to see if c+addedCov satisfies bᵢ (Line 18). If bᵢ is still not satisfied, then the coverage c is updated to include addedCov (Line 26) and the process is repeated for the next target (Line 28).

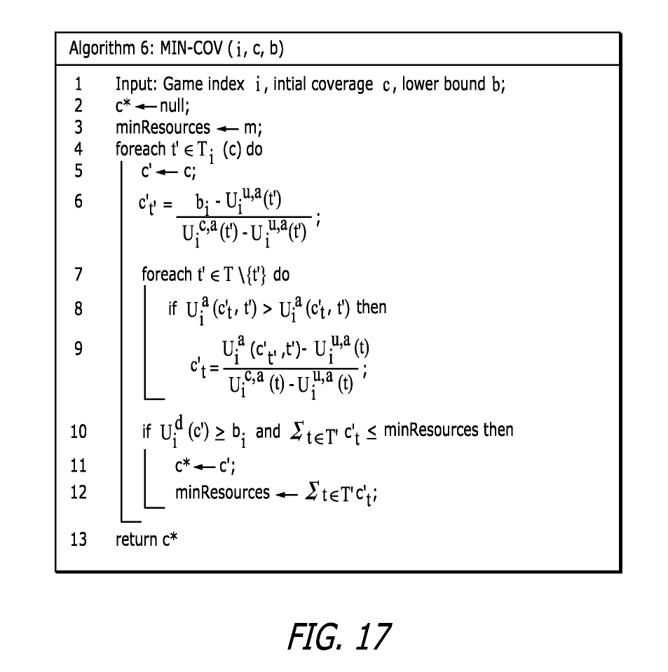

Then if c+addedCov expands Γᵢ and exceeds bᵢ, it may be possible to use less defender resources and still satisfy bᵢ. Thus, the algorithm MIN-COV, shown as Algorithm 6 in FIG. 17, is used to compute, ∀t′∈Γᵢ, the amount of coverage needed to induce an attack on t′ which yields a defender payoff of bᵢ. For each t′, MIN-COV generates a defender coverage vector c′, which is initialized to the current coverage c. Coverage c′_{t′} is updated such that the defender payoff for t′ is bᵢ, yielding an attacker payoff Uᵢ^{a}(c′_{t′},t′) (Line 6). The coverage for every other target t∈T\{t′} is updated, if needed, to ensure that t′ remains in Γᵢ, i.e. Uᵢ^{a}(c′_{t′},t′)≧Uᵢ^{a}(c′_{t′},t) (Line 9). After this process, c′ is guaranteed to satisfy bᵢ. From the set of defender coverage vectors, MIN-COV returns the c′ which uses the least amount of defender resources. If while computing the additional coverage to added, either Γᵢ is the set of all targets or all m security resources are exhausted, then both bᵢ and the CSOP are infeasible.

If b is satisfiable, ORIGAMI-M will return the minimum coverage vector c* that satisfies b. This coverage vector can be used to replace Equation (8) with c*ᵢ≦ct≦1.

ORIGAMI-A

In the previous section, heuristics to improve the efficiency of the described MILP approach were shown. However, solving MILPs, even when constrained, is computationally expensive. Thus, ORIGAMI-A, shown as Algorithm 7 in FIG. 18, is presented as an extension to ORIGAMI-M which eliminates the computational overhead of MILPs for solving CSOPs. The key idea of ORIGAMI-A is to translate a CSOP into a feasibility problem which can be solved using ORIGAMI-M. A series of these feasibility problems using binary search in order to approximate the optimal solution to the CSOP is then generated. As a result, this algorithmic approach is much more efficient.

ORIGAMI-M computes the minimum coverage vector necessary to satisfy a set of lower bound constraints b. As the MILP approach is an optimization problem, lower bounds are specified for the secondary objectives but not the primary objective. This optimization problem is converted into a feasibility problem by creating a new set of lower bounds constraints b⁺ by adding a lower bound constraint b₁⁺ for the primary objective to the constraints b. The lower bound constraint can be set b₁⁺=min_{t∈T}U₁^{u,d}(t), the lowest defender payoff for leaving a target uncovered. Now instead of finding the coverage c which maximizes U₁^{d}(c) and satisfies b, ORIGAMI-M can be used to determine if there exists a coverage vector c such that b⁺ is satisfied.

ORIGAMI-A finds an approximately optimal coverage vector c by using ORIGAMI-M to solve a series of feasibility problems. This series is generated by sequentially performing binary search on the objectives starting with initial lower bounds defined in b⁺. For objective i, the lower and upper bounds for the binary search are, respectively, b₁⁺ and max_{t∈T}U₁^{c,d}(t), the highest defender payoff for covering a target. At each iteration, b⁺ is updated by setting b₁⁺=(upper+lower)/2 and then passed as input to ORIGAMI-M. If b⁺ is found to be feasible, then the lower bound is updated to bᵢ⁺ and c is updated to the output of ORIGAMI-M, otherwise the upper bound is updated to bᵢ⁺. This process is repeated until the difference between the upper and lower bounds reaches the termination threshold, α. Before proceeding to the next objective, bᵢ⁺ is set to Uᵢ^{d}(c) in case the binary search terminated on an infeasible problem. After searching over each objective, ORIGAMI-A will return a coverage vector c such that U₁^{d}(c*)−U₁^{d}(c)≦α, where c* is the optimal coverage vector for a CSOP defined by b.

The solutions found by ORIGAMI-A are no longer Pareto optimal. Let Ω_{α} be the objective space of the solutions found by ORIGAMI-A. Its efficiency loss can be bound using the approximation measure p(∈,α)=max_{v∈Ω}min_{v′∈Ω}_{_{α}}max_{1≦i≦n}.(vᵢ−ν′ᵢ).

THEOREM 5. p(∈,α)≦max{∈,α}.

PROOF. Similar to the proof of Theorem 4, for each point v∈Ω, Algorithm 2 can be used to find a CSOP with constraints b which is solved using ORIGAMI-A with coverage c such that 1) bᵢ≦vᵢ for i>1 and 2) ν′ₜ≧vᵢ−∈ for i>1 where v′=U^{d}(c).

Assume that the optimal coverage is c* for the CSOP with constraints b. It follows that U₁^{d}(c*)≧v₁ since the coverage resulting in point v is a feasible solution to the CSOP with constraints b. ORIGAMI-A will terminate if the difference between lower bound and upper bound is no more than α. Therefore, ν′₁≧U₁^{d}(c*)−α. Combining the two results, it follows that ν′₁≧v₁−α.

Therefore, for any point missing in the frontier v∈Ω, a point v′∈Ω_{α} can be found such that 1) ν′₁≧v₁−α and v′ᵢ>vᵢ−∈ for i>1. It then follows that p(∈,α)≦max{∈,α}. □

Evaluation

An evaluation was performed by running the full algorithm in order to generate the Pareto frontier for randomly-generated MOSGs. For the experiments, the defender's covered payoff Uᵢ^{c,d}(t) and attacker's uncovered payoff Uᵢ^{u,a}(t) were uniformly distributed integers between 1 and 10 for all targets. Conversely, the defender's uncovered payoff Uᵢ^{u,d}(t) and attacker's covered payoff Uᵢ^{c,a}(t) were uniformly distributed integers between −1 and −10. Unless otherwise mentioned, the setup for each experiment is 3 objectives, 25 targets, E=1.0, and α=0.001. The amount of defender resources m was fixed at 20% of the number of targets. For experiments comparing multiple formulations, all formulations were tested on the same set of MOSGs. A maximum cap on runtime for each sample is set at 1800 seconds. the MILP formulations were solved using CPLEX version 12.1. The results were averaged over 30 trials.

Runtime Analysis

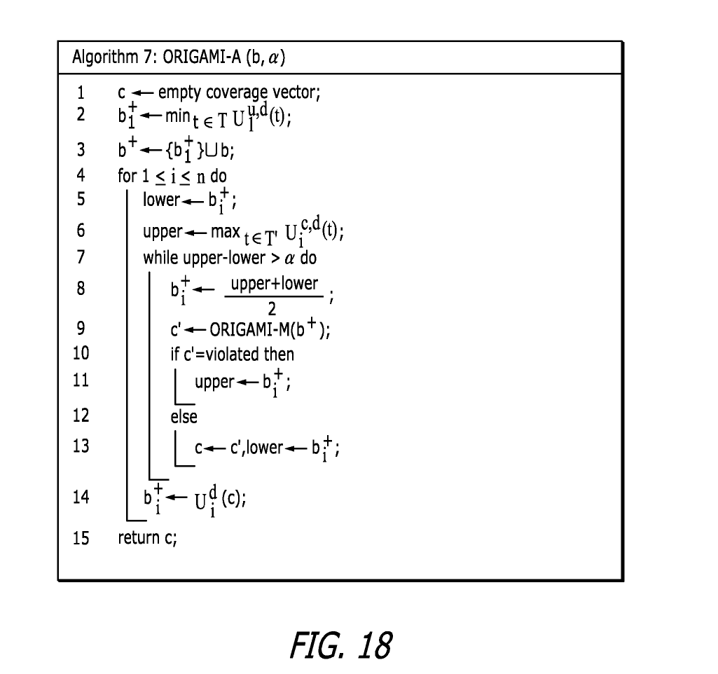

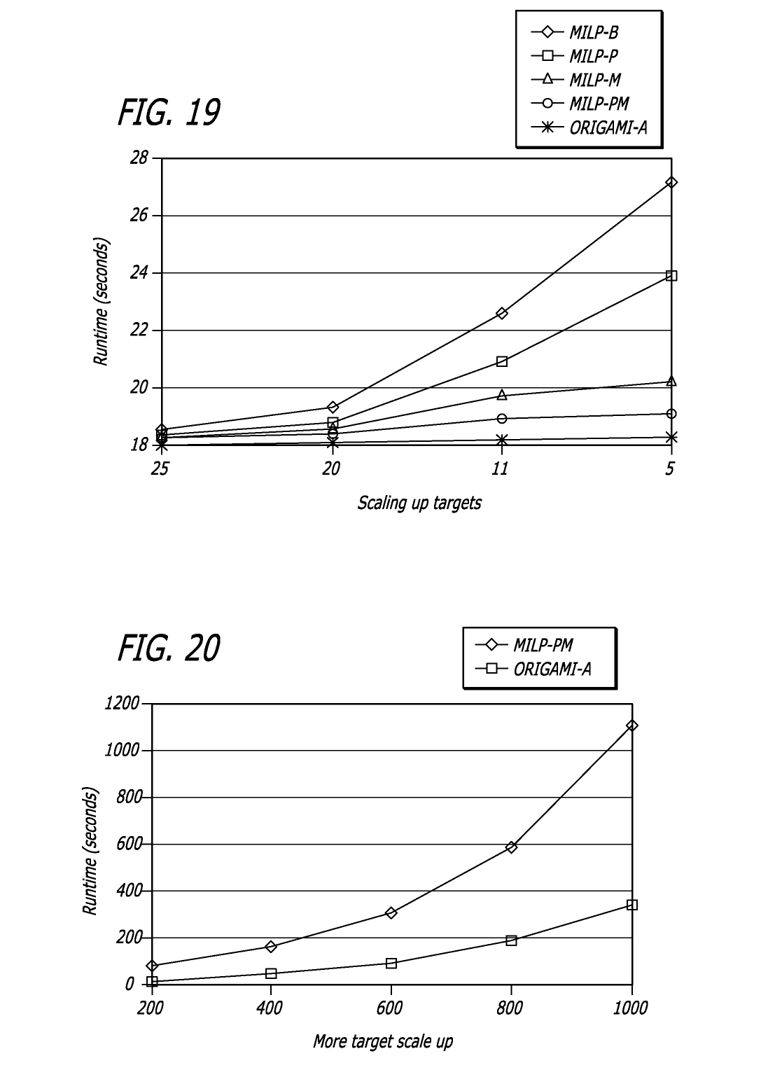

Five MOSG formulations were evaluated. Referring to the baseline MILP formulation as MILP-B, the MILP formulation adding a bound on the defender's payoff for the primary objective is MILP-P. MILP-M uses ORIGAMI-M to compute bounds on defender coverage. MILP-P can be combined with MILP-M to form MILP-PM. The algorithmic approach using ORIGAMI-A will be referred to by name. For the number of targets, all five formulations for solving CSOPs were evaluated. ORIGAMI-A and the fastest MILP formulation, MILP-PM, where then selected to evaluate the remaining factors. Results are shown in FIGS. 19-22.

Effect of the Number of Targets: This section presents results showing the efficiency of different MOSG formulations as the number of targets is increased. In FIG. 19, the x-axis represents the number of the targets in the MOSG. The y-axis is the number of seconds needed by Iterative ∈-Constraints to generate the Pareto frontier using the different formulations for solving CSOPs. The baseline MILP formulation, MILP-B, was observed to have the highest runtime for each number of targets tested. By adding an upper bound on the defender payoff for the primary objective, MILP-P was observed to yield a runtime savings of 36% averaged over all numbers of targets compared to MILP-B. MILP-M used ORIGAMI-M to compute lower bounds for defender coverage, resulting in a reduction of 70% compared to MILP-B. Combining the insights from MILP-P and MILP-M, MILP-PM achieved an even greater reduction of 82%. Removing the computational overhead of solving MILPs, ORIGAMI-A was the most efficient formulation with a 97% reduction. For 100 targets, ORIGAMI-A required 4.53 seconds to generate the Pareto frontier, whereas the MILP-B took 229.61 seconds, a speedup of >50 times. Even compared to fastest MILP formulation, MILP-PM at 27.36 seconds, ORIGAMI-A still achieved a 6 times speedup. T-test yielded p-value<0.001 for all comparison of different formulations when there are 75 or 100 targets.

An additional set of experiments were conducted to determine how MILP-PM and ORIGAMI-A scale up for an order of magnitude increase in the number of targets by testing on MOSGs with between 200 and 1000 targets. Based on the trends seen in the data, it was concluded that ORIGAMI-A significantly outperforms MILP-PM for MOSGs with large number of targets. Therefore, the number of targets in an MOSG is not believed to be a prohibitive bottleneck for generating the Pareto frontier using ORIGAMI-A. See FIG. 20.

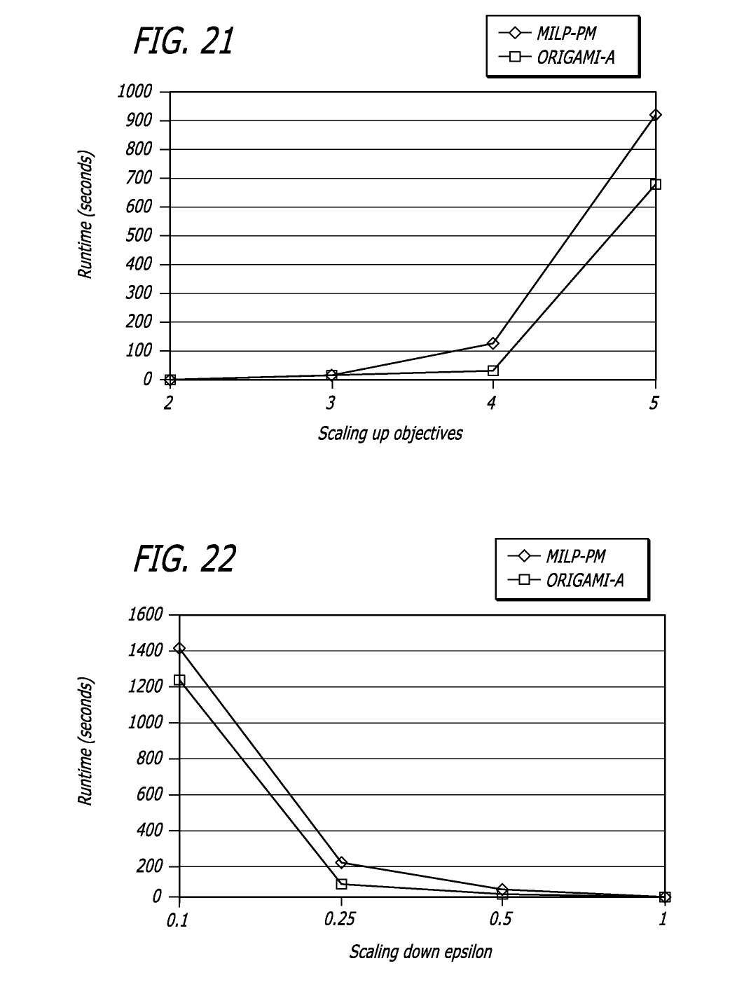

Effect of the Number of Objectives: Another key factor on the efficiency of Iterative ∈-Constraints algorithm is the number of objectives which determines the dimensionality of the objective space that Iterative ∈-Constraints must search. Experiments for MOSGs with between 2 and 6 objectives were run. For these experiments, the number of targets was fixed at 10. FIG. 21 shows the effect of scaling up the number of objectives. The x-axis represents the number of objectives, whereas the y-axis indicates the average time needed to generate the Pareto frontier. For both MILP-PM and ORIGAMI-A, an exponential increase in runtime was observed as the number of objectives is scaled up. For both approaches, the Pareto frontier was computed in under 5 seconds for 2 and 3 objectives. Whereas, with 6 objectives neither approach is able to generate the Pareto frontier before the runtime cap of 1800 seconds. These results show that the number of objectives, and not the number of targets, is the key limiting factor in solving MOSGs.

Effect of Epsilon: A third critical factor on the running time of Iterative ∈-Constraints is the value of the ∈ parameter which determines the granularity of the search process through the objective space. In FIG. 22, results are shown for ∈ values of 0.1, 0.25, 0.5, and 1.0. Both MILP-PM and ORIGAMI-A were observed to have a sharp increase in runtime as the value of ∈ is decreased due to the rise in the number of CSOPs solved. For example, with ∈=1.0, the average Pareto frontier consisted of 49 points, whereas for ∈=0.1 that number increased to 8437. Due to the fact that ∈ is applied to the n−1 dimensional objective space, the increase in the runtime resulting from decreasing ∈ is exponential in the number of secondary objectives. Thus, using small values of ∈ can be computationally expensive, especially if the number of objectives is large.

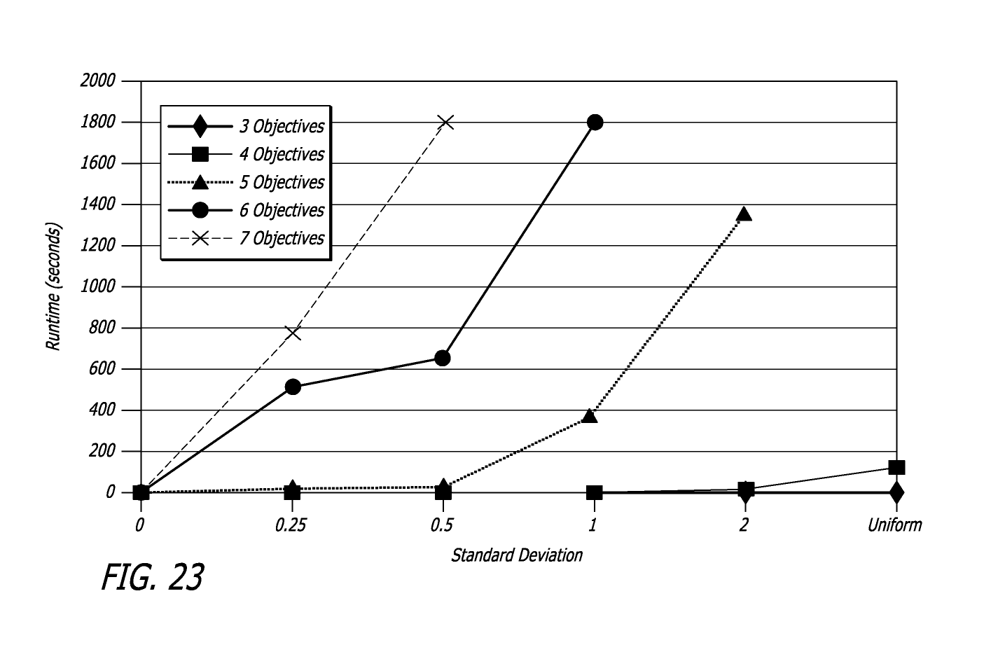

Effect of the Similarity of Objectives: In previous experiments, all payoffs were sampled from a uniform distribution resulting in independent objective functions. However, it is possible that in a security setting, the defender could face multiple attacker types which share certain similarities, such as the same relative preferences over a subset of targets. To evaluate the effect of objective similarity on runtime, a single security game was used to create a Gaussian function with standard deviation σ from which all the payoffs for an MOSG are sampled. FIG. 23 shows the results for using ORIGAMI-A to solve MOSGs with between 3 and 7 objectives using σ values between 0 and 2.0 as well as for uniformly distributed objectives. For σ=0, the payoffs for all security games are the same, resulting in Pareto frontier consisting of a single point. In this extreme example, the number of objectives did not impact the runtime. However, as the number of objectives was increased, less dissimilarity between the objectives is needed before the runtime started increasing dramatically. For 3 and 4 objectives, the amount of similarity had negligible impact on runtime. The experiments with 5 objectives were observed to time out after 1800 seconds for the uniformly distributed objectives. Whereas, the experiments with 6 objectives were observed to time out at σ=1.0 and with 7 objectives at σ=0.5. Thus, it is possible to scale to larger number of objectives if there is similarity between the attacker types.

Solution Quality Analysis

Effect of Epsilon: If the Pareto frontier is continuous, only a subset of that frontier can be generated. Thus, it is possible that one of the Pareto optimal points not generated by Iterative ∈-Constraints would be the most preferred solution, were it presented to the end user. As was proved earlier, the maximum utility loss for each objective resulting from this situation could be bounded by ∈. Experiments were conducted to empirically verify the bounds and to determine if the actual maximum objective loss was less than ∈.

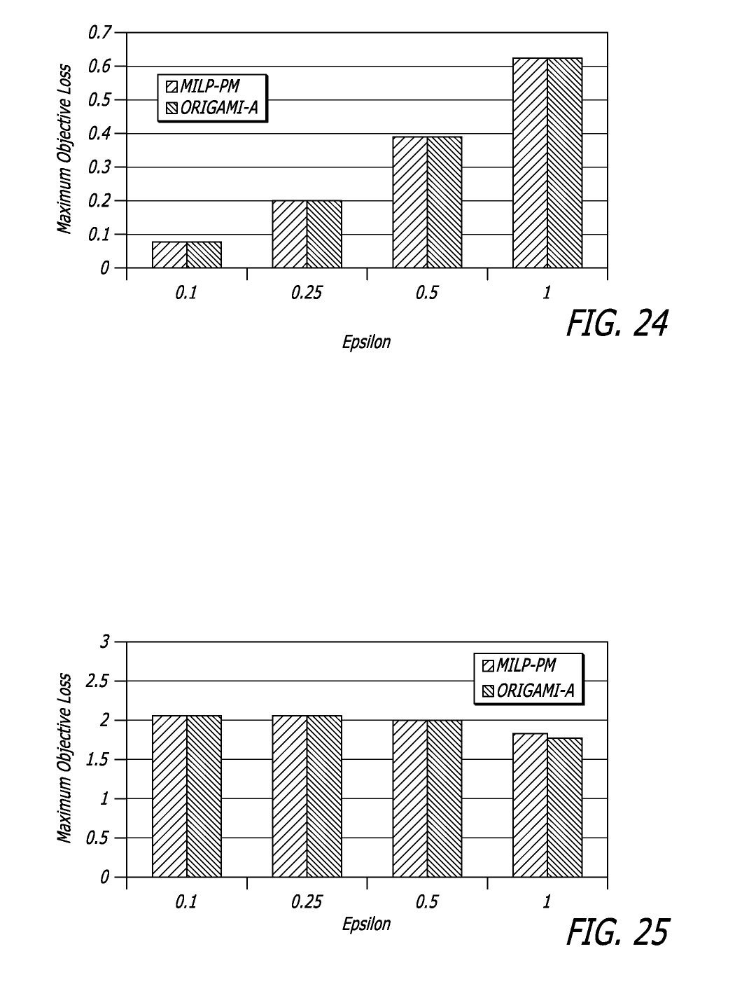

Ideally, the Pareto frontier generated by Iterative ∈-Constraints would be compared to the true Pareto frontier. However, the true Pareto frontier may be continuous and impossible to generate, thus the true frontier was simulated by using ∈=0.001. Due to the computational complexity associated with such a value of ∈, the number of objectives to 2 was fixed. FIG. 24 shows the results for ∈ values of 0.1, 0.25, 0.5, and 1.0. The x-axis represent the value of ∈, whereas the y-axis represents the maximum objective loss when comparing the generated Pareto frontier to the true Pareto frontier. It was observed that the maximum objective loss was less than ∈ for each value of ∈ tested. At ∈=1.0, the average maximum objective loss was only 0.63 for both MILP-PM and ORIGAMI-A. These results verify that the bounds for the MOSG algorithms presented herein are correct and that in practice a better approximation of the Pareto frontier can be generated, i.e., better than the bounds might suggest.

Comparison against Uniform Weighting: The MOSG model was introduced, in part, because it eliminates the need to specify a probability distribution over attacker types a priori. However, even if the probability distribution is unknown it is still possible to use the Bayesian security game model with a uniform distribution. Experiments were conducted to show the potential benefit of using MOSG over Bayesian security games in such cases. The maximum objective loss sustained by using the Bayesian solution as opposed to a point in the Pareto frontier generated by Iterative ∈-Constraints was computed. If v′ is the solution to a uniformly weighted Bayesian security game then the equation for maximum objective loss is max_{i∈Ω}_{_{c}}maxᵢ(vᵢ−ν′ᵢ). FIG. 25 shows the results for ∈ values of 0.1, 0.25, 0.5, and 1.0. At ∈=1.0, the maximum objective loss was observed to be only 1.87 and 1.85 for MILP-PM and ORIGAMI-A, respectively. Decreasing ∈ all the way to 0.1 was shown to increase the maximum objective loss by less than 12% for both algorithms. These results suggest that ∈ has limited impact on maximum objective loss, which is a positive result as it implies that solving an MOSG with a large ∈ can still yield benefits over a uniform weighted Bayesian security game.

Exemplary embodiments of the described algorithms are presented below, with reference to FIGS. 12-18; these exemplary embodiments are described below by way of example and other algorithms and variations of or additions/deletions to the described algorithms may be used within the scope of the present disclosure.

Algorithm 3: Iterative-Epsilon-Constraints

Line 1: This is a heuristic that checks to see if a solution has already been computed for the lower bound vector, b. If it is, then this subproblem (CSOP) is pruned (not computed), helping to speed up the algorithm.

Line 2: If the CSOP is not pruned, then b is added to the list of lower bound vectors that have been computed. So if any CSOP in the future has a lower bound vector identical to b, it will be pruned.

Line 3: This is the CSOP (defined by b) being passed to the CSOP solver which returns the solution c.

Line 4: Checks to see if c is a feasible solution.

Line 5: Given that c is feasible solution (coverage vector over targets) then the vector v represents the payoffs for the defender (one payoff for each objective).

Line 6: For each feasible solution found, n−1 CSOPs are generated where n is the number of objectives for the defender.

Line 7: the lower bound vector b is copied into a new vector b′.

Line 8: The lower bound is now updated for objective i in b′ to the payoff for objective i obtained by solution c. A discretization factor epsilon is added to allow for a tradeoff between runtime and granularity of the Pareto frontier.

Line 9: b′ is compared against the list of infeasible of lower bound vectors. If there exists a member, s, in that list for which the bounds for each objective in b′ are greater than or equal to the corresponding bound in s then it is known that b′ is also infeasible and should be pruned.

Line 10: Recursive call to Iterative-Epsilon-Constraints on the updated lower bound vector b′.

Line 11: If solution c is infeasible (from Line 4) then b is added to the list of infeasible lower bound vectors.

FIG. 14: MILP Formulation

Line 1: The objective function maximizes the defender's payoff for objective lambda.

Line 2: Specifies the defender's payoffs for each objective and each target given the defender's and attackers' strategies.

Line 3: Specifies the attacker payoff for each attacker type and each target given the defender's and attackers' strategies.

Line 4: Guarantees that the payoffs for objectives maximized in previous iterations of the lexicographic maximization will be maintained.

Line 5: Guarantees that the lower bound constraints in b will be satisfied for all objectives which have yet to be optimized.

Line 6: Limits the attackers to pure strategies (either they attack a target or they don't).

Line 7: Ensure that each attacker only attacks a single target.

Line 8: Specifies that the amount coverage placed on each target is between 0 and 1, since these values represent marginal probabilities.

Line 9: Specifies that the total amount coverage placed on all targets is less than the total number of defender resources, m.

Algorithm 5: ORIGAMI-M

Line 1: Initializes c (the solution to be returned by ORIGAMI-M to an empty coverage vector (no coverage on any targets).

Line 2: A while-loop that is repeated while the lower bound constraint for any objective in b is not satisfied by the defender payoffs produced by the current solution c.

Line 3: Sorts the list of targets in descending order according to attacker type i's payoff for attack each target given the current coverage c.

Line 4: Sets the variable left to the amount of remaining defender resources and the variable next (which represents the index in the sorted list of the next target to be added to the attack set) to 2.

Line 5: A while-loop that is repeated while there remain targets to be added to the attack set.

Line 6: A new coverage vector addCov (which will eventually be added to c) is initialized.

Line 7: Checks to see if there is a target in the current attack set which, regardless of the amount of the amount of coverage placed on it, will prevent the next target from being added to the attack set.

Line 8: If Line 7 is true, set variable x equal to fully covered payoff for attacker i on the target preventing the next target from being added to the attack set.

Line 9: The variable noninducibleNextTarget is set to true to indicate later that Line 7 was true.

Line 11: If Line 7 is false, set variable x equal to payoff for attacker type i for attacking the next target to be added given the current coverage c.

Line 12: A for-loop over each target currently in the attack set.

Line 13: Calculates the amount of coverage that needs to be added such that each target in the attack set yields the payoff to attacker type i as the next target to added to the attack set, given c.

Line 14: Checks to see if the amount of additional coverage need to add the next target to the attack set is greater than the amount of remaining defender resources.

Line 15: If Line 14 is true, resourcesExceeded is set to true.

Line 16/17: If Line 14 is true, then addedCov is recomputed and each target in the attack set is assigned a ratio of the remaining coverage so as to maintain the attack set

Line 18: Checks if combining the coverage vectors (c and addedCov) produces a coverage vector which yields a defender payoff for objective i which satisfies the lower bound on objective i, bᵢ.

Line 19: MIN-COV is called to see if it is possible to use even fewer resources than the combined coverage vector while still satisfying the lower bound constraint on objective i. The result is stored as c′.

Line 20: Checks to see if the solution returned by MIN-COV is feasible.

Line 21: If Line 20 is true, the current solution c is updated to c′.

Line 22: If this line is reached, the program/algorithm breaks out of the while-loop.

Line 23: If Line 18 if false, a check is made to see if either the amount of defender resources has been exceeded or it is not possible to add the next target to the attack set.

Line 24: If Line 23 is true, the lower bound constraints in b cannot be satisfied and the CSOP is infeasible. Thus, ORIGAMI-M terminates.

Line 26: If Lines 18 and 23 are false, the coverage vector addedCov is added to the current coverage vector c.

Line 27: If Lines 18 and 23 are false, the amount of resources used is subtracted, to add the next target to attack set from the amount of remaining defender resources.

Line 28: If Lines 18 and 23 are false, the next variable is incremented to indicate that another target has been added to the attack set.

Line 29: Once the while-loop (Line 5) has completed, a check is made to see if all targets have been added to the attack set.

Line 30: If Line 29 is true, a check is made to see if there are any remaining defender resources.

Line 31: If Line 30 is true, MIN-COV is called which figures how best to allocate the remaining defender resources and returns that coverage vector as c.

Line 32: a check is now made to see if the coverage vector returned by MIN-COV is feasible.

Line 33: If Line 32 is true, the lower bound constraints in b cannot be satisfied and the CSOP is infeasible. Thus, ORIGAMI-M terminates.

Line 35: If Line 30 is false, the lower bound constraints in b cannot be satisfied and the CSOP is infeasible. Thus, ORIGAMI-M terminates.

Line 36: Returns the solution c.

Algorithm 6: MIN-COV

Line 2: Initializes c* (the solution to be returned by MIN-COV) to an empty coverage vector (no coverage on any targets).

Line 3: Initializes the variable minResources to m (the total number of defender resources).

Line 4: A for-loop over each target t′ in the attack set for attacker type induce by the coverage vector c.

Line 5: Initialize a new coverage vector c′ with c.

Line 6: Computes the amount of coverage needed on target t′ to give the defender a payoff of bᵢ for objective i if attacker type i attacks target t′.

Line 7: A for-loop over the set of targets minus target t′.

Line 8: Checks to see if the payoff for attacker type i is greater from attacking target t than target t′ given the current amount of coverage placed on both targets.

Line 9: If it is, the coverage for target t is recomputed so that attacking target t yields the same payoff to attacker type i as target t′.

Line 10: Checks to see if c′ satisfies the lower bound on defender payoff for objective i AND uses less total coverage than minResources.

Line 11: If Line 10 is true, set c* (the best solution found so far) to c′.

Line 12: If Line 10 is true, set minResources variable the amount of resources used in c′.

Line 13: Return the solution c*.

Algorithm 7: ORIGAMI-A

Line 1: Initializes c (the solution to be returned by ORIGAMI-A) to an empty coverage vector (no coverage on any targets).

Line 2: Computes the lowest possible value for the primary objective (the target with the lowest payoff for the defender when fully uncovered).

Line 3: Initializes a new lower bound vector b+ as the union of the bound on the primary objective (objective 1) computed in Line 2 and the lower bound vector b for a given CSOP.

Line 4: The for-loop that specifies that will perform binary search over the defender payoff for each of the n objectives.

Line 5: The variable lower is initialized to the lower bound for objective in b+.

Line 6: The variable upper is initialized to the highest possible value for objective i (the target with the highest payoff for the defender when fully covered).

Line 7: A while-loop that specifies that the binary search over the payoff for objective i continues until the termination condition is reached (i.e., the difference between the upper and lower bounds of the binary search are less than alpha).

Line 8: Computes the new lower bound for objective i in b+ by dividing the upper and lower bounds for the search in half (hence binary search).

Line 9: ORIGAMI-M is called passing the updated lower bound vector b+which returns the solution c′.

Line 11: If c′ is infeasible then the upper variable is updated with lower bound for objective I from b+.

Line 13: If c′ is feasible then c (the best solution found thus far) is updated to c′ and the lower variable with the lower bound for objective i from b+.

Line 14: Once the binary search over objective i has terminated, the lower bound for objective i in b+ is updated to the defender payoff for objective i produced by solution c.

Line 15: Return the solution c.

MOSG—Conclusion

A new model, multi-objective security games (MOSG), has been developed, as described herein, for domains where security forces balance multiple objectives. Advantageous features include: 1) Iterative ∈-Constraints, a high-level approach for transforming MOSGs into a sequence of CSOPs, 2) exact MILP formulations, both with and without heuristics, for solving CSOPs, and 3) ORIGAMI-A, an approximate approach for solving CSOPs. Bounds for both the complexity as well as the solution quality of the MOSG approaches were then provided; additionally detailed experimental comparison of the different approaches was also presented, and these results confirmed the efficacy of the MOSG approach under tested circumstances.

Accordingly, the present disclosure provides different solution methodologies for addressing the issues of protecting and/or patrolling security domains, e.g., identified infrastructures or resources, with limited resources. The solution methodologies can provide optimal solutions to attacker-defender Stackelberg security games that are modeled on a real-world application of interest. These optimal solutions can be used for directing patrolling strategies and/or resource allocation for particular security domains. It will be understood that any of the algorithms in accordance with the present disclosure can be considered a means for solving a Stackelberg game modeling a particular security domain.

The above-described features, such as algorithms and methods and portions thereof, and applications can be implemented as and/or facilitated by software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion may refer to microprocessor or multi-core processors that execute software, some implementations can be performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

What is claimed is:

1. A computer-executable program product for determining a defender's patrolling strategy within a security domain and according to according to a Stackelberg game in which the attackers have a quantal response (QR) strategy, the computer-executable program product comprising a non-transitory computer-readable medium with resident computer-readable instructions, the computer readable instructions comprising instructions for:
fixing the policy of a defender to a mixed strategy according to a Stackelberg game for a security domain including a set of targets that the defender covers, wherein the defender has limited resources;
formulating an optimization problem for a strategy an attacker follows, wherein the optimization problem is for the optimal response to the leader's policy, wherein the attacker's strategy is a quantal response (QR) strategy;
maximizing the payoff of the defender, given that the attacker uses an optimal response that is function of the defender's policy, and formulating the problem as a non-convex fractional objective function having a polyhedral feasible region;
performing a binary search to solve the problem, wherein the binary search includes iteratively estimating a global optimal value of the fractional objective function;
reformulating the defender payoff problem as a convex objective function by performing a non-linear variable substitution;
solving the convex objective function to find the optimal solution, wherein the defender's strategy for the security domain is determined; and
directing a patrolling strategy of the defender within the security domain based on the optimal solution.

2. The computer-executable program product of claim 1, wherein the step of solving the convex objective function to find the optimal solution comprises using a piecewise linear function to approximate the nonlinear objective function, wherein the objective function is converted to a mixed-integer linear program (MILP).

3. The computer-executable program product of claim 1, wherein the computer-readable instructions comprise the optimization problem having resource assignment constraints.

4. The computer-executable program product of claim 2, wherein the computer-readable instructions comprise the MILP having resource assignment constraints.

5. The computer-executable program product of claim 2, wherein the MILP is of the form:
$$\begin{matrix}{min}_{x , z , a} {\sum }_{i ∈ 𝒯}^{ } {θ}_{i} ( r - {P}_{i}^{d} ) ( 1 + {\sum }_{k = 1}^{K} {γ}_{ik} {x}_{ik} ) + {\sum }_{i ∈ 𝒯}^{ } {θ}_{i} {α}_{i} {\sum }_{k = 1}^{K} {μ}_{ik} {x}_{ik} & \\ subject to {\sum }_{i ∈ 𝒯}^{ } {\sum }_{k = 1}^{K} {x}_{ik} \leq M , & \\ subject to 0 \leq {x}_{ik} \leq \frac{1}{K} , \\ ∀ i , \\ k = 1 … K , & \\ subject to {z}_{ik} \frac{1}{K} \leq {x}_{ik} , \\ ∀ i , \\ k = 1 … K - 1 , & \\ subject to {x}_{ik ( k + 1 )} \leq {z}_{ik} , \\ ∀ i , \\ k = 1 … K - 1 , & \\ subject to {z}_{ik} ∈ \{ 0 , 1 \} , \\ ∀ i , \\ k = 1 … K - 1 \\ subject to {\sum }_{k = 1}^{K} {x}_{ik} = {\sum }_{{A}_{j} ∈ 𝒜}^{ } {α}_{j} {A}_{ij} , \\ ∀ i ∈ 𝒯 \\ subject to {\sum }_{{A}_{j} ∈ 𝒜}^{ } {α}_{j} = 1 , and \\ subject to 0 \leq {a}_{j} \leq 1 , \\ {A}_{j} ∈ 𝒜 & \end{matrix}$$
and wherein T is the set of targets; i∈T denotes target i; xᵢ is the Probability that target i is covered by a resource; R₁^{d} is the defender reward for covering i if it is attacked; Pᵢ^{d} is the defender penalty on not covering i if it is attacked; Rᵢ^{a} is the attacker reward for attacking i if it is not covered; P₁^{a} is the attacker penalty on attacking i if it is covered; A is the set of defender strategies; Aⱼ∈ [symbol] denotes j^{th} strategy; aⱼ is the probability for defender to choose strategy Aⱼ, and, M is the total number of resources.

6. A system for determining a defender's patrolling strategy within a security domain, the system comprising:
a memory
a processor having access to the memory and configured to:
fix the policy of a defender to a mixed strategy according to a Stackelberg game for a security domain including a set of targets that the defender covers, wherein the defender has limited resources;
formulate an optimization problem for a strategy an attacker follows, wherein the optimization problem is for the optimal response to the leader's policy, wherein the attacker's strategy is a quantal response (QR) strategy;
maximize the payoff of the defender, given that the attacker uses an optimal response that is function of the defender's policy, and formulating the problem as a non-convex fractional objective function having a polyhedral feasible region;
perform a binary search to solve the problem, wherein the binary search includes iteratively estimating a global optimal value of the fractional objective function;
reformulate the defender payoff problem as a convex objective function by performing a non-linear variable substitution;
solve the convex objective function to find the optimal solution, wherein the defender's strategy for the security domain is determined; and
direct a patrolling strategy of the defender within the security domain based on the optimal solution.

7. The system of claim 6, wherein the processor is further configured to formulate an optimization problem for a strategy for a plurality of attacker.

8. The system of claim 6, wherein the processor is further configured to formulate the objective function for a plurality of defenders.

9. The system of claim 6, wherein the processor is configured to solve the convex objective function to find the optimal solution comprises using a piecewise linear function to approximate the nonlinear objective function, wherein the objective function is converted to a mixed-integer linear program (MILP).

10. The system of claim 6, wherein the processor is configured solve the optimization problem using a means for solving a Stackelberg game modeling the security domain.

11. A computer-executable program product for determining a defender's patrolling strategy within a security domain and according to a Bayesian Stackelberg game model, the computer-executable program product comprising a non-transitory computer-readable medium with resident computer-readable instructions, the computer readable instructions comprising instructions for:
fixing the policy of a defender to a mixed strategy according to a Stackelberg game for a security domain including a set of targets that the defender covers;
formulating an optimization problem for a strategy of each of a plurality of different attacker types, wherein each different type of attacker has its own optimization problem with its own respective payoff matrix for the optimal response to the leader's policy;
formulating the strategy of the defender as an optimization problem with a defender objective function;
formulating a search tree having a plurality of levels and a plurality of leaf nodes, wherein one attacker type is assigned to a pure strategy at each tree level, and wherein each leaf node is represented by a linear program that provides an optimal leader strategy such that the attacker's best response for every attacker type is the chosen target at that leaf node;
performing a best-first search in the search tree;
obtaining upper and lower bounds at internal nodes in the search tree;
solving the defender objective function to find the optimal solution, wherein the defender's strategy for the security domain is determined; and
directing a patrolling strategy of the defender within the security domain based on the optimal solution.

12. The computer-executable program product of claim 11, wherein the step of obtaining upper and lower bounds at internal nodes in the search tree comprises using an upper-bound (UB) linear program (LP) within an internal search node to produce an upper bound (UB) and a feasible solution.

13. The computer-executable program product of claim 12, wherein the feasible solution is utilized to produce a lower bound (LB) for the search, by determining the follower best response to the feasible solution.

14. The computer-executable program product of claim 12, wherein the computer-readable instructions comprise instructions for solving the upper-bound LP using Bender's decomposition.

15. The computer-executable program product of claim 14, wherein the computer-readable instructions further comprise instructions for reusing Bender's cuts from a parent node of the leaf nodes for those in its child nodes.

16. A computer-executable program product for determining a defender's patrolling strategy within a security domain and according to a Stackelberg game model, the computer-executable program product comprising a non-transitory computer-readable medium with resident computer-readable instructions, the computer readable instructions comprising instructions for:
fixing the policy of a defender to a mixed strategy according to a Stackelberg game for a security domain including a set of targets that the defender covers;
formulating an optimization problem for a strategy an attacker follows, wherein the optimization problem is for the optimal response to the leader's policy;
formulating the strategy of the defender as an optimization problem with multiple defender objective functions;
solving the defender objectives functions to find a Pareto frontier representing multiple Pareto optimal solutions, wherein the defender's strategy for the security domain is determined based on the Pareto frontier; and
directing a patrolling strategy of the defender within the security domain based on a selected a Pareto optimal solution of the Pareto frontier.

17. The computer-executable program product of claim 16, wherein the Pareto frontier is determined using the Iterative ∈-Constraints algorithm.

18. The computer-executable program product of claim 17, wherein the step of using the Iterative ∈-Constraints algorithm includes formulating multiple constrained single-objective optimization problems (CSOPs).

19. The computer-executable program product of claim 18, wherein the computer-readable instructions comprise instructions for formulating the multiple CSOPs in MILP form.

20. The computer-executable program product of claim 19, wherein the computer-readable instructions comprise instructions for solving the MILP.
